(19) United States
(12) Patent Application Publication
(10) Pub. No.: US 2018/0351650 A1
(43) Pub. Date: Dec. 6, 2018

(54) OPTICAL TRANSMISSION DEVICE AND OPTICAL TRANSMISSION METHOD

(71) Applicant: FUJITSU LIMITED, Kawasaki-shi (JP)

(72) Inventors: Takuma Togo, Saitama (JP); Rikiya Watanabe, Kawasaki (JP)

(73) Assignee: FUJITSU LIMITED, Kawasaki-shi (JP)

(21) Appl. No.: 15/990,848

(22) Filed: May 29, 2018

(30) Foreign Application Priority Data
May 30, 2017 (JP) 2017-107119

(51) Int. Cl. H04B 10/532; H04J 14/06; H04B 10/25

(52) U.S. Cl. CPC H04B 10/532; H04B 10/25; H04J 14/06

(57) ABSTRACT

There is provided an optical transmission device including a first receiver configured to receive first signal light from a first route, a memory, a processor coupled to the memory and the processor configured to detect a first polarization fluctuation amount which is a change amount of a parameter indicating a polarization state within a predetermined time and the change amount of the first signal light received from the first route, and a second receiver configured to receive second signal light from a second route different from the first route when an absolute value of the detected first polarization fluctuation amount exceeds a first specific value.

### CROSS-REFERENCE TO RELATED APPLICATION

This application is based upon and claims the benefit of priority of the prior Japanese Patent Application No. 2017-107119, filed on May 30, 2017, the entire contents of which are incorporated herein by reference.

### FIELD

The embodiments discussed herein are related to an optical transmission device and an optical transmission method.

### BACKGROUND

An optical communication system transmits an optical signal from a transmission device to a reception device via a transmission path. A system is known in which the quality caused by the polarization mode dispersion is monitored among the optical signal qualities, and the optical signal is transmitted through a preliminary transmission path before a communication failure occurs in the transmission path which is being operated (see, e.g., Japanese Laid-Open Patent Publication No. 2013-141048).

The polarization mode dispersion is a phenomenon where a difference occurs in a transmission speed of each polarization of signal light. The polarization mode dispersion occurs when the birefringence is generated in a core of an optical fiber which is the transmission path. The birefringence of the core is randomly generated by an external force (e.g., environmental temperature change or mechanical vibration) applied to the optical fiber. The fluctuation of the polarization mode dispersion tends to be high, and it is not easy to suppress the quality fluctuation of the optical signal due to the polarization mode dispersion by performing compensation. For this reason, there has been proposed a system which transmits the optical signal through the preliminary transmission path before a communication failure occurs in the transmission path which is being operated.

However, there has been a report on a technique for specifying an occurrence location of a lightning or an accident by detecting a polarization state of light propagating through an optical ground wire (hereinafter, referred to as OPGW) (see, e.g., Japanese Laid-Open Patent Publication No. 10-148654). Further, there has also been a report on a coherent optical communication which is a technique for dramatically increasing the transmission speed of the optical communication system (see, e.g., Japanese Laid-Open Patent Publication Nos. 2013-162136 and 2012-119759).

Related technologies are disclosed in, for example, Japanese Laid-Open Patent Publication Nos. 2013-141048, 10-148654, 2013-162136, and 2012-119759.

### SUMMARY

According to an aspect of the invention, an optical transmission device includes a first receiver configured to receive first signal light from a first route, a memory, a processor coupled to the memory and the processor configured to detect a first polarization fluctuation amount which is a change amount of a parameter indicating a polarization state within a predetermined time and the change amount of the first signal light received from the first route, and a second receiver configured to receive second signal light from a second route different from the first route when an absolute value of the detected first polarization fluctuation amount exceeds a first specific value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an optical communication system to which an optical transmission device according to a first embodiment is applied;

FIG. 2 is a diagram illustrating flows of signal lights in the optical communication system;

FIG. 3 is a perspective view illustrating an example of an OPGW;

FIG. 4 is a diagram for describing an influence of lightning on the OPGW;

FIG. 5 is a diagram illustrating an example of a fluctuation of a polarization plane by the lightning;

FIG. 6 is a diagram illustrating another example of an optical communication system to which the optical transmission device of a first embodiment is applied;

FIG. 7 is a diagram illustrating a portion corresponding to a reception unit of Configuration Example 1, a portion corresponding to a detection unit of Configuration Example 1, and a portion corresponding to a transmission unit of Configuration Example 1;

FIG. 8 is a diagram illustrating an example of a hardware configuration of each of a first transponder and a determination unit;

FIG. 9 is a diagram illustrating a flow of a signal in FIG. 8;

FIG. 10 is a diagram illustrating an example of a hardware configuration of an electro-optical conversion circuit connected to a first Y cable;

FIG. 11 is a diagram illustrating the flow of the signal in FIG. 10;

FIG. 12 is a diagram illustrating a program and a data file recorded in a non-volatile memory of the determination unit;

FIG. 13 is a diagram illustrating an example of a first history table used for executing a first recording program;

FIG. 14 is a diagram illustrating an example of a threshold table used for executing the first determination program;

FIG. 15 is a flowchart of a stand-by program;

FIG. 16 is a flowchart of a switching program;

FIG. 17 is a flowchart of the first recording program;

FIG. 18 illustrates an example of the flowchart of the first determination program;

FIG. 19 is a diagram illustrating a modified example of the first determination program;

FIG. 20 is a diagram illustrating a program and a data file recorded in a non-volatile memory of a determination unit according to a second embodiment;

FIG. 21 illustrates an example of a flowchart of a second determination program;

FIG. 22 illustrates an example of the flowchart of the second judgment program;

FIG. 23 is a diagram illustrating an example of an operation of an optical transmission device according to the second embodiment;

FIG. 24 illustrates a modified example of the second determination program according to the second embodiment;

FIG. 25 is a diagram illustrating a program and a data file recorded in a non-volatile memory of the determination unit 32;

FIG. 26 is a diagram illustrating an example of a first flag;

FIG. 27 illustrates an example of a flowchart of a monitoring program;

FIG. 28 illustrates an example of the flowchart of the monitoring program;

FIG. 29 illustrates an example of a flowchart of a third determination program;

FIG. 30 is a diagram illustrating a program and a data file recorded in the non-volatile memory of the determination unit;

FIG. 31 is a diagram illustrating an example of a first history table in which data is recorded according to a fourth embodiment;

FIG. 32 is a diagram illustrating an example of a second flag used for executing a first adjustment program;

FIG. 33 illustrates an example of a flowchart of a fourth determination program;

FIG. 34 illustrates an example of a flowchart of the first adjustment program;

FIG. 35 is a diagram for describing an example of a procedure for reducing a first threshold;

FIG. 36 is a diagram illustrating a relationship of the reduced first threshold and a first polarization fluctuation amount;

FIG. 37 is a diagram illustrating a program and a data file recorded in the non-volatile memory of the determination unit 32;

FIG. 38 illustrates an example of a flowchart of a second adjustment program;

FIG. 39 is a diagram for describing an example of a procedure for increasing the first threshold;

FIG. 40 is a diagram illustrating a relationship of the increased first threshold and the first polarization fluctuation amount;

FIG. 41 is a diagram illustrating an example of an optical communication system to which an optical transmission device according to a sixth embodiment is applied;

FIG. 42 is a diagram illustrating flows of signal lights in the optical communication system;

FIG. 43 is a diagram illustrating another example of the optical communication system to which the optical transmission device of the sixth embodiment is applied;

FIG. 44 is a diagram illustrating flows of the signal lights in FIG. 43;

FIG. 45 is a diagram illustrating a program and a data file recorded in a non-volatile memory of a determination unit;

FIG. 46 illustrates an example of a flowchart of a fifth determination program;

FIG. 47 is a diagram illustrating an example of an optical communication system to which an optical transmission device according to a seventh embodiment is applied;

FIG. 48 is a diagram illustrating flows of signal lights in the optical communication system;

FIG. 49 is a diagram illustrating another example of the optical communication system to which the optical transmission device of the seventh embodiment is applied;

FIG. 50 is a diagram illustrating the flow of the signal in FIG. 49;

FIG. 51 is a diagram illustrating an example of a hardware configuration of a fourth transponder;

FIG. 52 is a diagram illustrating an example of the flow of the signal in the fourth transponder;

FIG. 53 is a diagram illustrating a program and a data file recorded in the non-volatile memory of a determination unit;

FIG. 54 illustrates an example of a flowchart of a sixth determination program;

FIG. 55 is a diagram illustrating a modified example of the seventh embodiment;

FIG. 56 is a diagram illustrating the flow of the signal in FIG. 55;

FIG. 57 is a diagram illustrating another example of the modified example; and

FIG. 58 is a diagram illustrating the flow of the signal in FIG. 57.

### DESCRIPTION OF EMBODIMENTS

The coherent optical communication using the coherence of light (e.g., optical interference) is a technology enabling a high-speed communication. In the coherent optical communication, since a signal generated by the interference between signal light and local oscillation light is detected, the detected signal (hereinafter, also referred to as a detection signal) fluctuates as well when a polarization state of the signal light fluctuates. A technique for removing the influence of the fluctuation of the polarization state (hereinafter, referred to as a polarization fluctuation) from the detection signal has already been developed. However, when the polarization fluctuation is severe, it is difficult to remove the influence of the polarization fluctuation. As a result, a transmission error occurs in which information to be transmitted by the signal light is not output from a transmission device on a receiving side.

The coherent optical communication is also useful for increasing the speed of the optical communication system using the OPGW as a transmission path. However, in the optical communication system using the OPGW as the transmission path, the polarization state of the signal light propagating through the OPGW violently fluctuates due to, for example, lightning so that the transmission error easily occurs.

Hereinafter, embodiments of a technique, for suppressing the transmission error due to, for example, the lightning in the optical communication system using, for example, the OPGW as the transmission path, will be described with reference to the accompanying drawings. However, the technical scope of the present disclosure is not limited to the embodiments, but extends to the matters described in the claims and equivalents thereto. Even though the drawings are different from each other, for example, elements having the same structure with each other will be denoted by the same reference numerals, and descriptions thereof will be omitted.

### First Embodiment

### (A) System

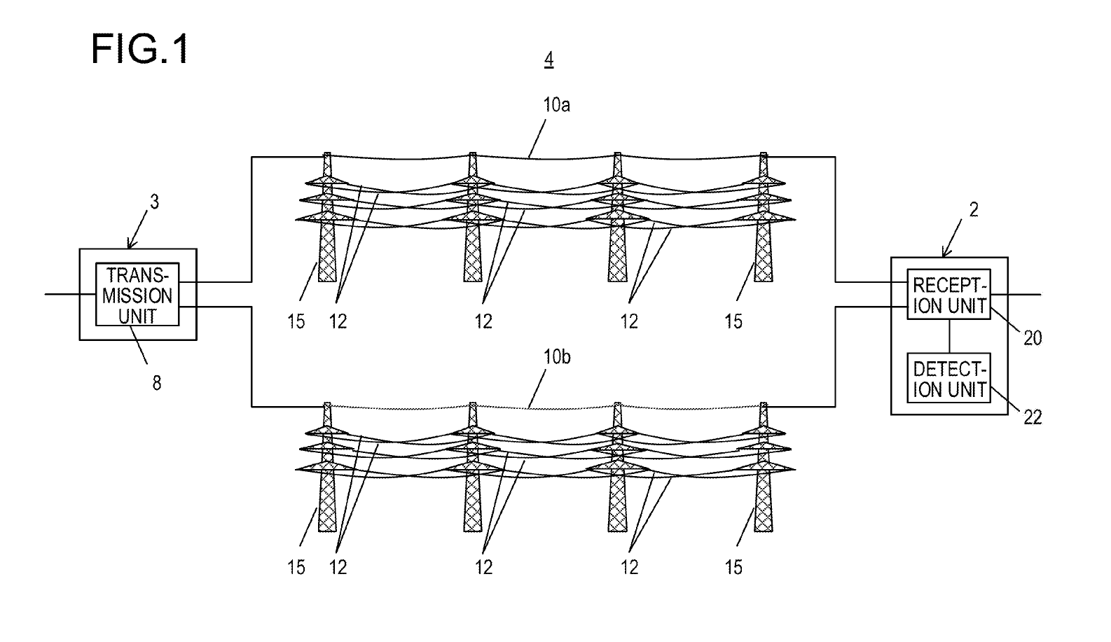

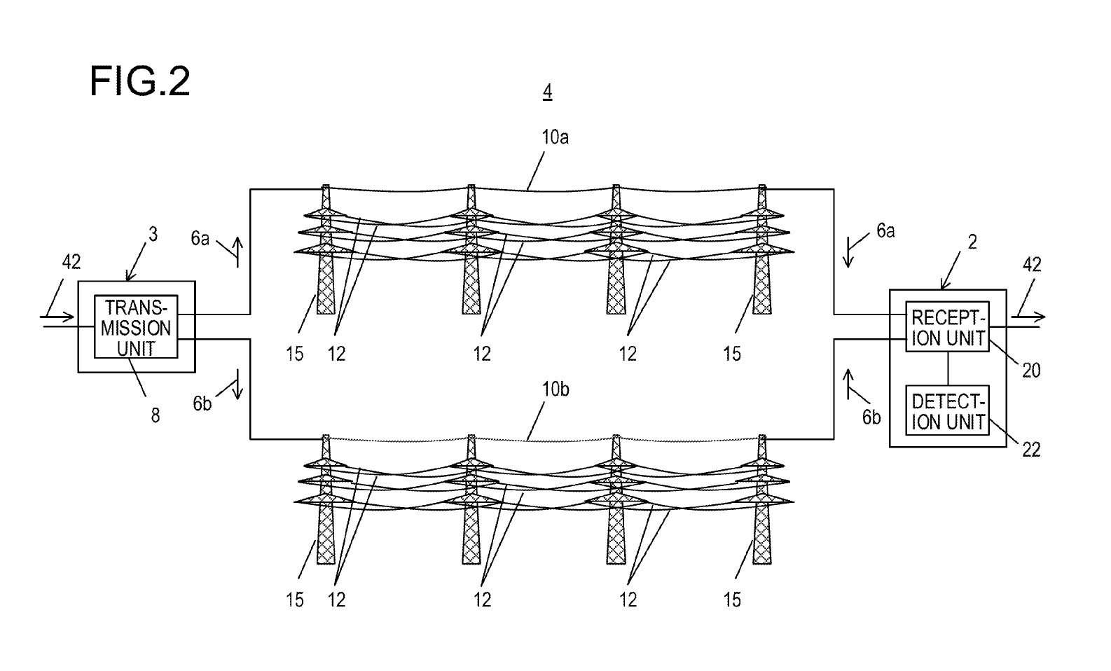

FIG. 1 is a diagram illustrating an example of an optical communication system 4 to which an optical transmission device 2 according to a first embodiment is applied. FIG. 2 is a diagram illustrating flows of signal lights 6a and 6b in the optical communication system 4. The optical communication system 4 is used, for example, for managing a power transmission network.

The optical communication system 4 includes an optical transmission device 2 (see FIG. 1). The optical transmission device 2 includes a reception unit 20 and a detection unit 22.

The optical communication system 4 also includes an optical transmission device 3. The optical transmission device 3 includes a transmission unit 8. The transmission unit 8 transmits the signal lights 6a and 6b (see FIG. 2) to the optical transmission device 2.

The optical communication system 4 further includes a first route 10a connecting the optical transmission device 2 and the optical transmission device 3 to each other. The optical communication system 4 further includes a second route 10b, which is different from the first route 10a, connecting the optical transmission device 2 and the optical transmission device 3 to each other.

The transmission unit 8 of the optical transmission device 3 transmits first signal light 6a for transmitting specific information (hereinafter, referred to as transmission information) to the optical transmission device 2 via the first route 10a. While transmitting the first signal light 6a, the transmission unit 8 also transmits the second signal light 6b for transmitting the transmission information (that is, the transmission information of the first signal light 6a) to the optical transmission device 2 through the second route 10b. That is, the optical communication system 4 is made redundant. The first signal light 6a and the second signal light 6b are, for example, lights whose phases are modulated for the transmission of the transmission information. The first signal light 6a and the second signal light 6b may be lights of which frequencies are modulated.

The length of each of the first route 10a and the second route 10b is, for example, 10 km to 100 km. An interval between the first route 10a and the second route 10b is, for example, 10 km to 70 km, except for the vicinity of the optical transmission devices 2 and 3. That is, the second route 10b is sufficiently apart from the first route 10a, except for both the ends of each route.

The first route 10a is, for example, a route passing through the OPGW. The second route 10b is, for example, a route passing through the OPGW different from the OPGW of the first route 10a. The OPGW is a kind of a lightning arrester earth wire (overhead ground wire) for protecting a high-voltage transmission line 12 from a direct lightning strike. For example, the OPGW is bridged over the high-voltage transmission line 12 supported by a supporting steel tower 15.

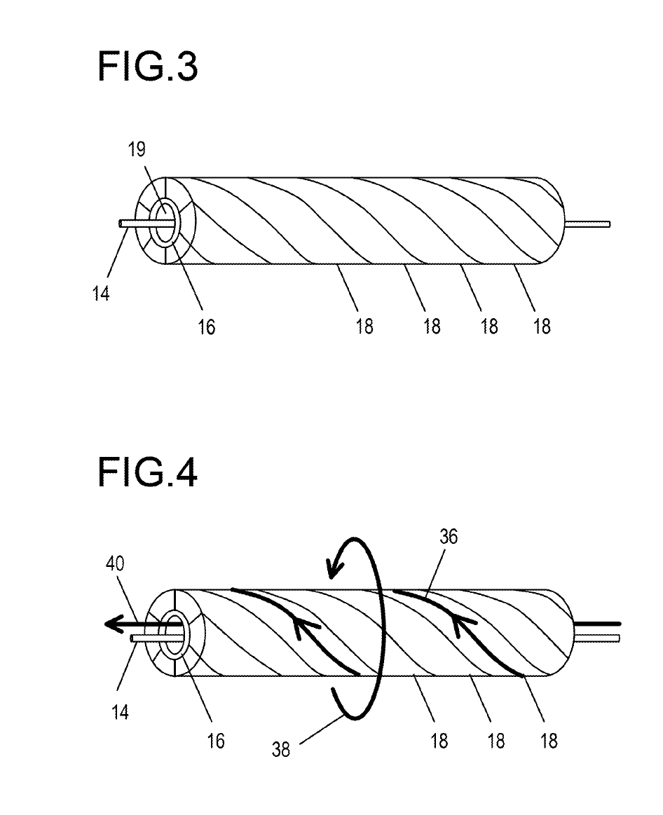

FIG. 3 is a perspective view illustrating an example of an OPGW. The OPGW includes, for example, an optical fiber 14, a pipe 16 (e.g., an aluminum pipe) through which the optical fiber 14 penetrates, and a plurality of conductive wires (conductive wires) 18 wound around the pipe 16 in a swirling manner.

The first route 10a passes through, for example, the optical fiber 14 penetrating a region 19 around which the conductive wire 18 extending in the swirling manner is wound (a region surrounded by an outer surface of the pipe 16). In the example illustrated in FIG. 3, there is one optical fiber 14, but there may be a plurality of optical fibers which pass through the cavity inside the OPGW.

The second route 10b is, for example, a route passing through the optical fiber penetrating the OPGW different from the OPGW of the first route 10a. That is, the second route 10b is, for example, a route passing outside the region 19 through which the first route 10a passes.

[Influence of Lightning in OPGW]

FIG. 4 is a diagram for describing an influence of lightning on the OPGW. When there is the lightning near a transmission line, the OPGW is exposed to electromagnetic waves due to the lightning. Then, a spiral current 36 (see FIG. 4) flows on the conductive wire 18 of the OPGW. Due to the current 36, an external magnetic field 38 circulating around the OPGW is generated outside the OPGW and an internal magnetic field 40 penetrating the OPGW is generated inside the OPGW. Due to the Faraday effect of the internal magnetic field 40, a state of a polarization plane of the signal light propagating through the optical fiber 14 fluctuates drastically. The polarization plane is a plane including a direction of vibration of an electric field and a propagation direction of the electromagnetic waves.

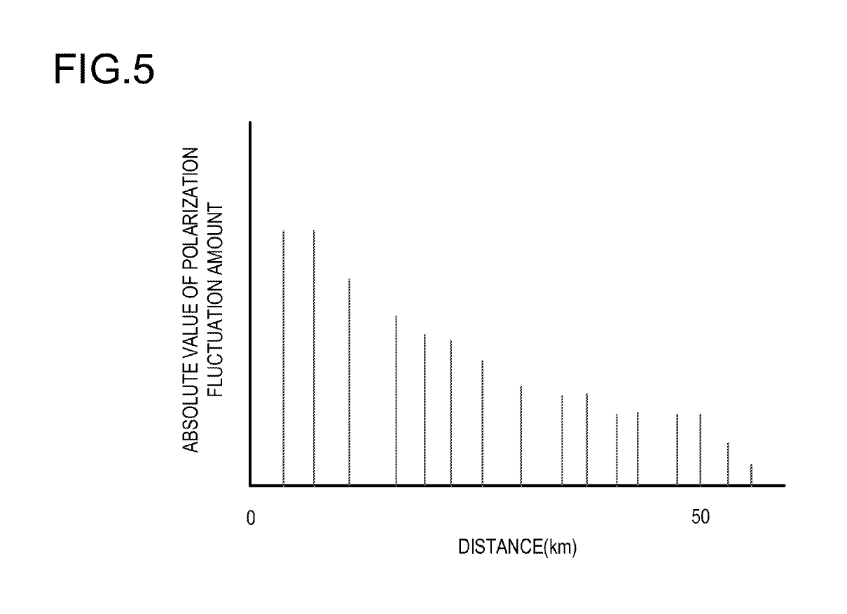

FIG. 5 is a diagram illustrating an example of a fluctuation of a polarization plane by the lightning. A vertical axis is an absolute value of a polarization fluctuation amount. A physical meaning of the polarization fluctuation amount will be described below. A horizontal axis is a distance (shortest distance) between a lightning point and the OPGW. The horizontal axis and the vertical axis are linear axes.

As illustrated in FIG. 5, the absolute value of the polarization fluctuation amount rapidly increases as the distance between the lightning point and the OPGW becomes shorter. Therefore, when there is a lightning near the OPGW where the signal light (e.g., the first signal light 6a) propagates, an error that the received signal light may not be converted into data (i.e., transmission information) occurs in the optical transmission device 2.

As described above, the first signal light 6a is phase- or frequency-modulated light (hereinafter, referred to as coherent modulated light). For demodulation of such signal light, homodyne detection or heterodyne detection is used, which causes the signal light and local oscillation light to interfere with each other.

When the polarization plane of the signal light fluctuates, an amplitude of interference light between the signal light and the local oscillation light fluctuates. Therefore, in the demodulation of the coherent modulated light, a signal from which the influence of the fluctuation of the polarization plane is removed from the amplitude of the interference light is detected. However, when the fluctuation of the polarization plane is severe, it is difficult to remove the influence of the fluctuation of the polarization plane fluctuation. As a result, a transmission error occurs.

### (B) Optical Transmission Device

### (1) Configuration and Operation

### (1-1) Configuration Example 1

The reception unit 20 (see FIG. 2) of the optical transmission device 2 receives the second signal light 6b for transmitting information which is the same as the transmission information of the first signal light 6a from the second route different from the first route while receiving the first signal light 6a for transmitting the transmission information from the first route 10a.

The detection unit 22 detects a first polarization fluctuation amount which is a polarization fluctuation amount of the light (e.g., the first signal light 6a) from the first route 10a. The polarization fluctuation amount is a change amount of a parameter indicating the polarization state of the light within a predetermined time.

The reception unit 20 monitors the first polarization fluctuation amount detected by the detection unit 22 and outputs transmission information 42 transmitted by the first signal light 6a before the absolute value of the first polarization fluctuation amount exceeds a first threshold 42. After the absolute value of the first polarization fluctuation amount exceeds the first threshold, the reception unit 20 outputs the transmission information 42 transmitted by the second signal light 6b.

“Parameter indicating the polarization state of the light” represents, for example, a rotational speed of the polarization plane of the electromagnetic wave (i.e., interference light) caused by the interference between the signal light and the local oscillation light (laser light generated by the optical transmission device 2). “The change amount within a predetermined time” represents a difference (=X1−X0) between a value X0 of the parameter at a predetermined point of time and a value X1 of the parameter after a lapse of a predetermined time.

The “predetermined time” represents, for example, time which is sufficiently longer than a modulation period (e.g., 25 ns) of the signal light (e.g., the first signal light 6a) and is shorter than a duration of the lightning (e.g., 10 μs to 100 s). The “predetermined time” is, for example, 100 ns or more and 10 μs or less.

The first threshold is a magnitude of the polarization fluctuation which may be converted into the transmission information 42 of the first signal light 6a by the reception unit 20. For example, the first threshold is 1 to 40 krad/sec when converted to a value per unit time.

As described above, the optical transmission device 2 monitors the polarization fluctuation amount of the light from the first route 10a, and when the polarization fluctuation amount exceeds the first threshold, the optical transmission device 2 outputs the transmission information 42 obtained from the signal light of the second route 10b, instead of the transmission information 42 obtained from the signal light of the first route 10a.

That is, the optical transmission device 2 stops outputting the transmission information 42 from the first route 10a before the transmission error due to the lightning occurs and starts, for example, the output of the transmission information 42 from the second route 10b sufficiently away from the lightning. Therefore, according to the optical transmission device 2, the transmission error due to the lightning is suppressed.

### (1-2) Configuration Example 2

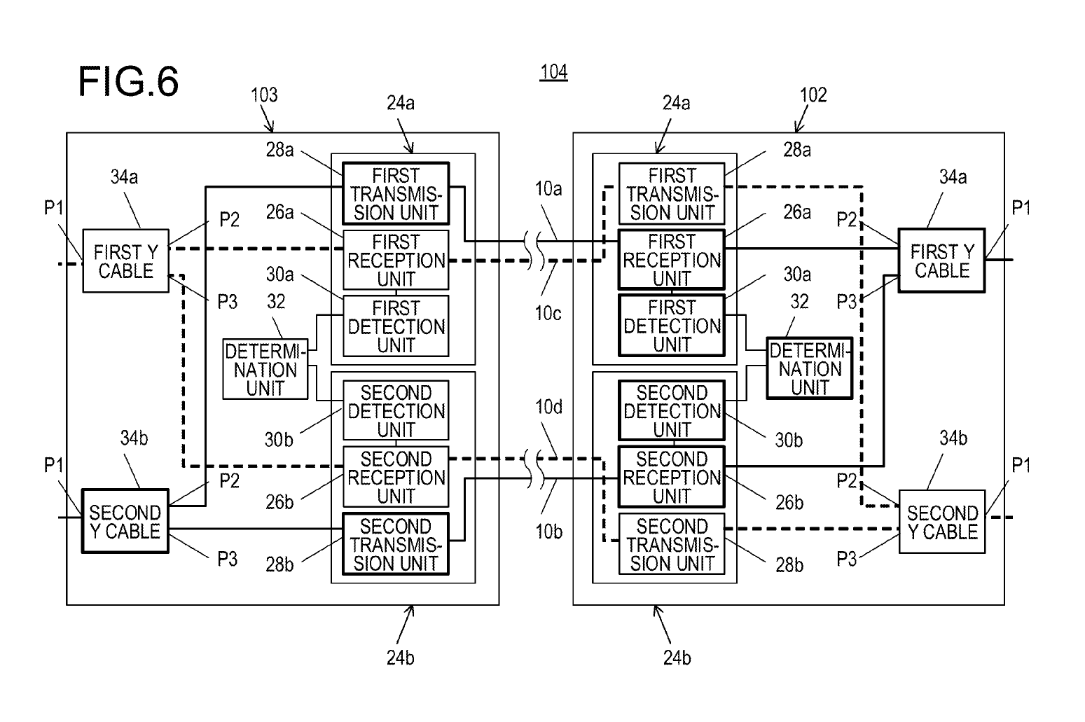

FIG. 6 is a diagram illustrating another example of an optical communication system to which an optical transmission device 102 of the first embodiment is applied. According to the optical communication system 104, a bidirectional communication becomes available.

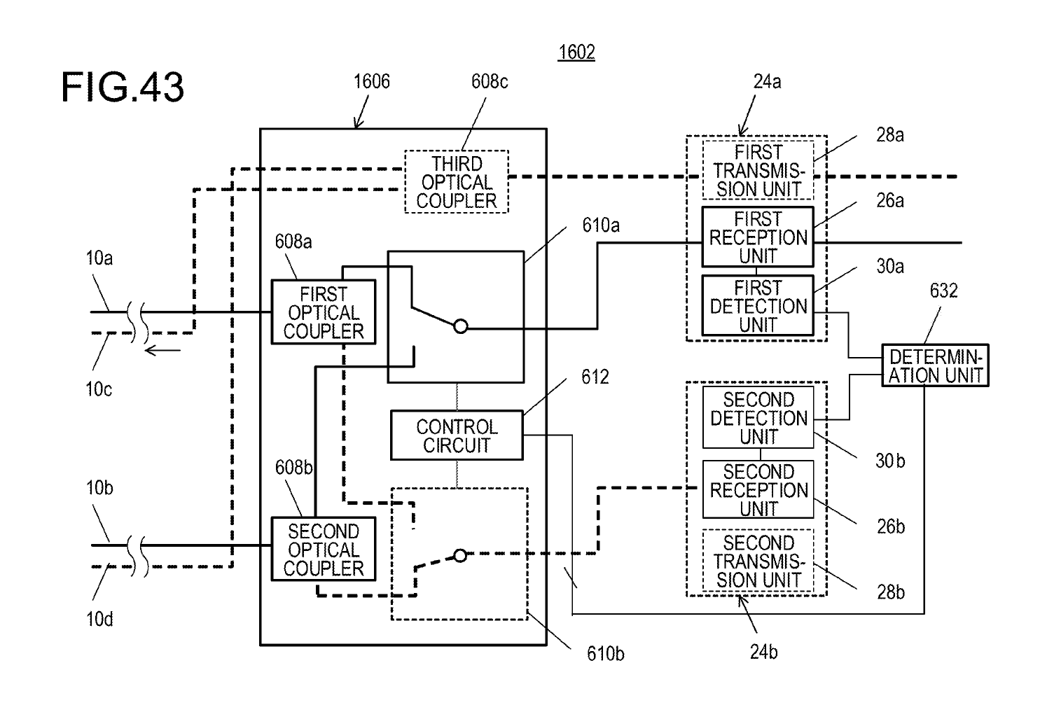

A signal line marked by a thick solid line or a thick dashed line in FIG. 6 indicates an optical line (e.g., an optical waveguide or optical fiber) (the same applies to, for example, FIG. 43 which will be described below). A signal line marked by a thin solid line or a thin dashed line in FIG. 6 indicates an electrical line (e.g., an electrical wire) (the same applies to, for example, FIG. 43 which will be described below).

The optical communication system 104 includes an optical transmission device 102, another optical transmission device 103, and a first route 10a to a fourth route 10d. The optical transmission device 102 corresponds to the optical transmission device 2 of Configuration Example 1 (see FIG. 1). The optical transmission device 103 corresponds to the optical transmission device 3 of Configuration Example 1.

[Optical Transmission Device]

The optical transmission device 102 includes a first transponder 24a, a second transponder 24b, a determination unit 32, a first Y cable 34a, and a second Y cable 34b.

The optical transmission device 103 has substantially the same structure as that of the optical transmission device 102. Further, the optical transmission device 103 is configured to perform substantially the same operation as that of the optical transmission device 102. Therefore, the description of the optical transmission device 103 will be omitted or simplified.

(1-2-1) Transponder

The first transponder 24a includes a first reception unit 26a, a first transmission unit 28a, and a first detection unit 30a. Similarly, the second transponder 24b includes a second reception unit 26b, a second transmission unit 28b, and a second detection unit 30b.

The first reception unit 26a and the second reception unit 26b have substantially the same structure and function with each other. Similarly, the first transmission unit 28a and the second transmission unit 28b have substantially the same structure and function with each other. Further, the first detection unit 30a and the second detection unit 30b have substantially the same structure and function with each other.

(1-2-2) Determination Unit

The determination unit 32 makes a determination based on the first polarization fluctuation amount 46a of the first signal light 6a. Further, the determination unit 32 controls the first reception unit 26a and the second reception unit 26b based on a result of the determination.

(1-2-3) Y Cable

The first Y cable 34a includes a first port P1 connected to a communication device (not illustrated) such as a router or an L2 switch. The first Y cable 34a further includes a second port P2 connected to the first reception unit 26a and a third port P3 connected to the second reception unit 26b.

The second Y cable 34b includes the first port P1 connected to the communication device (not illustrated) such as the router or the L2 switch. The second Y cable 34b further includes the second port P2 connected to the first transmission unit 28a and the third port P3 connected to the second transmission 28b.

The first Y cable 34a emits the signal light incident on the second port P2 from the first port P1. The first Y cable 34a also emits the signal light incident on the third port P3 from the first port P1. The second Y cable 34b divides the signal light incident on the first port P1 and emits the divided signal light from the second port P2 and the third port P3.

The first Y cable 34a and the second Y cable 34b are, for example, an optical coupler having a directional coupler or a Y branching device having a planar waveguide.

(1-2-4) Route

The first route 10a connects the first transmission unit 28a of the optical transmission device 103 and the first reception unit 26a of the optical transmission device 102 to each other. The second route 10b connects the second transmission unit 28b of the optical transmission device 103 and the second reception unit 26b of the optical transmission device 102 to each other.

The third route 10c connects the first transmission unit 28a of the optical transmission device 102 and the first reception unit 26a of the optical transmission device 103 to each other. The fourth route 10d connects the second transmission unit 28b of the optical transmission device 102 and the second reception unit 26b of the optical transmission device 103 to each other.

The third route 10c is a route extending along the first route 10a. The first route 10a and the third route 10c penetrate, for example, an OPGW (hereinafter, referred to as a two-core OPGW) including two optical fibers. That is, the first route 10a is a route that passes through one optical fiber of the two-core OPGW. The third route 10c is a route that passes through the other optical fiber of the two-core OPGW penetrated by the first route 10a.

Similarly, the fourth route 10d is a route extending along the second route 10b. The second route 10b is a route that passes through one optical fiber of the two-core OPGW. The fourth route 10d is a route that passes through the other optical fiber of the two-core OPGW penetrated by the second route 10b.

The reception unit 20 of Configuration Example 1 (see FIG. 1) is, for example, a block including the first reception unit 26a of the optical transmission device 102, the second reception unit 26b of the optical transmission device 102, the first Y cable 34a of the optical transmission device 102, and the judgment unit 32 of the optical transmission device 102.

The detection unit 22 of Configuration Example 1 (see FIG. 1) is, for example, a block including the first detection unit 30a of the optical transmission device 102. The detection unit 22 of Configuration Example 1 may include the second detection unit 30b of the optical transmission device 102. Further, the detection unit 22 of a third embodiment to be described later is a block including both the first detection unit 30a and the second detection unit 30b.

The transmission unit 8 of Configuration Example 1 (see FIG. 1) is, for example, a block including the first transmission unit 28a of the optical transmission device 103, the second transmission unit 28b of the optical transmission device 103, and the second Y cable 34b of the optical transmission device 103.

(1-2-5) Operation

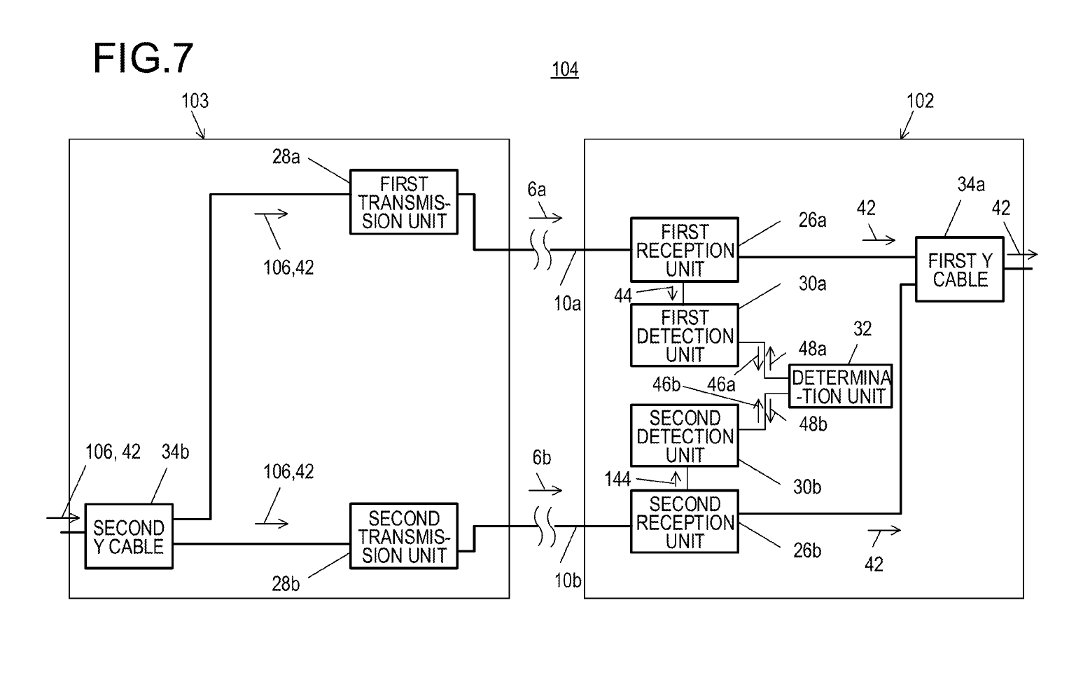

FIG. 7 is a diagram illustrating a portion corresponding to the reception unit 20 of Configuration Example 1, a portion corresponding to the detection unit 22, of Configuration Example 1, and a portion corresponding to the transmission unit 8 of Configuration Example 1. In FIG. 7, the flow of the signal is illustrated.

The second Y cable 34b of the optical transmission device 103 divides signal light 106 received from a communication device (not illustrated) and transmits the divided signal light to the first transmission unit 28a and the second transmission unit 28b of the optical transmission device 103. The signal light 106 is, for example, light of which intensity is modulated to transmit the transmission information 42.

The first transmission unit 28a of the optical transmission device 103 converts the received signal light 106 into the first signal light 6a and transmits the first signal light 6a to the first reception unit 26a of the optical transmission device 102. Similarly, the second transmission unit 28a of the optical transmission device 103 converts the received signal light 106 into the second signal light 6b and transmits the second signal light 6b to the second reception unit 26b of the optical transmission device 102.

The first reception unit 26a of the optical transmission device 102 converts the received first signal light 6a into an electrical signal (hereinafter, referred to as a first electrical signal). The first reception unit 26a also regenerates the transmission information 42 from the first electrical signal (that is, demodulates and decodes the signal light).

The first detection unit 30a acquires data 44 from the first reception unit 26a. The data 44 is obtained in the process of reproducing the transmission information 42 from the first electrical signal. The first detection unit 30a derives (i.e., detects) the first polarization fluctuation amount 46a of the first signal light 6a based on the data 44. The first detection unit 30a transmits the derived first polarization fluctuation amount 46a to the determination unit 32.

The second reception unit 26b of the optical transmission device 102 converts the received second signal light 6b into an electrical signal (hereinafter, referred to as a second electrical signal). The second reception unit 26b also reproduces the transmission information 42 from the second electrical signal. The transmission information 42 reproduced by the second reception unit 26b is the same information as the transmission information 42 reproduced by the first reception unit 26a.

The determination unit 32 determines whether the absolute value of the received first polarization fluctuation amount 46a exceeds the first threshold. That is, the determination unit 32 monitors the fluctuation amount 46a of the polarization state of the first signal light 6a from the first route 10a.

When the determination unit 32 determines that the absolute value of the received first polarization fluctuation amount 46a exceeds the first threshold, the determination unit 32 transmits a first command 48a to the first reception unit 26a via, for example, the first detection unit 30a. The determination unit 32 also transmits a second command 48b to the second reception unit 26b via the second detection unit 30b. The first command 48a is a command for prohibiting outputting the transmission information 42. The second command 48b is a command for starting outputting the transmission information 42.

Until the first reception unit 26a receives the first command 48a, the first reception unit 26a outputs the transmission information 42 reproduced from the first signal light 6a via the first Y cable 34a. Upon receiving the first command 48a, the first reception unit 26a stops outputting the transmission information 42. Until the second reception unit 26b receives the second command 48b, the second reception unit 26b does not output the reproduced transmission information 42. After the second reception unit 26b receives the second command 48b, the second reception unit 26b outputs the transmission information 42 via the first Y cable 34a.

That is, the portion in the optical transmission device 102 corresponding to the receiving unit 20 (see FIG. 1) monitors the first polarization fluctuation amount 46a detected by the first detection unit 30a and outputs the transmission information 42 reproduced by the first reception unit 26a before the absolute value of the first polarization fluctuation amount 46a exceeds the first threshold. Further, the portion in the optical transmission device 102 corresponding to the reception unit 20 outputs the transmission information 42 reproduced by the second reception unit 26b after the absolute value of the first polarization fluctuation amount 46a exceeds the first threshold.

For example, the first reception unit 26a outputs the transmission information 42 with the intensity-modulated signal light. The same applies to the second reception unit 26b as well.

### (2) Hardware

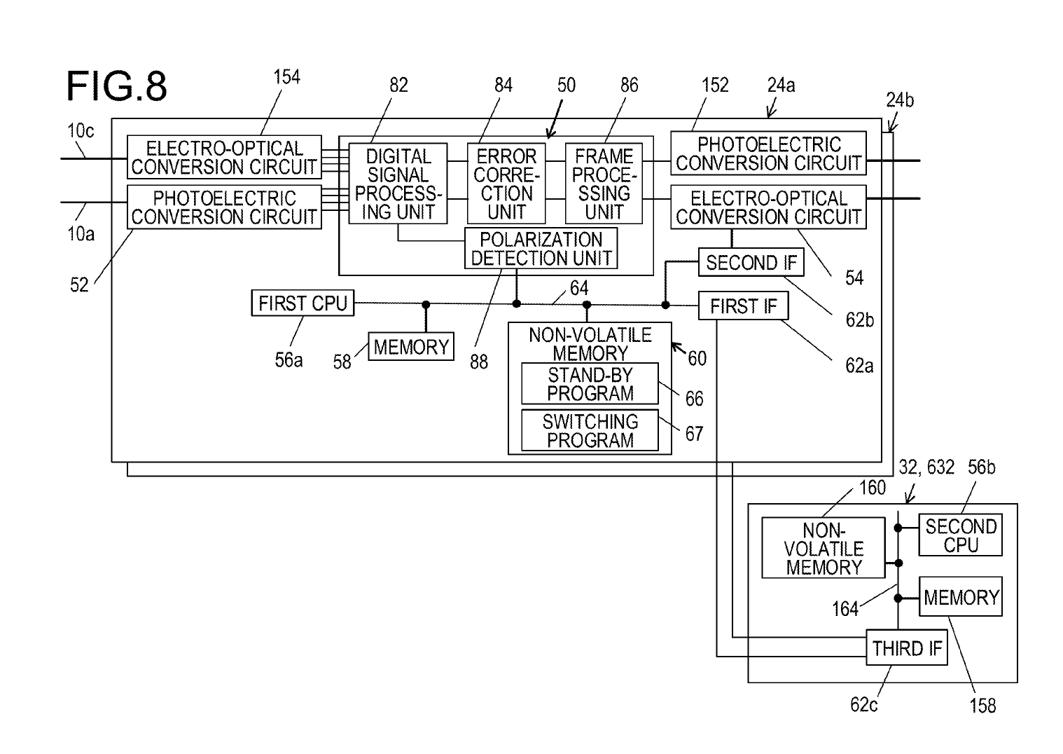

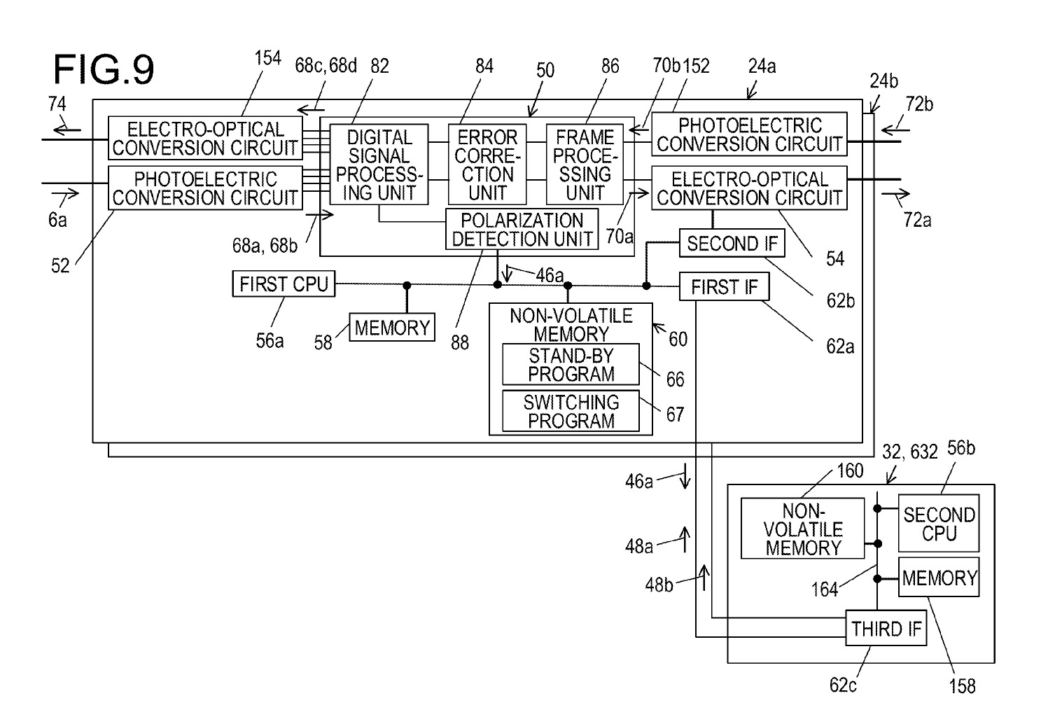

FIG. 8 is a diagram illustrating examples of hardware configurations of a first transponder 24a and a determination unit 32. FIG. 9 is a diagram illustrating a flow of a signal in FIG. 8.

The first transponder 24a is a transponder for a digital coherent light transmission. The digital coherent optical transmission is a technique that applies digital signal processing which performs signal processing in a baseband by separating the electrical signal into an in-phase component and an orthogonal component to a coherent optical communication. The first transponder 24a and the second transponder 24b have substantially the same structure and function with each other. Therefore, the description of the second transponder 24b will be omitted.

### (2-1) First Transponder

The first transponder 24a is configured to transmit and receive signal light modulated according to, for example, dual polarization quadrature phase-shift keying (QPSK).

The first transponder 24a includes, for example, a digital signal processor (DSP) chip 50, a photoelectric conversion circuit 52 connected to the first route 10a, and an electro-optic conversion circuit 54 connected to the first Y cable 34a (see FIG. 6).

The DSP chip 50 is a microprocessor specialized for the signal processing of the digital coherent optical transmission. The DSP chip 50 is hardware. One end of the photoelectric conversion circuit 52 is connected to the first route 10a, and the other end of the photoelectric conversion circuit 52 is connected to the DSP chip 50. One end of the electro-optic conversion circuit 54 is connected to the first Y cable 34a, and the other end of the electro-optic conversion circuit 54 is connected to the DSP chip 50.

The first transponder 24a also includes a photoelectric conversion circuit 152 connected to the second Y cable 34b (see FIG. 6) and an electro-optic conversion circuit 154 connected to the third route 10c. One end of the photoelectric conversion circuit 152 is connected to the second Y cable 34b, and the other end of the photoelectric conversion circuit 152 is connected to the DSP chip 50. One end of the electro-optic conversion circuit 154 is connected to the third route 10c, and the other end of the electro-optic conversion circuit 154 is connected to the DSP chip 50.

The first transponder 24a also includes a central processing unit (CPU) 56a (hereinafter, referred to as a first CPU), a memory 58, a non-volatile memory 60, a first interface circuit 62a, a second interface circuit 62b, and a bus 64. The first CPU 56a, the DSP chip 50, the memory 58, the non-volatile memory 60, the first interface circuit 62a, and the second interface circuit 62b are connected to the bus 64.

The memory 58 is, for example, a random access memory (RAM) (the same applies to, for example, a memory 158 as well which will be described later). The non-volatile memory 60 is, for example, a flash memory (the same applies to, for example, the non-volatile memory 160 as well which will be described later).

The first CPU 56a that executes software is hardware. The same applies to a second CPU 56b as well to be described later.

(2-2-1) Photoelectric Conversion Circuit Connected to First Route

The photoelectric conversion circuit 52 connected to the first route 10a is a device that converts the received light (e.g., the first signal light 6a) into a first electrical signal 68a (see FIG. 9) and a second electrical signal 68b. The photoelectric conversion circuit 52 is, for example, a dual polarization QPSK receiver (see, e.g., Patent Document 3). The photoelectric conversion circuit 52 is, for example, a circuit for performing a homodyne detection.

Therefore, the photoelectric conversion circuit 52 includes a local oscillation light source (e.g., a semiconductor laser). A frequency of the local oscillation light is, for example, a frequency which is substantially the same as the frequencies of the first signal light 6a and the second signal light 6b.

The first electrical signal 68a is a signal corresponding to a phase of a component (hereinafter, referred to as an X polarized wave) polarized in a first direction among the received light. The first electrical signal 68a is a parallel signal having, for example, an electrical signal (so-called I channel) corresponding to the in-phase component of the X polarized wave and an electrical signal (so-called Q channel) corresponding to the orthogonal component of the X polarized wave. A reference of the phase is the phase of the local oscillation light (laser light) (hereinafter, the same).

The second electrical signal 68b is a signal corresponding to the phase of a component (hereinafter, referred to as a Y polarized wave) polarized in a second direction orthogonal to the first direction among the received light. The second electrical signal 68b is a parallel signal having, for example, the electrical signal corresponding to the in-phase component of the Y polarized wave (so-called I channel) and the electrical signal corresponding to the orthogonal component of the Y polarized wave (so-called Q channel).

(2-2-2) Electro-Optic Conversion Circuit Connected to First Y Cable

The electro-optic conversion circuit 54 connected to the first Y cable 34a is a circuit that converts an electrical signal 70a (see FIG. 9) from the DSP chip 50 into signal light 72a which is intensity-modulated.

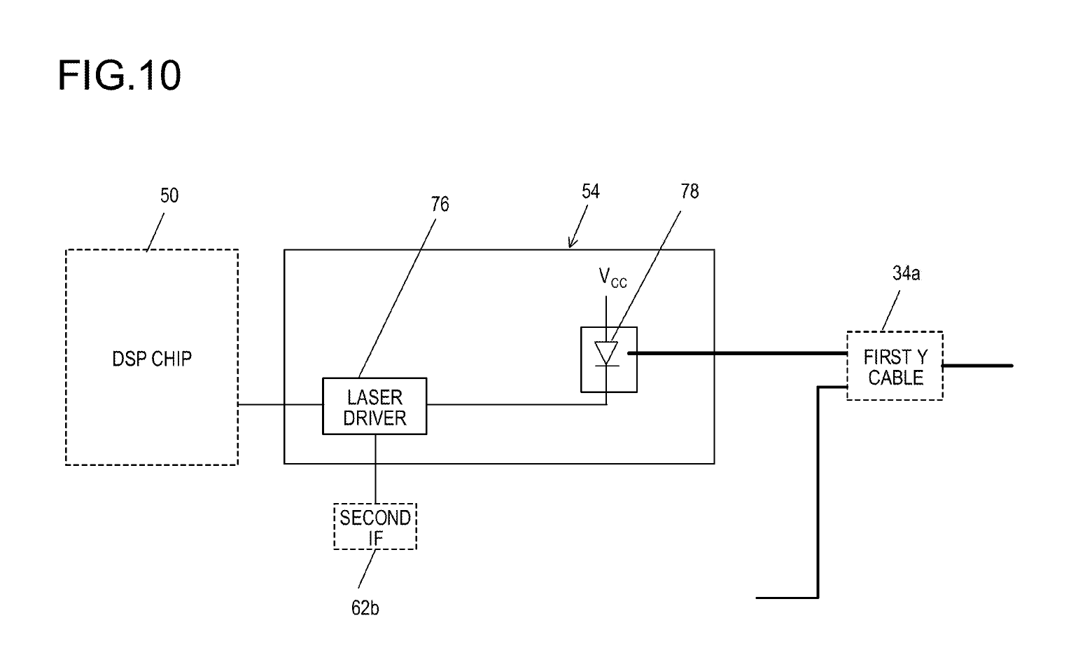

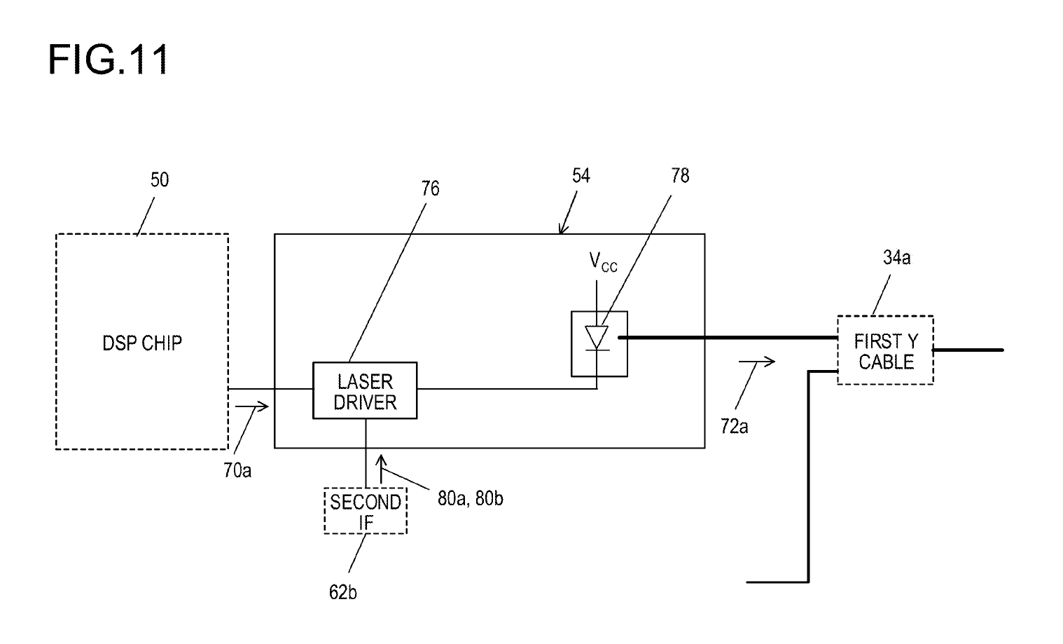

FIG. 10 is a diagram illustrating an example of a hardware configuration of an electro-optical conversion circuit 54 connected to a first Y cable 34a. FIG. 11 is a diagram illustrating the flow of the signal in FIG. 10. The electro-optic conversion circuit 54 includes a laser driver 76 and a semiconductor laser 78.

The laser driver 76 supplies driving current to the semiconductor laser 78 in response to the electrical signal 70a (see FIG. 11) from the DSP chip 50. The semiconductor laser 78 generates the signal light 72a which is intensity-modulated in response to the driving current. The generated signal light 72a is transmitted to the first Y cable 34a via the optical line. The signal light 72a is signal light for transmitting the transmission information 42 (see FIG. 7).

The laser driver 76 stops driving the laser driver 76 in response to a first control signal 80a from the first CPU 56a. The laser driver 76 starts driving the semiconductor laser 78 in response to a second control signal 80b from the first CPU 56a.

The first control signal 80a is sent to the laser driver 76 via the second interface circuit 62b. The same applies to the second control signal 80b as well.

(2-2-3) Photoelectric Conversion Circuit Connected to Second Y Cable

The photoelectric conversion circuit 152 connected to the second Y cable 34b is a device that converts signal light 72b (see FIG. 9) which is intensity-modulated into an electrical signal 70b. The signal light 72b is signal light from a communication device (not illustrated). The signal light 72b corresponds to, for example, the signal light 106 in the optical transmission device 103 (see FIG. 7).

(2-2-4) Electro-Optic Conversion Circuit Connected to Third Route

The electro-optic conversion circuit 154 connected to the third route 10c converts a third electrical signal 68c and a fourth electrical signal 68d from the DSP chip 50 into coherent modulation light 74 (hereinafter, referred to as transmission light) in which the phase of the X polarized wave and the phase of the Y polarized wave are modulated. The electro-optic conversion circuit 154 is, for example, a dual polarization QPSK modulator (so-called IQ modulator) (see, e.g., Patent Document 4).

The third electrical signal 68c is, for example, a parallel signal having the electrical signal corresponding to the in-phase component of the X polarized wave of the transmission light 74 and the electrical signal corresponding to the orthogonal component of the X polarized wave of the transmission light 74. The fourth electrical signal 68d is, for example, a parallel signal having the electrical signal corresponding to the in-phase component of the Y polarized wave of the transmission light 74 and the electrical signal corresponding to the orthogonal component of the Y polarized wave of the transmission light 74.

The transmission light 74 corresponds to, for example, the first signal light 6a (or the second signal light 6b) in the optical transmission device 103 (see FIG. 7).

(2-2-5) DSP Chip

As illustrated in FIG. 9, the DSP chip 50 is an integrated circuit having a digital signal processing unit 82, an error correction unit 84, a frame processing unit 86, and a polarization detection unit 88.

The digital signal processing unit 82 converts the first electrical signal 68a and the second electrical signal 68b from the photoelectric conversion circuit 52 into data (parallel bit string) and transmits the data to the error correction unit 84. In the process of converting the first electrical signal 68a and the second electrical signal 68b into the data, the digital signal processing unit 82 calculates the phase of the X polarized wave and the phase of the Y polarized wave of the signal light (e.g., the first signal light 6a).

The error correction unit 84 corrects errors of the data from the digital signal processing unit 82 and transmits the error-corrected data to the frame processing unit 86. The frame processing unit 86 serializes the error-corrected data to generate the electrical signal 70a.

The frame processing unit 86 also converts the serial electric signal 70b from the photoelectric conversion circuit 152 into the data (parallel bit string) and supplies the data to the error correction unit 84.

The error correction unit 84 corrects the errors of the data from the frame processing unit 86 and supplies the error-corrected data to the digital processing unit 82. The digital signal processing unit 82 generates the third electrical signal 68c and the fourth electrical signal 68d from the error-corrected data. The digital signal processing unit 82 supplies the generated third electrical signal 68c and fourth electrical signal 68d to the electro-optic conversion circuit 154.

The polarization detection unit 88 acquires the phase of the X polarized wave of the signal light (e.g., the first signal light 6a) from the digital signal processing unit 82. The polarization detection unit 88 also acquires the phase of the Y polarized wave of the signal light (e.g., the first signal light 6a) from the digital signal processing unit 82. The polarization detection unit 88 derives a polarization fluctuation amount (e.g., the first polarization fluctuation amount 46a) of the signal light (e.g., the first signal light 6a) based on the phase of the X polarized wave and the phase of the Y polarized wave. The polarization detection unit 88 transmits the derived polarization fluctuation amount 46a to the determination unit 32 via the first interface circuit 62a (see FIG. 8).

### (2-2) Determination Unit

The determination unit 32 includes a CPU 56b (hereinafter, referred to as a second CPU), the memory 158, the non-volatile memory 160, a third interface circuit 62c, and a bus 164. The second CPU 56b, the memory 158, the non-volatile memory 160, and the third interface circuit 62c are connected to the bus 164.

The first reception unit 26a of the optical transmission device 102 (see FIG. 6) is implemented by the photoelectric conversion circuit 52, the DSP chip 50, the electro-optic conversion circuit 54, the first CPU 56a, and the memory 58 in the first transponder 24a of the optical transmission device 102.

The second reception unit 26b of the optical transmission device 102 is implemented by the photoelectric conversion circuit 52, the DSP chip 50, the electro-optic conversion circuit 54, the first CPU 56a, and the memory 58 in the second transponder 24b of the optical transmission device 102.

The determination unit 32 of the optical transmission device 102 is implemented by the second CPU 56b and the memory 158 of the optical transmission device 102.

The first detection unit 30a of the optical transmission device 102 is implemented by the DSP chip 50 (particularly, the polarization detection unit 88) in the first transponder 24a of the optical transmission device 102.

The second detection unit 30b of the optical transmission device 102 is implemented by the DSP chip 50 (particularly, the polarization detection unit 88) in the second transponder 24b of the optical transmission device 102.

The first transmission unit 28a of the optical transmission device 103 is implemented by the photoelectric conversion circuit 152, the DSP chip 50, and the electro-optic conversion circuit 154 in the first transponder 24a of the optical transmission device 103.

The second transmission unit 28b of the optical transmission device 103 is implemented by the photoelectric conversion circuit 152, the DSP chip 50, and the electro-optic conversion circuit 154 in the second transponder 24b of the optical transmission device 103.

### (3) Software

### (3-1) Program and Data

As illustrated in FIG. 8, in the non-volatile memory 60 of the first transponder 24a, the stand-by program 66 and the switching program 67 are recorded. The same applies to the non-volatile memory 60 of the second transponder 24b as well.

The processing by the stand-by program 66 is a processing that is continued endlessly once the processing starts. In the non-volatile memory 60, a program (hereinafter, referred to as a termination program) for forcibly terminating such endless processing may be recorded (this also applies to the second to seventh embodiments). The forced termination by a termination program is an interrupt processing.

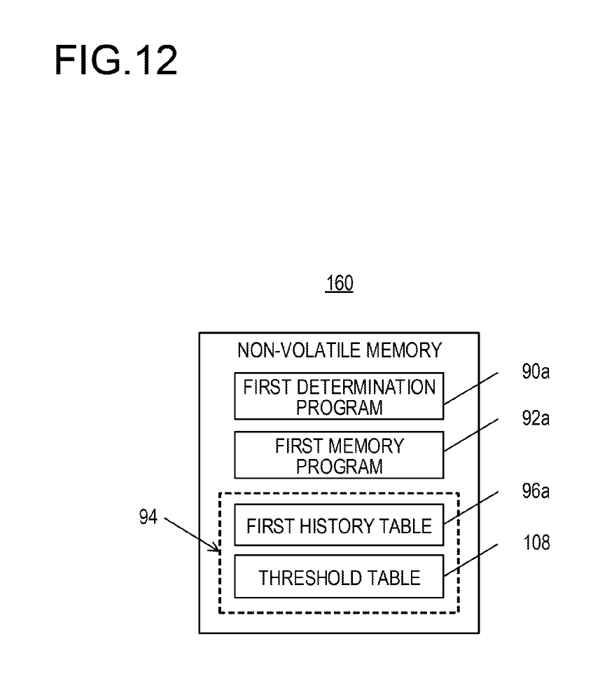

FIG. 12 is a diagram illustrating a program and a data file 94 recorded in a non-volatile memory 160 of the determination unit 32. As illustrated in FIG. 12, a first determination program 90a and a first recording program 92a are recorded in the non-volatile memory 160. The first history table 96a and the threshold table 108 are also recorded in the non-volatile memory 160.

An interrupt program (hereinafter, referred to as a change program) may be recorded in the non-volatile memory 160 in order to change the data recorded in the threshold table 108. The processing by the change program is an interrupt processing for the first judgment program 90a. The processing by the change program is a processing of changing the data recorded in the threshold table 108 to data input from an input device (e.g., a keyboard).

In the non-volatile memory 160, the termination program for forcibly terminating the program executed by the second CPU 56b may be recorded (the same applies to the second to seventh embodiments as well).

(3-1-1) First History Table

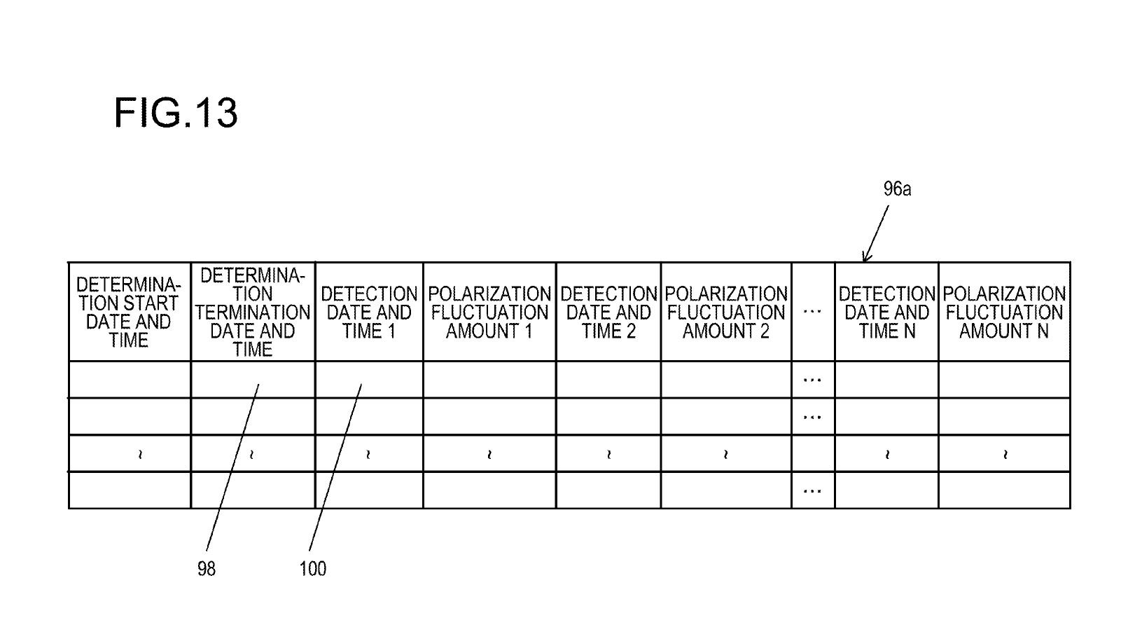

FIG. 13 is a diagram illustrating an example of a first history table 96a used for executing a first recording program 92a. “N” (see a first row of a last column) described in FIG. 13 is an integer other than 0.

The data of each cell in the first row of the first history table 96a indicates contents of data to be recorded in each cell in the second and subsequent rows. The first row may be omitted.

A determination start date and time (see the fourth embodiment) is recorded in each cell of a first column of the first history table 96a. A determination termination date and time (see the fourth embodiment) is recorded in each cell of a second column of the first history table 96a. In the first embodiment, the first and second columns are not used. Therefore, the first and second columns may be omitted.

Cells in odd-numbered columns after a third column are cells for recording the date and time at which the first detection unit 30a detects the first polarization fluctuation amount 46a (hereinafter, referred to as detection date and time). Cells in even-numbered columns after a fourth column are cells for recording the first polarization fluctuation amount 46a detected by the first detection unit 30a.

(3-1-2) Threshold Table

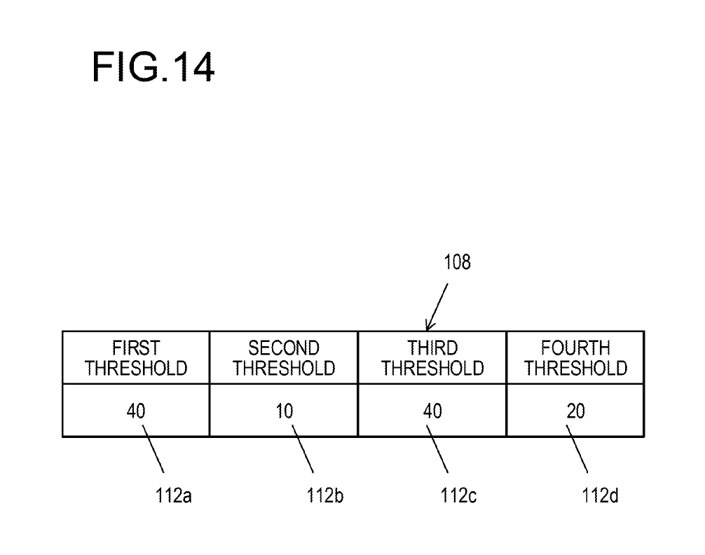

FIG. 14 is a diagram illustrating an example of a threshold table 108 used for executing a first determination program 90a. In each cell of the first row of the threshold table 108, the contents of the data recorded in each cell of the second row are recorded.

A first threshold 112a (e.g., 40 krad/sec) is recorded in the cell of the second row and the first column of the threshold table 108. A second threshold 112b (e.g., 10 krad/sec) is recorded in the cell of the second row and the second column of the threshold table 108. A third threshold 112c (e.g., 40 krad/sec) is recorded in the cell of the second row and the third column of the threshold table 108. A fourth threshold 112d (e.g., 20 krad/sec) is recorded in the cell of the second row and the fourth column of the threshold table 108.

The values of the first threshold 112a to the fourth threshold 112d in FIG. 14 are examples. The second threshold 112b is used in the second embodiment. The third threshold is used in the third embodiment. The fourth threshold 112d is used in a modification of the first embodiment. Accordingly, the second to fourth columns of the threshold table 108 may be omitted.

### (3-2) Processing

(3-2-1) Standby Processing (Processing by Stand-by Program 66)

The first CPU 56a (the CPU of each of the first and second transponders 24a and 24b) reads and executes the stand-by program 66 and the switching program 67 from the non-volatile memory 60 (see FIG. 8). The first CPU 56a concurrently executes the stand-by program 66 and the switching program 67. The first CPU 56a is a CPU having a multitasking function.

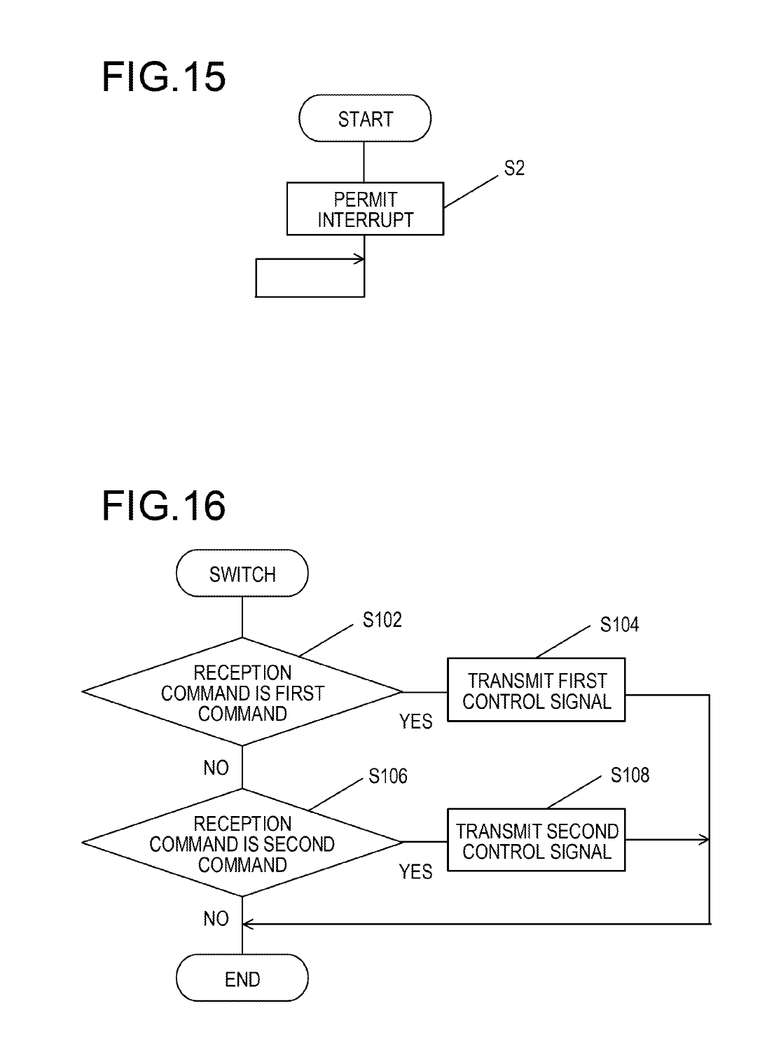

FIG. 15 is a flowchart of a stand-by program 66. The stand-by program 66 is a main processing program.

When the first CPU 56a is activated, the first CPU 56a executes the stand-by program 66. First, the first CPU 56a permits the interrupt processing by, for example, the termination program (operation S2). After operation S2, the first CPU 56a stands by.

The stand-by program 66 is executed by each of the first reception unit 26a (see FIG. 6) and the second reception unit 26b. In other words, the stand-by program 66 is executed by the reception unit 20 (see FIG. 1) including the first reception unit 26a and the second reception unit 26b.

When an execution of the termination program is requested during the execution of the stand-by program 66, the first CPU 56a stops the execution of the stand-by program 66. Thereafter, the first CPU 56a executes the termination program. The stand-by program 66 is terminated by executing the termination program. The termination program is a program (hereinafter, referred to as an interrupt program) for the interrupt processing.

A command for requesting the execution of the termination program is input from, for example, the input device (e.g., the keyboard or the like) connected to the first transponder 24a. The same applies even to the termination program of another program.

(3-2-2) Switching Processing (Processing by Switching Program 67)

FIG. 16 is a flowchart of a switching program 67. The switching program 67 is an interrupt program.

Upon receiving a first command 48a (or a second command 48b) via the first interface circuit 62a (see FIG. 9), the first CPU 56a stops the execution of the stand-by program 66 and executes the switching program 67. The first command 48a and the second command 48b are the commands described in “(1-2-5) Operation.”

[Operation S102]

First, the first CPU 56a determines whether the received command is the first command 48a.

[Operation S104]

When it is determined that the received command is the first command 48a, the first CPU 56a transmits the first control signal 80a to the electro-optic conversion circuit 54 via the second interface circuit 62b. Thereafter, the first CPU 56a terminates the execution of the switching program 67. The first control signal 80a is the signal described in “(2-2-2) Electro-optic conversion circuit connected to first Y cable.” The same applies to the second control signal 80b as well.

[Operation S106]

When it is determined that the received command is not the first command 48a, the first CPU 56a determines whether the received command is the second command 48b. When the received command is not the second command 48b, the first CPU 56a terminates the execution of the switching program 67.

[Operation S108]

When the received command is the second command 48b, the first CPU 56a transmits the second control signal 80b to the electro-optic conversion circuit 54 via the second interface circuit 62b.

Thereafter, the first CPU 56a terminates the execution of the switching program 67. When the switching program 67 is terminated, the first CPU 56a resumes the stand-by program 66.

In the example illustrated in FIG. 16, operations S102 to S104 are executed before operations S106 to S108. However, operations S102 to S104 may be executed after operations S106 to S108.

The switching program 67 is executed by each of the first reception unit 26a (see FIG. 6) and the second reception unit 26b. In other words, the switching program 67 is executed by the reception unit 20 (see FIG. 1).

(3-2-3) First Recording Processing (Processing by First Recording Program 92a)

The second CPU 56b reads and executes the first recording program 92a and the first judgment program 90a from the non-volatile memory 160 (see FIG. 12). The second CPU 56b concurrently executes the first recording program 92a and the first determination program 90a. The second CPU 56b is the CPU having the multitasking function.

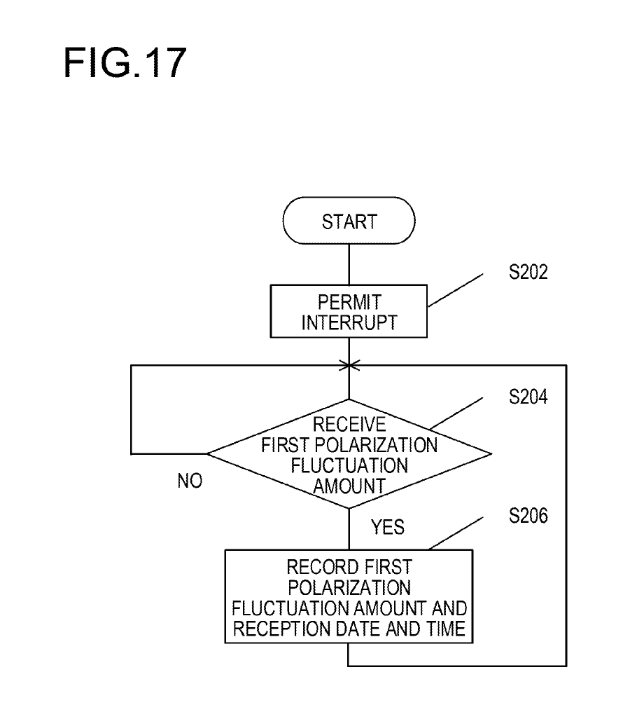

FIG. 17 is a flowchart of the first recording program 92a. The first recording program 92a is a program for recording the first polarization fluctuation amount 46a.

[Operation S202]

When the second CPU 56b is activated, the first recording program 92a is executed. First, the second CPU 56b permits the interrupt processing by, for example, the termination program.

[Operation S204]

After operation S202, the second CPU 56b determines whether a new first polarization fluctuation amount 46a (or an initial first polarization fluctuation amount 46a, hereinafter the same) has been received from the DSP chip 50. The first polarization fluctuation amount 46a (see FIG. 7) is received via the third interface circuit 62c. When the second CPU 56b determines that the new first polarization fluctuation amount 46a has not been received, the second CPU 56b executes operation S204 again.

When the second CPU 56b determines that the new first polarization fluctuation amount 46a has been received, the second CPU 56b proceeds to operation S206.

[Operation S206]

The second CPU 56b records the date and time when the new first polarization fluctuation amount 46a is received in the first history table 96a (see FIG. 13), and the new first polarization fluctuation amount 46a. Thereafter, the second CPU 56b returns to operation S204.

An initial value of each cell in the second and subsequent rows of the first history table 96a is null. In operation S204, for example, the date and time (hereinafter, referred to as reception date and time) at which the first polarization fluctuation amount 46a is received is recorded in a cell 98 for the detection date and time. In operation S204, the first polarization fluctuation amount 46a is also recorded in a cell 100 next to the cell 98 in which the reception date and time is recorded.

For example, the reception date and time is sequentially recorded from the left side to the right side of each row. When data is recorded in all cells for the detection date and time in a predetermined row, the reception date and time to be newly received are recorded in the third column of a next row. The same applies to the first polarization fluctuation amount 46a as well. However, the second CPU 56b may align a row being recorded at a predetermined timing (see the fourth embodiment).

According to the first recording program 92a, the first polarization fluctuation amount 46a of the first signal light 6a detected by the DSP chip 50 and the detection date and time thereof are thoroughly recorded in the first history table 96a. The first recording program 92a is executed by the determination unit 32. In other words, the first recording program 92a is executed by the reception unit 20 including the determination unit 32.

(3-2-4) First Judgment Processing (Processing by First Determination Program 90a)

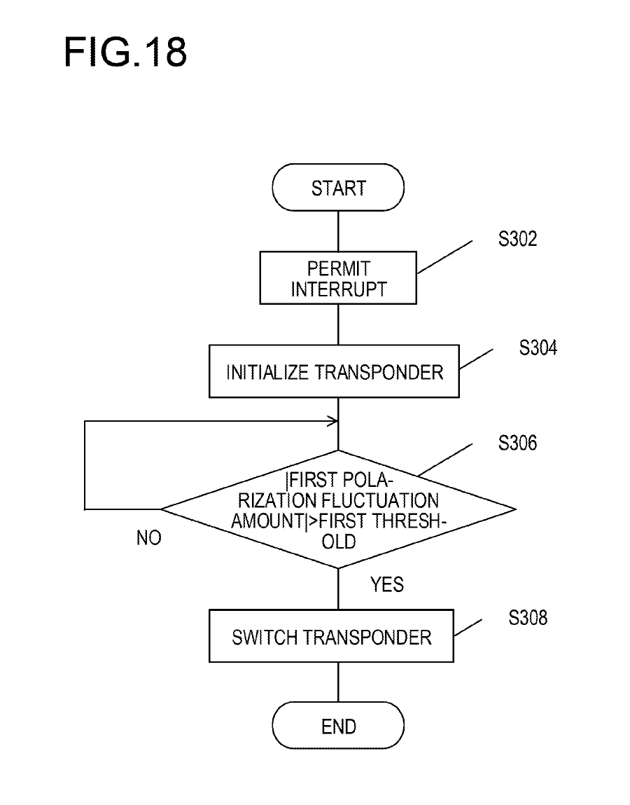

FIG. 18 illustrates an example of the flowchart of the first determination program 90a.

[Operation S302]

When the second CPU 56b is activated, the first determination program 90a (see FIG. 18) is executed. First, the second CPU 56b permits the interrupt processing by, for example, the termination program.

[Operation S304]

After operation S302, the second CPU 56b transmits the second command 48b to the first transponder 24a. The second CPU 56b transmits the first command 48a to the second transponder 24b.

The first transponder 24a starts outputting the transmission information 42 in response to the second command 48b. Meanwhile, the second transponder 24b does not output the transmission information 42 in response to the first command 48a.

In operation S304, the first transponder 24a and the second command 48b are initialized. The first transponder 24a may be initialized by the first transponder 24a itself. Similarly, the second transponder 24b may be initialized by the second transponder 24b itself. In this case, operation S304 is omitted.

[Operation S306]

After operation S304, the second CPU 56b determines whether the absolute value of a latest first polarization fluctuation amount 46a recorded in the first history table 96a (see FIG. 13) is larger than the first threshold 112a recorded in the threshold table 108. The latest first polarization fluctuation amount 46a means the first polarization fluctuation amount 46a last recorded in the first history table 96a.

When the second CPU 56b determines that the absolute value of the first polarization fluctuation amount 46a does not exceed the first threshold 112a, the second CPU 56b executes operation S306 again.

The latest first polarization fluctuation amount 46a is detected based on the detection date and time recorded in the first history table 96a. Even while the second CPU 56b executes the first determination program 90a, the new first polarization fluctuation amount 46a and the detection date and time thereof are recorded in the first history table 96a. It is preferable that a period in which the second CPU 56b repeats operation S306 is shorter than a period in which the first polarization fluctuation amount 46a and the detection date and time thereof are recorded (the same applies to operation S408 as well to be described below).

[Operation S308]

When the second CPU 56b determines that the absolute value of the latest first polarization fluctuation amount 46a exceeds the first threshold 112a, the second CPU 56b switches a transponder that outputs the transmission information 42 from the first transponder 24a to the second transponder 24b.

Specifically, for example, the second CPU 56b transmits the first command 48a to the first transponder 24a and transmits the second command 48b to the second transponder 24b. After operation S308, the second CPU 56b terminates the first determination processing.

The first determination program 90a is executed by the determination unit 32 (see FIG. 7). In other words, the first determination program 90a is executed by the reception unit 20 (see FIG. 1) including the determination unit 32.

### (4) Optical Transmission Method

As described above, the optical transmission device 2 according to the first embodiment receives the first signal light 6a for transmitting the transmission information 42 from the first route 10a, and receives the second signal light 6b for transmitting the transmission information 42 from the second route 10b different from the first route 10a.

The optical transmission device 2 monitors the first polarization fluctuation amount 46a which is a change amount of the parameter indicating the polarization state within a predetermined time and is the change amount of the light from the first route 10a. In addition, before the absolute value of the first polarization fluctuation amount 46a exceeds the first threshold 112a, the optical transmission device 2 outputs the transmission information 42 transmitted by the first signal light 6a. After the absolute value of the first polarization fluctuation amount 46a exceeds the first threshold 112a, the optical transmission device 2 also outputs the transmission information 42 transmitted by the second signal light 6b.

### (5) Modification

### (5-1) Modification 1

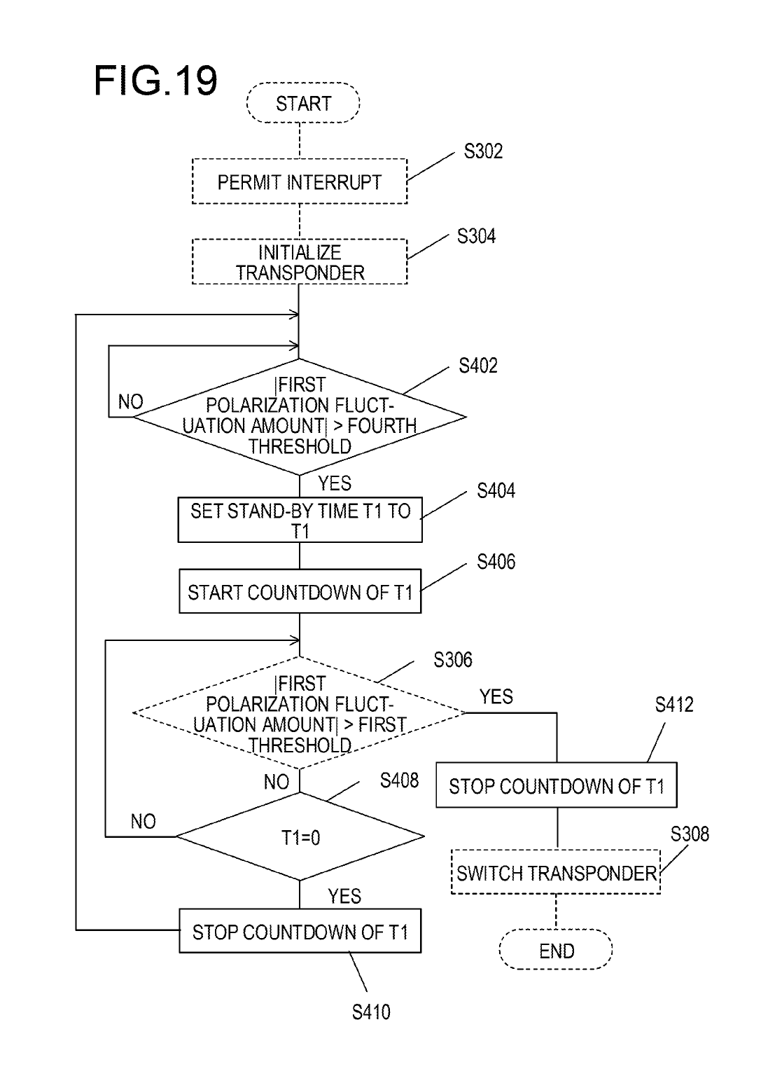

FIG. 19 is a diagram illustrating a modification of the first determination program 90a. Among the operations illustrated in FIG. 19, the operations marked by the dashed lines are the operations included in the flowchart of FIG. 18. Therefore, the description of the operations marked by the dashed lines will be omitted or simplified. According to the modification, the switching of the transponder due to a temporary cause other than the lightning is suppressed.

[Operation S402]

After operation S304, the second CPU 56b first determines whether the absolute value of the latest first polarization fluctuation amount 46a is larger than the fourth threshold 112d recorded in the threshold table 108 (see FIG. 14), by referring to the first history table 96a (see FIG. 13). When the second CPU 56b determines that the absolute value of the latest first polarization fluctuation amount 46a does not exceed the fourth threshold, the second CPU 56b executes operation S402 again.

The fourth threshold 112d is, for example, a value larger than 0 and smaller than the first threshold (e.g., 1 to 40 krad/sec). The fourth threshold 112d is, for example, 1 to 20 krad/sec.

When the second CPU 56b determines that the absolute value of the latest first polarization fluctuation amount 46a is larger than the fourth threshold 112d, the second CPU 56b proceeds to operation S404.

[Operation S404]

The second CPU 56b sets a stand-by time T1 of a timer to t1. The timer of the first embodiment is a timer on the software (the same applies to the timer of the second to seventh embodiments as well to be described below). The t1 is, for example, 1 to 15 minutes.

[Operation S406]

After operation S404, the second CPU 56b starts the countdown of the timer.

[Operation S306]

After operation S406, the second CPU 56b determines whether the absolute value of the latest first polarization fluctuation amount 46a recorded in the first history table 96a is larger than the first threshold 112a recorded in the threshold table 108. When the second CPU 56b determines that the absolute value of the first polarization fluctuation amount 46a does not exceed the first threshold 112a, the second CPU 56b proceeds to operation S408. When the second CPU 56b determines that the absolute value of the first polarization fluctuation amount 46a exceeds the first threshold 112a, the second CPU 56b proceeds to operation S412.

[Operation S408]

The second CPU 56b determines whether the stand-by time T1 of the timer is 0. When the second CPU 56b determines that the stand-by time T1 of the timer is not 0, the second CPU 56b returns to operation S306. When the second CPU 56b determines that the stand-by time T1 of the timer is 0, the second CPU 56b proceeds to operation S410.

[Operation S410]

The second CPU 56b stops the countdown of the timer and returns operation S402.

[Operation S412]

The second CPU 56b stops the countdown of the timer and proceeds to operation S308.

[Operation S308]

The second CPU 56b switches the transponder for outputting the transmission information 42 from the first transponder 24a to the second transponder 24b. Thereafter, the second CPU 56b terminates the program of the modification.

As described above, according to the modification, when the absolute value of the first polarization fluctuation amount 46a exceeds the first threshold within a predetermined time t1 after the absolute value of the first polarization fluctuation amount 46a exceeds the fourth threshold, the transponder for outputting the transmission information is switched to the second transponder 24b.

Each operation of the modification is executed by the determination unit 32 (see FIG. 7). In other words, each operation of the modification is executed by the reception unit 20 (see FIG. 1) including the determination unit 32.

The polarization fluctuation amount of the signal light may also fluctuate abruptly due to causes (e.g., mechanical vibration) other than the lightning. Such fluctuation occurs almost temporarily. In the modification, the transponder is switched when the polarization fluctuation amount exceeds the fourth threshold 112d and then exceeds the first threshold 112a within the predetermined time t1. Therefore, according to the modification, the switching of the transponder due to a temporary cause other than the lightning is suppressed.

### (5-2) Modification 2

In the above example, the polarization fluctuation amount detected by the first detection unit 30a is a change amount (that is, a rotational speed) of a rotational angle of the polarization plane of light (or electromagnetic wave) generated by the interference between the first signal light 6a and the local oscillation light within a predetermined time. However, the polarization fluctuation amount derived by the first detection unit 30a may be other than the change amount of the rotational angle of the polarization plane within the predetermined time. The polarization fluctuation amount detected by the first detection unit 30a may be, for example, a change amount of a Stokes parameter of the first signal light 6a within the predetermined time.

### (6) Alternative

The transmission error due to the lightning may also be suppressed by transmitting the signal light through a polarization maintaining fiber. However, the optical fiber of the existing OPGW is most a single mode optical fiber. Therefore, it is difficult to suppress the transmission error by the polarization maintaining fiber unless the OPGW having the polarization maintaining fiber is newly installed.

Even though the polarization state of the first signal light 6a fluctuates, it is possible to eliminate the influence of the fluctuation of the polarization state based on the phase of the X polarized wave and the phase of the Y polarized wave of the first signal light 6a (that is, compensation of the polarization fluctuation). However, it is difficult to compensate the polarization fluctuation when the polarization fluctuation amount is large or when a bit rate of the signal light is high (especially when the bit rate is 100 Gbps or higher).

The transmission error due to the lightning may also be suppressed by polarization diversity. However, the optical communication by the polarization diversity has not been in practical use.

As described above, there is a problem in the transmission error suppression method that may be considered as an alternative to the first embodiment. Meanwhile, the optical transmission device of the first embodiment does not have the problem described above.

The optical transmission device of the first embodiment monitors the first polarization fluctuation amount 46a of the light from the first route 10a, and when the absolute value of the first polarization fluctuation amount 46a exceeds the first threshold, the optical transmission device outputs the same information transmitted by the light of the second route 10b, instead of the information transmitted by the light of the first route 10a. Therefore, according to the first embodiment, the transmission error due to the lightning is suppressed.

### Second Embodiment

The optical transmission device of the second embodiment is a device that resumes the output of the transmission information transmitted by the first signal light when the risk of the transmission error due to the lightning becomes low. The optical transmission device of the second embodiment is similar to the optical transmission device of the first embodiment. Therefore, for example, the description of the same parts as those in the first embodiment will be omitted or simplified.

### (1) Configuration and Operation

The optical transmission device of the second embodiment has substantially the same structure (see FIGS. 1 and 6) as the optical transmission devices 2 and 102 of the first embodiment. That is, the optical transmission device of the second embodiment includes the reception unit 20 and the detection unit 22.

The detection unit 22 of the second embodiment is configured to perform substantially the same operation as the detection unit 22 of the first embodiment. Specifically, the detection unit 22 of the second embodiment is configured to have the same structure as the detection unit 22 of the first embodiment and operate by the same software as used in the first embodiment (the same applies to the reception unit 20 as well).

Similarly, the reception unit 20 of the second embodiment is configured to perform substantially the same operation as the reception unit 20 of the first embodiment. The reception unit 20 of the second embodiment is also configured to resume the output of the transmission information 42 transmitted by the first signal light 6a when the risk of the transmission error due to the lightning becomes low.

Specifically, when the absolute value of the first polarization fluctuation amount 46a detected after the start of the output of the transmission information transmitted by the second signal light continues to be below the second threshold for a predetermined time, the reception unit 20 of the second embodiment resumes the output of the transmission information transmitted by the first signal light. The second threshold is a threshold smaller than the first threshold. The second threshold is, for example, 1 to 20 krad/sec.

When the lightning is away from the first route 10a, the absolute value of the first polarization fluctuation amount 46a continues to be below the second threshold which is smaller than the first threshold. Therefore, the optical transmission device of the second embodiment may resume the output of the transmission information transmitted from the first route 10a when the risk of the transmission error due to the lightning becomes low.

### (2) Hardware

The hardware configuration of the optical transmission device according to the second embodiment is substantially the same as the hardware configuration of the optical transmission devices 2 and 102 according to the first embodiment. Therefore, the description of the hardware configuration of the optical transmission device according to the second embodiment will be omitted.

### (3) Software

### (3-1) Program and Data

In the non-volatile memory 60 of the first and second transponders 24a and 24b (see FIG. 8), the programs (that is, the stand-by program 66 and the switching program 67) described in the first embodiment are recorded (the same applies to the third to fifth embodiments as well).

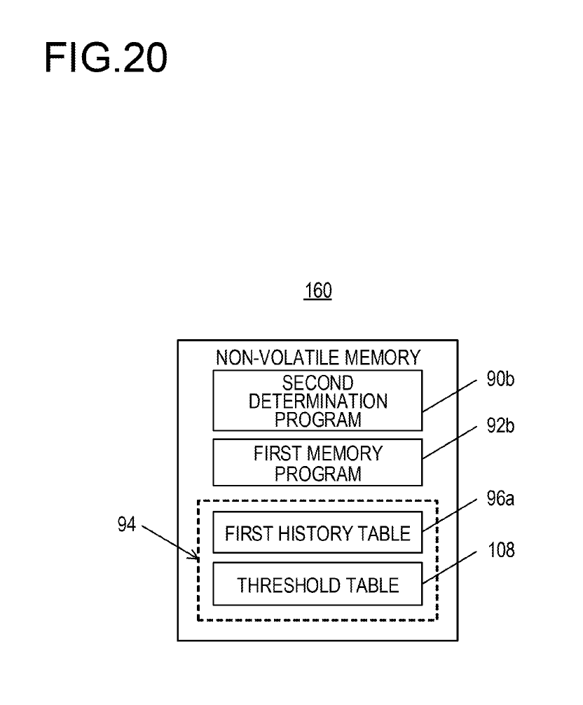

FIG. 20 is a diagram illustrating a program and a data file 94 recorded in a non-volatile memory 160 of the determination unit 32 (see FIG. 8) according to a second embodiment. In the non-volatile memory 160, instead of the first determination program 90a of the first embodiment, a second determination program 90b is recorded. Programs and data other than the second determination program 90b are substantially the same as those recorded in the non-volatile memory 160 of the first embodiment. However, the second threshold 112b and the fourth threshold 112d of the threshold table 108 (see FIG. 14) are not omitted.

### (3-2) Processing

The first CPU 56a (the CPU of each of the first and second transponders 24a and 24b) reads and concurrently executes the stand-by program 66 and the switching program 67 from the non-volatile memory 60 (the same applies to the third to fifth embodiments as well).

Meanwhile, the second CPU 56b reads and concurrently executes the second judgment program 90b and the first recording program 92a from the non-volatile memory 160. The first recording program 92a is described in the first embodiment.

(3-2-1) Second Determination Processing (Processing by Second Determination Program 90b)

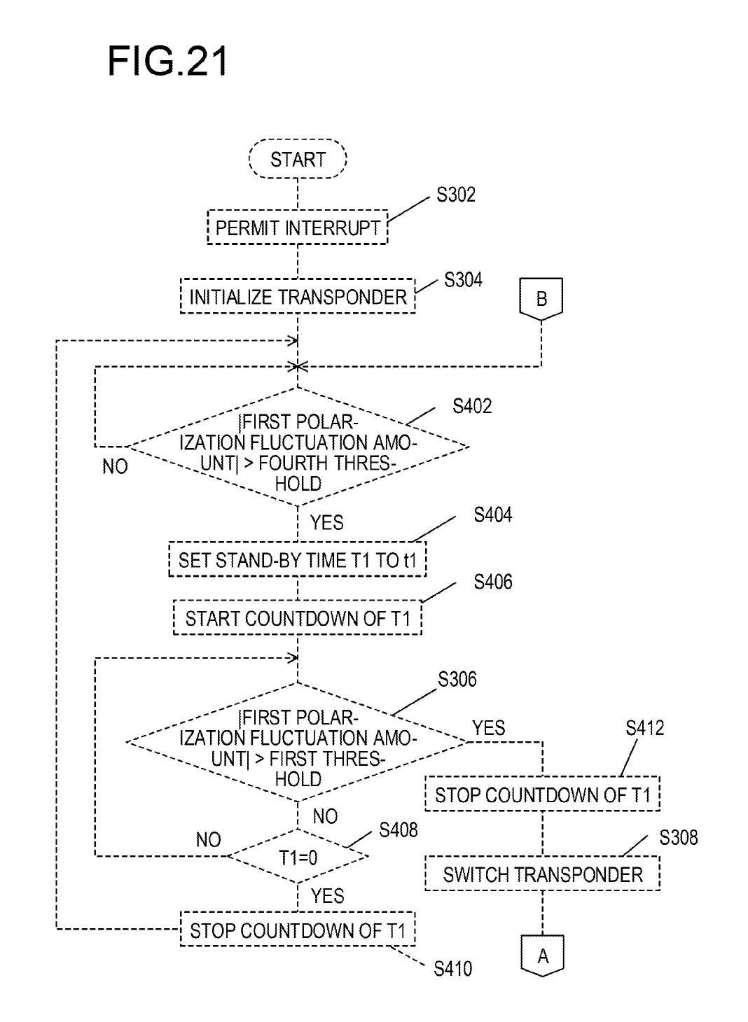

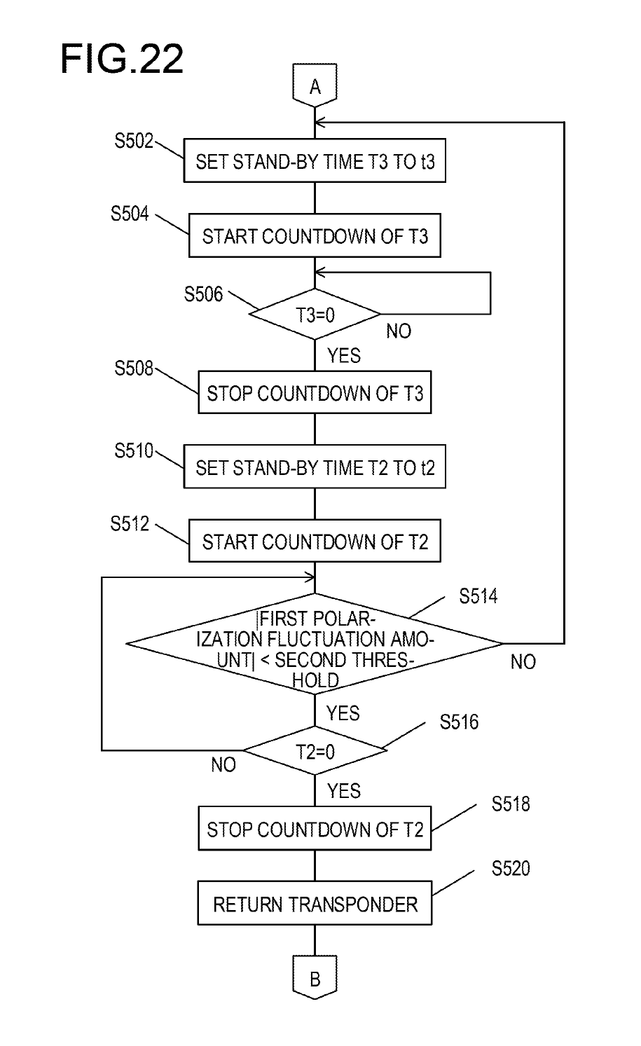

FIGS. 21 and 22 illustrate an example of the flowchart of the second determination program 90b. Among the operations illustrated in FIGS. 21 and 22, the operations marked by the dashed lines are the operations included in the modification (see FIG. 19) of the first embodiment.

[Operations S302 to S308 and S402 to S412]

The second CPU 56b first executes operations S302 to S308 and S402 to S412. After operation S308, the second CPU 56b proceeds to operation S502. Operations S402 to S412 may be omitted (see FIG. 18).

Operations S302 to S308 and S402 to S412 are the operations described in the first embodiment.

[Operation S502]

After the operation S308, the second CPU 56b sets a standby-time T3 of the timer to t3 (e.g., 1 to 30 minutes).

[Operation S504]

After operation S502, the second CPU 56b starts the countdown of the timer.

[Operation S506]

After operation S504, the second CPU 56b determines whether the stand-by time T3 is 0. When it is determined that the stand-by time T3 is not 0, the second CPU 56b executes operation S506 again. When it is determined that the stand-by time T3 is 0, the second CPU 56b proceeds to operation S508.

[Operation S508]

The second CPU 56b stops the countdown of the stand-by time T3.

[Operation S510]

After operation S508, the second CPU 56b sets a standby-time T2 of the timer to t2 (e.g., 1 to 15 minutes).

[Operation S512]

After operation S510, the second CPU 56b starts the countdown of the stand-by time T2.

[Operation S514]

After operation S512, the second CPU 56b determines whether the absolute value of the latest first polarization fluctuation amount 46a recorded in the first history table 96a is smaller than the second threshold (e.g., 1 to 20 krad/sec) recorded in the threshold table 108. The second threshold may be a value smaller than the first threshold and the fourth threshold. The determination in operation S514 is performed based on the detection date and time of the first polarization fluctuation amount 46a recorded in the first history table 96a.

When the absolute value of the latest first polarization fluctuation amount 46a is equal to or larger than the second threshold, the second CPU 56b returns to operation S502. When the absolute value of the latest first polarization fluctuation amount 46a is less than the second threshold, the second CPU 56b proceeds to operation S516.

[Operation S516]

The second CPU 56b determines whether the stand-by time T2 is 0. When it is determined that the stand-by time T2 is not 0, the second CPU 56b returns to operation S514. When it is determined that the stand-by time T2 is 0, the second CPU 56b proceeds to operation S518.

[Operation S518]

The second CPU 56b stops the countdown of the stand-by time T2.

[Operation S520]

After operation S518, the second CPU 56b returns the transponder for outputting the transmission information 42 from the second transponder 24b to the first transponder 24a.

Specifically, for example, the second CPU 56b transmits the second command 48b to the first transponder 24a, and concurrently, transmits the first command 48a to the second transponder 24b. The second command 48b is a command for starting the output of the transmission information 42. The first command 48a is a command for prohibiting the output of the transmission information 42.

[Operation S402]

After operation S520, the second CPU 56b returns to operation S402.

As described above, after the second CPU 56b switches the transponder, the second CPU 56b returns the transponder when the absolute value of the first polarization fluctuation amount 46a continues to be below the second threshold for a predetermined time t2 (operations S510 to S518). As described above, when it is considered that the risk of the transmission error due to the lightning is lowered because the first polarization fluctuation amount 46a is kept small for the predetermined time t2, the return (operation S520) of the transponder is executed.

The second CPU 56b starts to determine whether or not to return the transponder (operations S510 to S518) after a predetermined time t3 elapses from the switching (operation S308) of the transponder (operations S502 to S508). Therefore, the return of the transponder which is rough and ready is suppressed.

The second determination program 90b is executed by the determination unit 32 (see FIG. 7). In other words, the second determination program 90b is executed by the reception unit 20 including the determination unit 32.

### (4) Operational Example

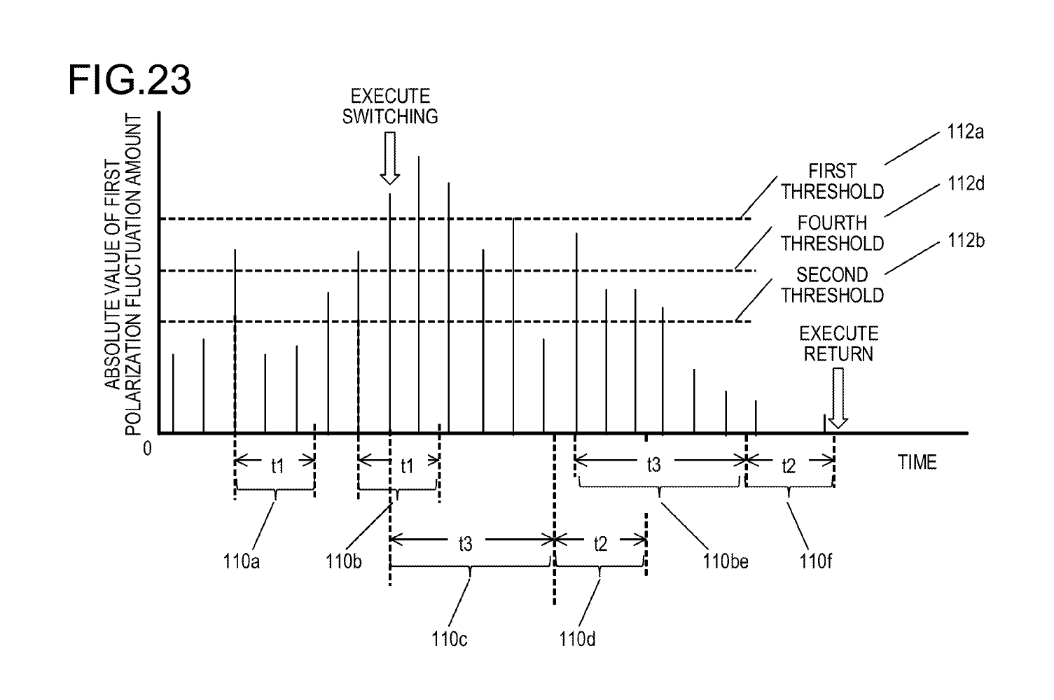

FIG. 23 is a diagram illustrating an example of an operation of an optical transmission device according to the second embodiment. A horizontal axis represents time. A vertical axis represents the absolute value of the first polarization fluctuation amount 46a detected by the detection unit 22. The horizontal axis and the vertical axis are linear axes.

When the second CPU 56b detects the first polarization fluctuation amount 46a of which absolute value exceeds the fourth threshold 112d, a first period 110a starts (see operations S402 to S406 in FIG. 21). The first period 110a lasts for a maximum of t1 hour. The second CPU 56b monitors whether the absolute value of the first polarization fluctuation amount 46a exceeds the first threshold 112a during the first period 110a (see operations S306, and S408 to S412). By the first period 110a, the switching of the transponder due to the temporary cause other than the lightning is suppressed.

In the example illustrated in FIG. 23, the first polarization fluctuation amount 46a whose absolute value exceeds the first threshold 112a within the first period 110a is not detected. Accordingly, the switching of the transponder (see operation S308) is not executed.

In the example illustrated in FIG. 23, after the first period 110a, the first polarization fluctuation amount 46a whose absolute value exceeds the fourth threshold 112d is detected again, and the second period 110b starts (see operations S402 to S406).

In the example illustrated in FIG. 23, the first polarization fluctuation amount 46a whose absolute value exceeds the first threshold 112a is detected in the middle of the second period 110b. As a result, the transponder that outputs the transmission information 42 is switched from the first transponder 24a to the second transponder 24b (see operation S308).

When the transponder is switched, a third period 110c starts (see operations S502 to S508 in FIG. 22). The third period 110c is continued for the t3 time. By the third period 110c, the return of the transponder which is rough and ready is suppressed.

When the third period 110c is terminated, a fourth period 110d starts (see operations S510 to S518). The fourth period 110d is continued for a maximum of t2 time.

When the second CPU 56b monitors whether the absolute value of the first polarization fluctuation amount 46a continues to be below the second threshold 112b during the fourth period 110d (operations S514 to S516). In the example illustrated in FIG. 23, the first polarization fluctuation amount 46a whose absolute value is equal to or larger than the second threshold 112b is detected in the middle of the fourth period 110d. Therefore, the transponder is not returned.

In the example illustrated in FIG. 23, the first polarization fluctuation amount 46a whose absolute value exceeds the fourth threshold 112d is detected in the middle of the fourth period 110d. As a result, a fifth period 110e starts (see operations S502 to S508). The fifth period 110e is continued for the t3 time.

When the fifth period 110e is terminated, a sixth period 110f starts (see operations S510 to S518). When the second CPU 56b monitors again whether the absolute value of the first polarization fluctuation amount 46a continues to be below the second threshold 112b during the sixth period 110f (operations S514 to S516).

In the example illustrated in FIG. 23, the absolute value of the first polarization fluctuation amount 46a continues to be below the second threshold 112b during a sixth period 110f. As a result, the transponder that outputs the transmission information 42 is returned from the second transponder 24b to the first transponder 24a (see operation S520). Since it is confirmed in the sixth period 110f that the risk of the transmission error due to the lightning decreases, the transponder is returned.

### (5) Modification

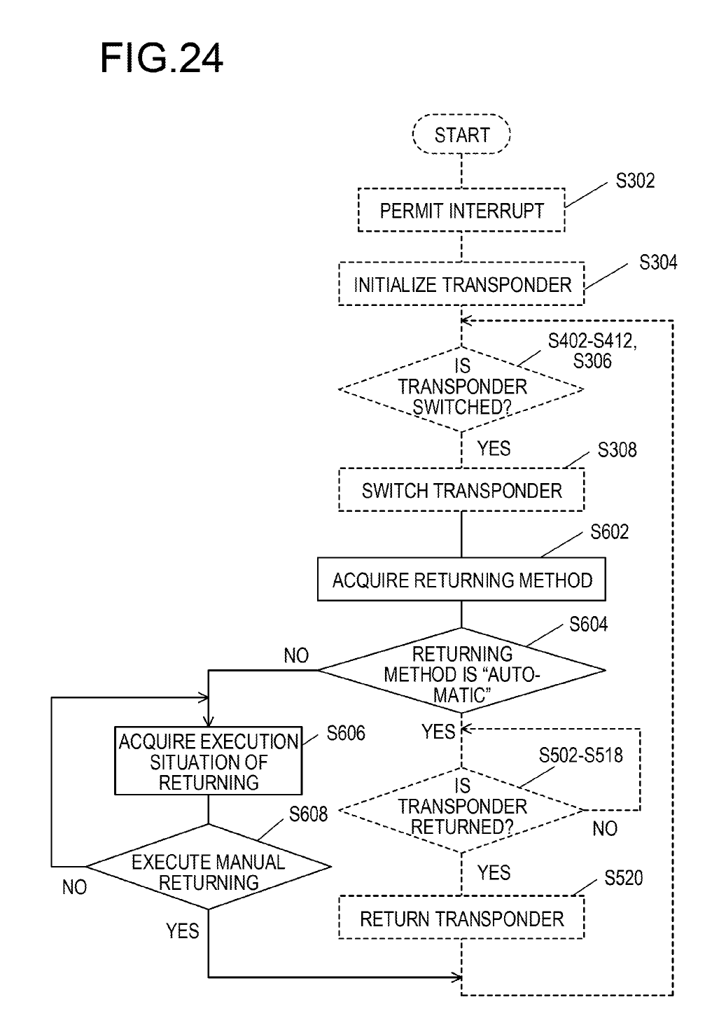

FIG. 24 illustrates a modification of the second determination program 90b according to the second embodiment.

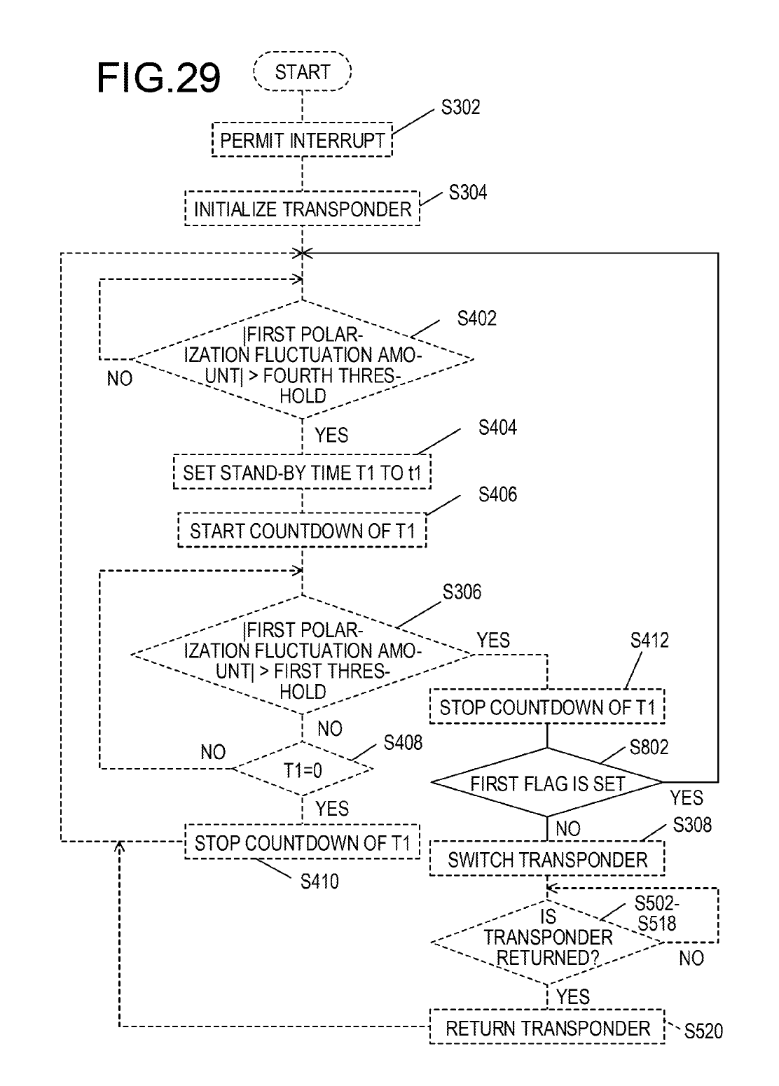

Among the operations illustrated in FIG. 24, the operations marked by the dashed lines are the operations included in the flowchart of FIGS. 21 and 22. Operations S402 to S412 and S306 among the operations included in FIGS. 21 and 22 are integrated into one operation. Similarly, the operations S502 to S518 are integrated into one operation (the same applies to, for example, FIG. 29 as well).

[Operations S302 to S308 and S402 to S412]

The second CPU 56b first executes operations S302 to S308 and S402 to S412.

[Operation S602]

After operation S308, the second CPU 56b requests an operator to select a method for returning the transponder by using, for example, a display device (not illustrated). The second CPU 56b also acquires a “returning method of the transponder” which the operator selects by using an input device (not illustrated). For example, the operator selects “automatic” when hastening to return the transponder and selects “manual” when not hastening to return the transponder.

Operation S602 may be executed before operation S308 of switching the transponder. For example, operation S602 may be executed before operation S402.

[Operation S604]

The second CPU 56b determines whether the acquired returning method is “automatic.” When it is determined that the acquired returning method is “automatic,” the second CPU 56b proceeds to operation S502. When it is determined that the acquired returning method is not “automatic,” the second CPU 56b proceeds to operation S606.

[Operation S606]

The second CPU 56b inquires the operator about an execution situation of the manual returning of the transponder by using, for example, the display device (not illustrated). The second CPU 56b also acquires the “execution situation of the manual returning” which the operator replies by using the input device (not illustrated).

[Operation S608]

The second CPU 56b determines whether the acquired “execution situation of the manual returning” indicates the completion of the manual returning. When it is determined that the acquired “execution situation of the manual returning” does not indicate the completion of the manual returning, the second CPU 56b returns to operation S606.

When it is determined that the acquired “execution situation of the manual returning” indicates the completion of the manual returning, the second CPU 56b returns to operation S402.

According to the modification, the operator may select the method for returning the transponder.

As described above, according to the second embodiment, when the absolute value of the first polarization fluctuation amount 46a continues to be below the second threshold 112b which is smaller than the first threshold 112a for the predetermined time t2, the transponder is returned. Therefore, according to the second embodiment, it is possible to return the transponder when the lightning is sufficiently far away and the risk of the transmission error decreases.

### Third Embodiment

The optical transmission device according to the third embodiment is an optical transmission device that suppresses the transmission error due to the lightning in the vicinity of the second route 10b by detecting the second polarization fluctuation amount of the light from the second route 10b. The optical transmission device according to the third embodiment is similar to the optical transmission device according to the first or second embodiment. Therefore, for example, the description of the same parts as those in the first or second embodiment will be omitted or simplified.

### (1) Configuration and Operation

The optical transmission device according to the third embodiment has substantially the same structure as that of the optical transmission devices 2 and 102 according to the first and second embodiments described with reference to FIGS. 1 and 6. That is, the optical transmission device of the third embodiment includes the reception unit 20 and the detection unit 22.

The detection unit 22 of the third embodiment performs substantially the same operation as the detection unit 22 of the second embodiment. The detection unit 22 of the third embodiment also detects the second polarization fluctuation amount 46b (see FIG. 7) of the light from the second route 10b. The second polarization fluctuation amount 46b is a polarization fluctuation amount of the light (e.g., the second signal light 6b) from the second route 10b. The polarization fluctuation amount is the change amount (e.g., the rotation speed of the polarization plane of the interference light between the signal light and the local oscillation light) of the parameter indicating the polarization state of the light described in the first embodiment within a predetermined time. The second polarization fluctuation amount 46b is detected by the second detection unit 30b (e.g., the polarization detection unit 88 of the DSP chip 50) of the second transponder 24b.

The second detection unit 30b derives the second polarization fluctuation amount 46b based on the data 144 generated in the process of reproducing the transmission information 42 from the second signal light 6b by the second reception unit 26b (see FIG. 7).

The reception unit 20 of the third embodiment performs substantially the same operation as the reception unit 20 of the second embodiment. However, when the absolute value of the detected second polarization fluctuation amount 46b exceeds the third threshold 112c before the absolute value of the first polarization fluctuation amount 46a exceeds the first threshold 112a, the reception unit 20 of the third embodiment suspends the switching of the transponder. The third threshold 112c is, for example, the first threshold 112a.

Therefore, while the lightning occurs in the vicinity of the second route 10b, the switching of the transponder is suppressed. Therefore, according to the optical transmission device of the third embodiment, the transmission error due to the lightning in the vicinity of the second route 10b is suppressed.

### (2) Hardware

The hardware configuration of the optical transmission device according to the third embodiment is substantially the same as the hardware configurations (see, e.g., FIG. 8) of the optical transmission devices 2 and 102 according to the first embodiment.

### (3) Software

### (3-1) Program

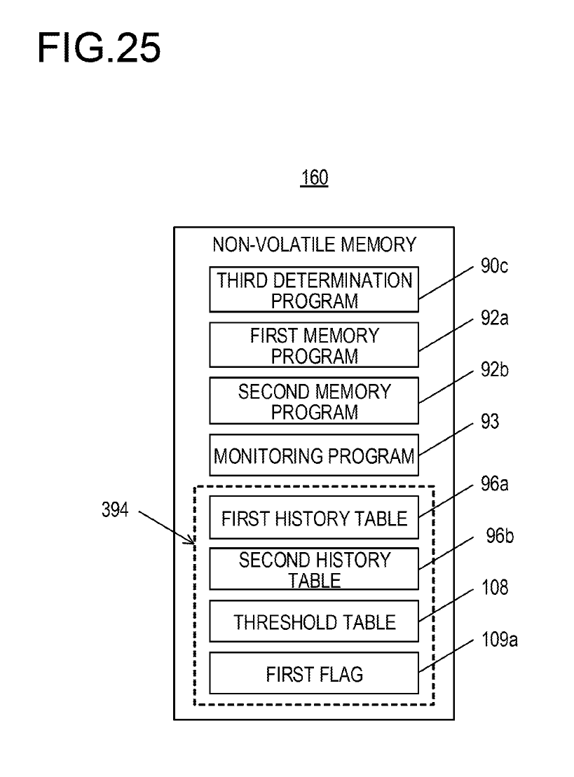

FIG. 25 is a diagram illustrating a program and a data file 394 recorded in the non-volatile memory 160 of the judgment unit 32 (see FIG. 8).

As illustrated in FIG. 25, the third determination program 90c, the first recording program 92a, the second recording program 92b, and the monitoring program 93 are recorded in the non-volatile memory 160 of the optical transmission device of the third embodiment.

### (3-2) Data

As illustrated in FIG. 25, the first history table 96a, the second history table 96b, the threshold table 108, and the first flag 109a are recorded in the non-volatile memory 160.

(3-2-1) First History Table

For example, the first history table 96a of the third embodiment has the same structure as the first history table 96a described with reference to FIG. 13.

(3-2-2) Second History Table

For example, the second history table 96b has the same structure as the first history table 96a described with reference to FIG. 13.

(3-2-3) Threshold Table

The threshold table 108 of the third embodiment has the same structure as the threshold table 108 of the first embodiment described with reference to FIG. 14. In the threshold table 108 of the third embodiment, for example, the first to fourth thresholds described in the first embodiment are recorded.

(3-2-4) First Flag

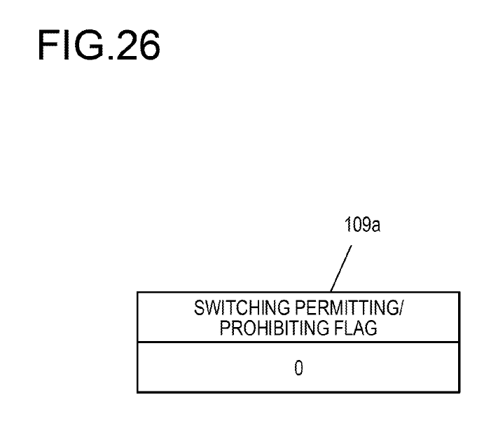

FIG. 26 is a diagram illustrating an example of a first flag 109a. The first flag 109a is, for example, a table having two rows and one column. The data of the first row of the first flag 109a indicates the contents of the data recorded in the second row. The first row may be omitted. For example, the numeral “0” or “1” is recorded in the second row of the first flag 109a.

### (3-3) Processing

The second CPU 56b reads and concurrently executes the third determination program 90c, the first recording program 92a, the second recording program 92b, and the monitoring program 93 from the non-volatile memory 160. The first recording program 92a is described in the first embodiment.

(3-3-1) Second Recording Processing (Processing by Second Recording Program 92b)

The second recording program 92b is similar to the first recording program 92a (see FIG. 17) for recording the first polarization fluctuation amount 46a of the first signal light 6a. The second recording program 92b is a program for recording the second polarization fluctuation amount 46b of the second signal light 6b.

The second recording program 92b is executed by the determination unit 32. In other words, the second recording program 92b is executed by the reception unit 20 including the determination unit 32.

The second CPU 56b executes the same or similar operations as the operations S202 to S206 of the first recording program 92a. The second CPU 56b first executes operation S202 of the first recording program 92a. The second CPU 56b also determines whether the second polarization fluctuation amount 46b (see FIG. 7) of the second signal light 6b has been received from the second detection section 30b, instead of operation S204 of the first recording program 92a.

Next, instead of operation S206 of the first recording program 92a, the second CPU 56b records the second polarization fluctuation amount 46b and the detection date and time thereof in the second history table 96b.

According to the second recording program 92b, the second polarization fluctuation amount 46b of the second signal light 6b and the detection date and time thereof are recorded in the second history table 96b.

(3-3-2) Monitoring Processing (Processing by Monitoring Program 93)

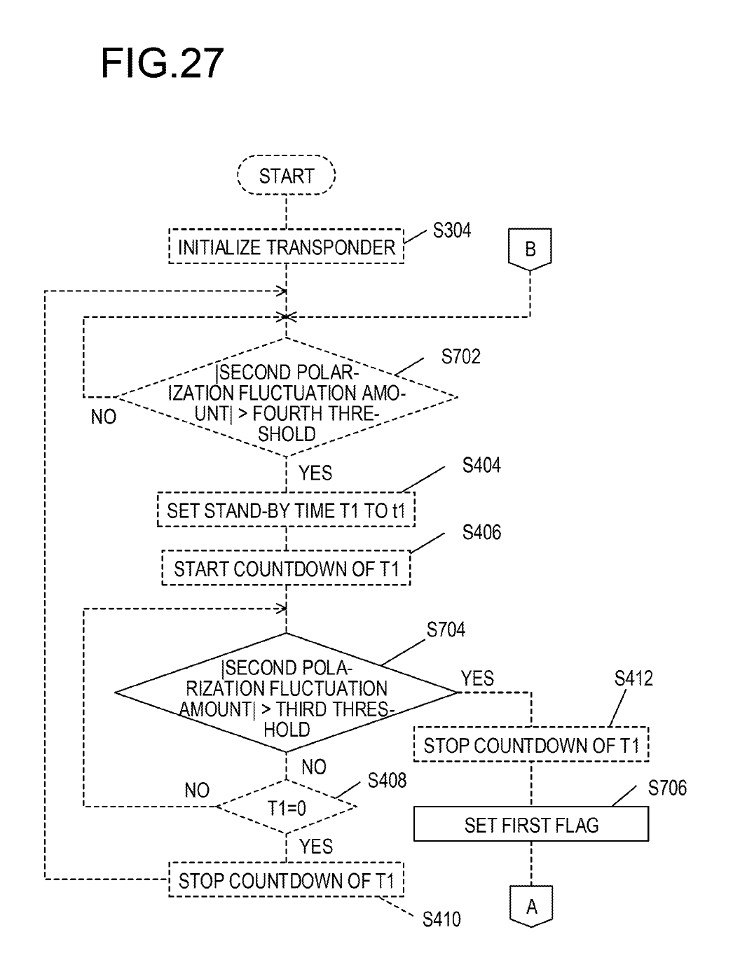

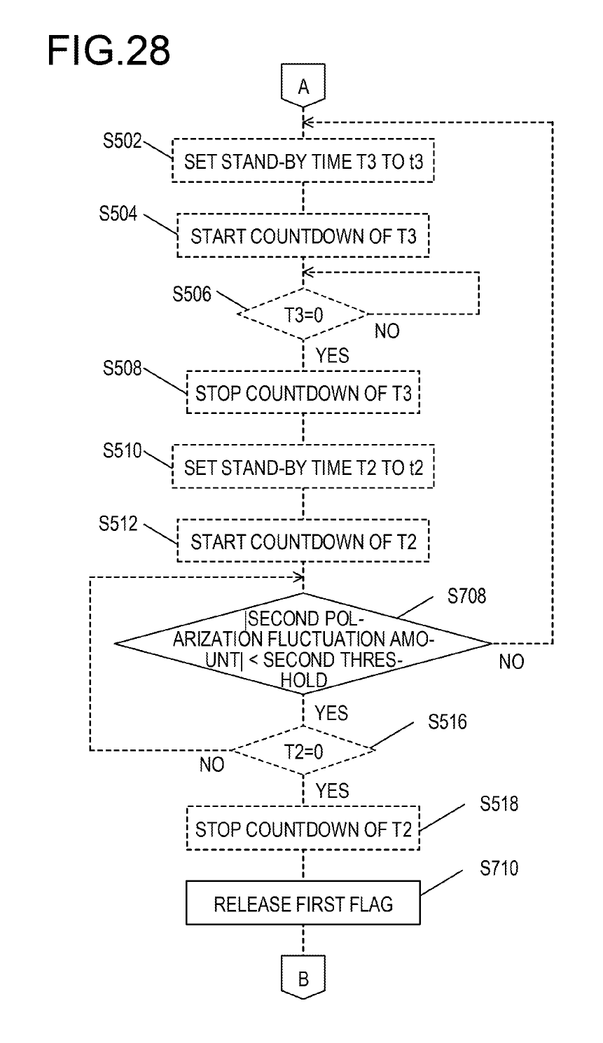

FIGS. 27 and 28 illustrate an example of the flowchart of the monitoring program 93. The monitoring program 93 is a program for monitoring whether the absolute value of the second polarization fluctuation amount 46b of the second signal light 6b from the second route 10b exceeds the third threshold 112c. The monitoring program 93 is executed by the second CPU 56b (see FIG. 8).

The monitoring program 93 is executed by the determination unit 32 (see FIG. 6). In other words, the monitoring program 93 is executed by the reception unit 20 (see FIG. 1) including the determination unit 32.

The monitoring program 93 is similar to the second judgment program 90b (see FIGS. 21 and 22) of the second embodiment. The operations marked by the dashed line in FIGS. 27 and 28 are the operations described in the second embodiment.

The monitoring program 93 does not have operation S302 of the second determination program 90b.

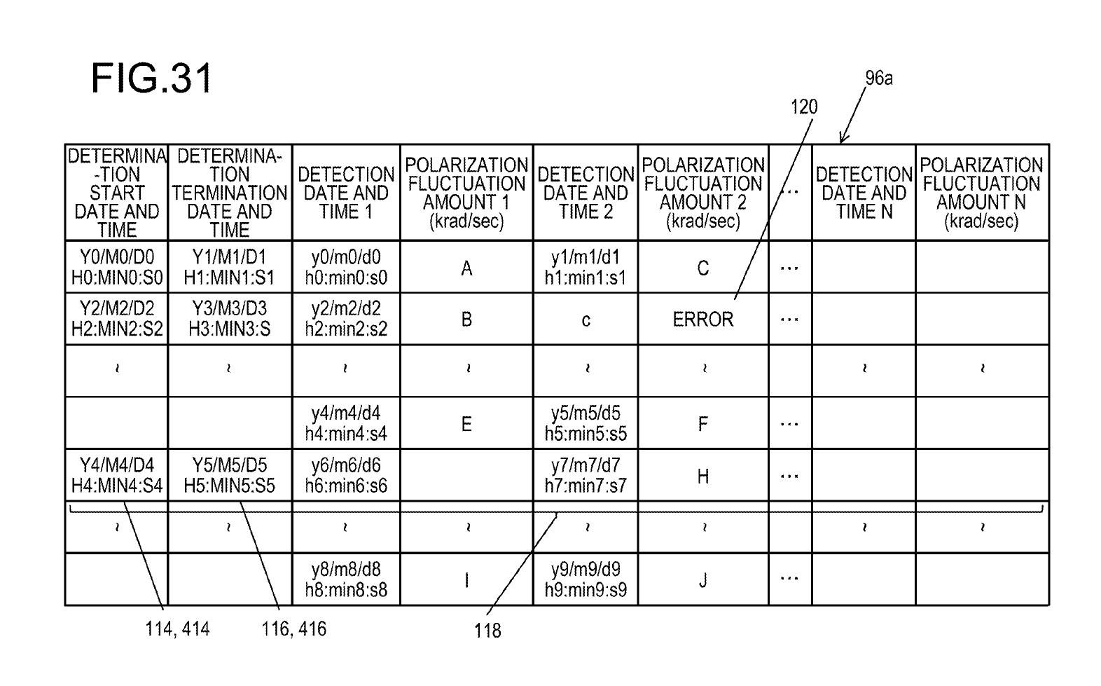

The monitoring program 93 includes operation S702 (see FIG. 27), instead of operation S402 (see FIG. 21) of the second determination program 90b. The monitoring program 93 also includes operation S704, instead of operation S306 (see FIG. 31) of the second determination program 90b. The monitoring program 93 also includes operation S706, instead of operation S308 (see FIG. 21) of the second determination program 90b.

The monitoring program 93 also includes operation S708, instead of operation S514 (see FIG. 22) of the determination program. The monitoring program 93 also includes operation S710, instead of operation S520 (see FIG. 22) of the second determination program 90b.

[Operation S702]

The second CPU 56b compares the absolute value of the second polarization fluctuation amount 46b of the second signal light 6b with the fourth threshold. Operation S702 is executed based on the second history table 96b and the threshold table 108 (the same applies to S704 and S708 as well).

[Operation S704]

The second CPU 56b compares the absolute value of the second polarization fluctuation amount 46b of the second signal light 6b with the third threshold.

[Operation S706]

The second CPU 56b sets the first flag. Specifically, the second CPU 56b records the numeral “1” in the second row of the first flag 109a (see FIG. 26).

[Operation S708]

The second CPU 56b compares the absolute value of the second polarization fluctuation amount 46b of the second signal light 6b with the second threshold.

[Operation S710]

The second CPU 56b releases the first flag. Specifically, the second CPU 56b records the numeral “0” in, for example, the second row of the first flag 109a.

When the absolute value of the second polarization fluctuation amount 46b of the second signal light 6b exceeds the third threshold 112c, the first flag 109a is set by executing the monitoring program 93. Further, when the absolute value of the second polarization fluctuation amount 46b of the second signal light 6b continues to be below the second threshold 112b for the predetermined time t2, the first flag 109a is released by executing the monitoring program 93.

Operations S404 to S412 may be omitted.

(3-3-3) Third Determination Processing (Processing by Third Determination Program 90c)

FIG. 29 illustrates an example of the flowchart of the third determination program 90c. The third determination program 90c is a program for suspending the output of the transmission information 42 transmitted by the second signal light 6b when the absolute value of the second polarization fluctuation amount 46b exceeds the third threshold 112c. The third determination program 90c is executed by the determination unit 32. In other words, the third determination program 90c is executed by the reception unit 20 (see FIG. 1) including the determination unit 32.

The third determination program 90c is similar to the second determination program 90b (see FIGS. 21 and 22) of the second embodiment. The operations marked by the dashed lines in FIG. 29 are the operations described in the second embodiment. In FIG. 29, operations S502 to S518 among the operations included in FIGS. 21 and 22 are integrated into one operation.

The third determination program 90c includes operation S802 between operations S412 and S308. The second CPU 56b executes each operation of the third determination program 90c.

[Operation S802]

When the second CPU 56b determines whether the absolute value of the first polarization fluctuation amount 46a of the first signal light 6a exceeds the first threshold 112a in operations S402 to S412 and S306, the second CPU 56b determines whether the first flag 109a is set up. When it is determined that the first flag 109a is set up, the second CPU 56b returns to operation S402.

When the first flag 109a is not set up, the second CPU 56b proceeds to operation S308 of switching the transponder for outputting transmission information from the first transponder 24a to the second transponder 24b.

Specifically, the second CPU 56b determines whether the second row of the first flag 109a is the numeral “1.” When it is determined that the numeral in the second row of the first flag 109a is “1,” the second CPU 56b returns to operation S402. When it is determined that the second row of the first flag 109a is not “1,” the second CPU 56b proceeds to operation S308.

That is, when it is determined that the absolute value of the second polarization fluctuation amount 46b exceeds the third threshold 112c before the absolute value of the first polarization fluctuation amount 46a exceeds the first threshold 112a, the switching of the transponder is suspended.

According to the third embodiment, when large lightning occurs in the vicinity of the second route 10b, the output of the transmission information 42 from the second route 10b is suspended, so that the transmission error due to the lightning hardly occurs in the vicinity of the second route 10b.

In the above example, the third threshold 112c has the same value as the first threshold 112a. However, the third threshold 112c may have a different value from the first threshold 112a. For example, the third threshold 112c may be a value larger than the fourth threshold 112d and smaller than the first threshold 112a.

The reception unit 20 of the third embodiment is configured to execute each operation of the second determination processing of the second embodiment and operation S802. However, the optical transmission device of the third embodiment may be configured to execute each operation of the first determination processing (or modified example) of the first embodiment and operation S802.

### Fourth Embodiment

The optical transmission device according to the fourth embodiment is an optical transmission device that suppresses the occurrence of the transmission error by decreasing an excessively set first threshold. The optical transmission device of the fourth embodiment is similar to the optical transmission devices of the first to third embodiments. Therefore, for example, the description of the same parts as those in the first to third embodiments will be omitted or simplified.

### (1) Configuration and Operation

The optical transmission device of the fourth embodiment has substantially the same structure (see FIGS. 1 and 6) as the optical transmission devices 2 and 102 of the second embodiment. That is, the optical transmission device of the fourth embodiment includes the reception unit 20 and the detection unit 22.

The detection unit 22 of the fourth embodiment performs substantially the same operation as the detection unit 22 of the second embodiment.

Similarly, the reception unit 20 of the fourth embodiment performs substantially the same operation as the reception unit 20 of the second embodiment. When the output of the transmission information 42 transmitted by the first signal light 6a stops before the output of the transmission information 42 transmitted by the second signal light 6b starts, the reception unit 20 of the fourth embodiment also decreases the first threshold 112a (see FIG. 23). The stop of the output of the transmission information 42 means the occurrence of the transmission error.

When the first threshold 112a decreases, a timing at which the reception unit 20 starts outputting the transmission information 42 by the second signal light 6b becomes earlier. As a result, the transmission error hardly occurs.

### (2) Hardware

The optical transmission device of the fourth embodiment has substantially the same hardware configuration (see, e.g., FIG. 8) as that of the optical transmission device of the second embodiment.

### (3) Software

### (3-1) Program

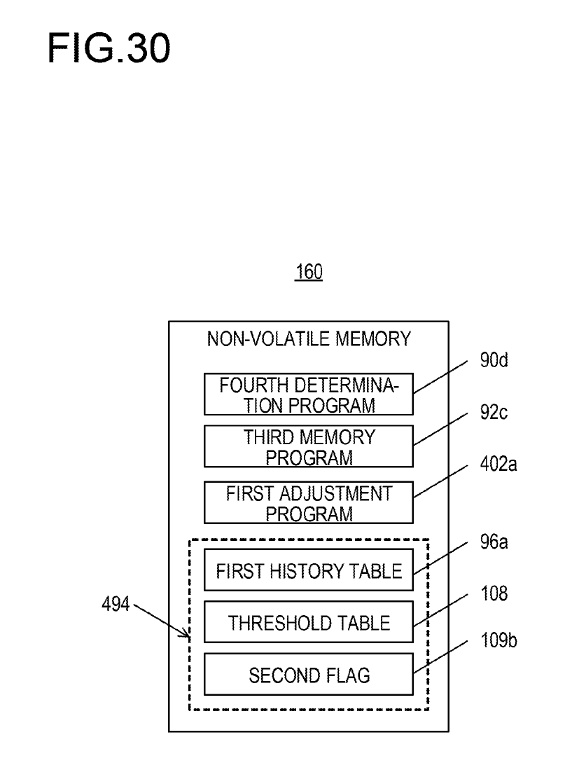

FIG. 30 is a diagram illustrating a program and a data file 494 recorded in the non-volatile memory 160 (see FIG. 8) of the determination unit 32 (see FIG. 8).

As illustrated in FIG. 30, a fourth determination program 90d, a third recording program 92c, and a first adjustment program 402a are recorded in the non-volatile memory 160 of the optical transmission device of the fourth embodiment.

### (3-2) Data

As illustrated in FIG. 30, the first history table 96a, the threshold table 108, and the second flag 109b are recorded in the non-volatile memory 160 of the determination unit 32.

(3-2-1) First History Table

For example, the first history table 96a of the fourth embodiment has the same structure as the first history table 96a described with reference to FIG. 13.

FIG. 31 is a diagram illustrating an example of the first history table 96a in which data is recorded according to the fourth embodiment. In FIG. 31, for example, the symbols “Y0/M0/D0H0:MIN0:S0” are described instead of the actual date and time for the convenience of the description. The symbols “A” and “B” to “J” are described instead of an actual polarization fluctuation amount for the convenience of the description.

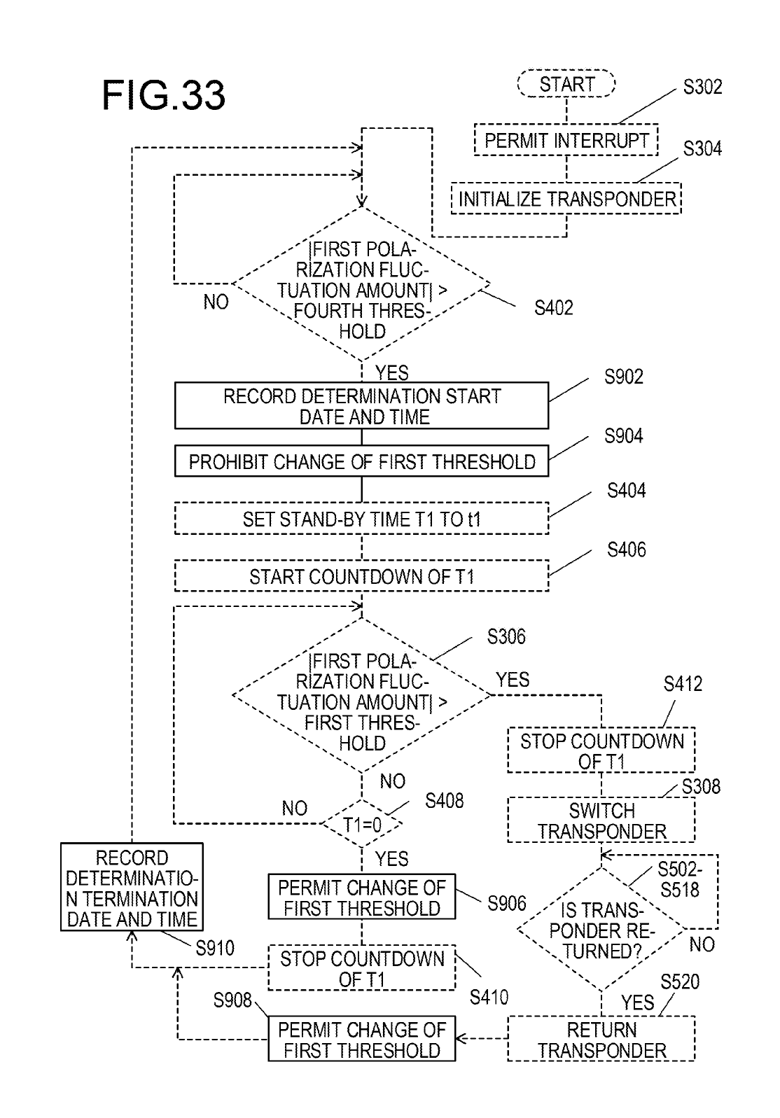

In a cell 114 (cell other than the first row) of the first column in FIG. 31, a date and time when the second CPU 56b starts to determine whether the first polarization fluctuation amount 46a exceeds the first threshold 112a (e.g., operations S404 to S412 and S306 in FIG. 33 to be described later) is recorded.

When the determination is terminated while the first polarization fluctuation amount 46a does not exceed the first threshold 112a, a date and time when the determination is terminated (hereinafter, referred to as a determination termination date and time) is recorded in a cell 116 on a right side of the cell 114 in which the start date and time of the determination (hereinafter, referred to as a determination start date and time) are described.

When the first polarization fluctuation amount 46a exceeds the first threshold 112a, a date and time when the return of the transponder (operation S520) is performed are recorded in the cell 116 on the right side of the cell 114 in which the start date and time of the determination (hereinafter, referred to as the determination start date and time) are described.

The first polarization fluctuation amount 46a detected by the first detection unit 30a is recorded in a row 118 where a determination start date and time 414 and a determination termination date and time 416 are recorded from the determination start date and time 414 to the determination termination date and time 416. Each row of the first history table 96a includes sufficiently more cells than the sum of the first polarization fluctuation amount 46a and the detection date and time (that is, twice the detection date and time) recorded from the start of the lightning to the termination of the lightning.

In a row on which the determination start date and time 414 and the determination termination date and time 416 are not recorded, the first polarization fluctuation amount 46a detected during a period until the first determination starts and a period until a next determination starts after the first determination is terminated (e.g., a period in which S402 is repeated) is recorded.

When there is the large lightning in the vicinity of the first route 10a before switching the transponder, an error in which the first transponder 24a may not convert the first signal light 6a into the transmission information (hereinafter, referred to as a conversation error) may occur. Then, the output of the transmission information 42 transmitted by the first signal light 6a stops. In this case, the DSP chip 50 transmits data indicating the occurrence of the conversion error (hereinafter, referred to as an error data) to the determination unit 32 instead of the first polarization fluctuation amount 46a.

Upon receiving the error data, the determination unit 32 records the error data 120 in the first history table 96a, instead of the first polarization fluctuation amount 46a. The error data 120 is, for example, character data “ERROR.”

Instead of the detection date and time of the first polarization fluctuation amount 46a, a reception date and time of the error data are also recorded in the first history table 96a.

(3-2-2) Threshold Table

The threshold table 108 of the fourth embodiment is substantially the same as the threshold table 108 of the first embodiment described with reference to FIG. 14.

(3-2-3) Second Flag

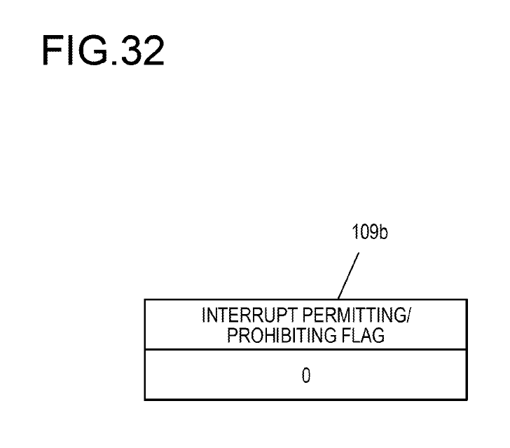

FIG. 32 is a diagram illustrating an example of the second flag 109b used for executing the first adjustment program 402a. The second flag 109b is, for example, a table having two rows and one column. The first row of the second flag 109b indicates the contents of the data recorded in the second row of the second flag 109b. The cell of the second row of the second flag 109b is, for example, the numeral “0” or “1.”

For example, “0” is recorded in the second row of the second flag 109b when an interrupt to the fourth judgment processing (processing by the fourth determination program 90d) is permitted. Meanwhile, when the interrupt to the fourth determination processing is prohibited, for example, “1” is recorded in the second row of the second flag 109b.

### (3-3) Processing

The second CPU 56b reads and concurrently executes the fourth determination program 90d, the third recording program 92c, and the first adjustment program 402a from the non-volatile memory 160.

(3-3-1) Fourth Determination Processing (Processing by Fourth Determination Program 90d)

FIG. 33 illustrates an example of the flowchart of the fourth determination program 90d. The fourth determination program 90d is executed by the determination unit 32 (see FIG. 6). In other words, the fourth determination program 90d is executed by the reception unit 20 (see FIG. 1) including the determination unit 32.

The fourth determination program 90d is similar to the second determination program 90b (see FIGS. 21 and 22) of the second embodiment. The operations marked by the dashed lines in FIG. 33 are the operations described in the second embodiment.

The fourth determination program 90d is executed by the second CPU 56b.

[Operation S902]

After operation S402 (that is, after the first polarization fluctuation amount 46a exceeds the fourth threshold 112d in FIG. 23), the second CPU 56b aligns the first history table 96a (see FIG. 31) and records a date and time when the first polarization fluctuation amount 46a is last received at a head of the next row. Operation S902 is a process for a third recording processing to be described later.

Operation S902 may be executed at any timing between operations S402 to S406 (the same applies to operation S904 as well).

[Operation S904]

The second CPU 56b prohibits the change of the first threshold 112a by first adjustment processing to be described later. Specifically, the second CPU 56b records the numeral “1” in, for example, the cell of the second row of the second flag 109b.

[Operation S906]

When the second CPU 56b determines that the stand-by time T1 becomes 0 in operation S408, the second CPU 56b permits the change of the first threshold 112a (i.e., the change of the first threshold 112a).

For example, the second CPU 56b records the numeral “0” in the cell of the second row of the second flag 109b.

[Operation S908]

After operation S520, the second CPU 56b permits the change of the first threshold 112a by the first adjustment processing. Specifically, the second CPU 56b records the numeral “0” in, for example, the cell of the second row of the second flag 109b.

[Operation S910]

After operation S410 and operation S908 (or operation S520), the second CPU 56b records the date and time when the first polarization fluctuation amount 46a is last received in the cell of the second column of the row being recorded in the first history table 96a. Thereafter, the second CPU 56b aligns the first history table 96a. Operation S902 is a process for a third recording processing to be described later.

Operation S306 is a processing based on the first threshold 112a. Therefore, it is not preferable that the first threshold 112a is changed while operation S306 is being repeated. In the fourth determination processing, before the repetition of operation S306 starts, the change of the first threshold 112a is prohibited by operation S902. Therefore, according to the fourth determination processing, the first threshold 112a is not changed while operation S306 is being repeated.

However, when the conversion error occurs, the DSP chip 50 outputs the error data 120, instead of the first polarization fluctuation amount 46a. Therefore, in the first history table 96a, the first polarization fluctuation amount 46a at the time when the conversion error occurs is not recorded. In operation S402, the second CPU 56b acquires the latest data among the first polarization fluctuation amount 46a recorded in the first history table 96a and the error data recorded in the first history table 96a.

When the acquired data is the first polarization fluctuation amount 46a, the second CPU 56b compares the acquired first polarization fluctuation amount 46a with the fourth threshold 112d. Meanwhile, when the acquired data is the error data, the second CPU 56b proceeds to operation S902.

The fourth threshold 112d is smaller than the first polarization fluctuation amount 46a when the error data is generated. Accordingly, when the error data is acquired, the second CPU 56b proceeds to operation S902. The same also applies to the determination in operation S306 and operations S502 to 518.

(3-3-2) Third Recording Processing (Processing by Third Recording Program 92c)

The flowchart of the third recording program 92c is substantially the same as the flowchart (see FIG. 17) of the first recording program 92a of the first embodiment. The third recording program 92c is executed by the second CPU 56b (see FIG. 8).

The third recording program 92c is executed by the determination unit 32 (see FIG. 6). In other words, the third recording program 92c is executed by the reception unit 20 (see FIG. 1) including the determination unit 32.

The processing by the third recording program 92c (hereinafter, referred to as third recording processing) is substantially the same as the first recording processing of the first embodiment, except for the recording method of the data (detection date and time and first polarization fluctuation amount 46a) in operation S206. In the first recording processing, the data is sequentially recorded from the left to the right in the cells of each row of the first history table 96a, and after the data is recorded in the last cell, the first history table 96a is aligned.

Meanwhile, in the third recording processing of the fourth embodiment, for example, when the first history table 96a (see FIG. 31) is aligned by operation S902 of the fourth determination processing, new data is sequentially recorded in a new aligned row. In the third recording processing, when the first history table 96a is also aligned in operation S910 of the fourth judgment processing, new data is sequentially recorded in the aligned row.

The second CPU 56b may receive the error data instead of the first polarization fluctuation amount 46a. In this case, the second CPU 56b records the received error data and the reception date and time of the received error data in the first history table 96a.

(3-3-3) First Adjustment Processing (Processing by First Adjustment Program 402a)

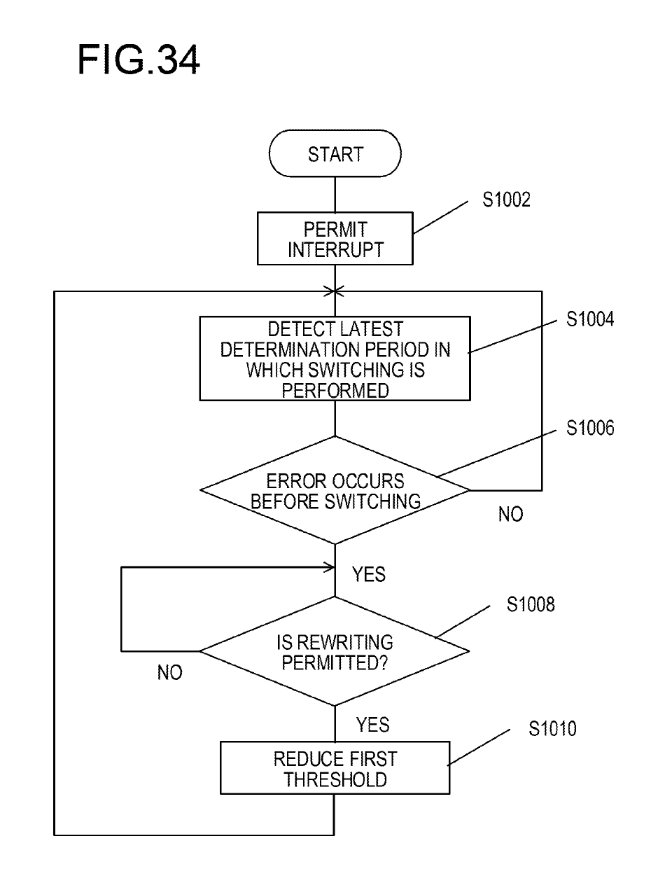

FIG. 34 illustrates an example of the flowchart of the first adjustment program 402a. The first adjustment program 402a is executed by the determination unit 32 (see FIG. 6). In other words, the first adjustment program 402a is executed by the reception unit 20 (see FIG. 1) including the determination unit 32.

[Operation S1002]

First, the second CPU 56b permits the interrupt processing by, for example, the termination program.

[Operation S1004]

After operation S1002, the second CPU 56b refers to the first history table 96a (see FIG. 31) and detects a latest period in which the switching processing is executed, during the period from the determination start date and time 414 to the determination termination date and time 416.

The switching processing is a processing executed in operation S308 (see FIG. 33). Hereinafter, the period from the determination start date and time 414 (see FIG. 31) to the determination termination date and time 416 is called a determination period.

Specifically, the second CPU 56b detects all determination time periods by referring to, for example, the first history table 96a. The second CPU 56b extracts a determination period including the first polarization fluctuation amount 46a (or error data) whose absolute value is larger than the first threshold 112a among the detected determination periods.

The second CPU 56b also detects the latest determination period of the extracted determination periods based on the determination start date and time 414 (or the determination termination date and time 416). The latest determination period is a latest determination period in which the switching processing is executed.

[Operation S1006]

The second CPU 56b determines whether the conversion error occurs before the switching processing in the “latest determination period in which switching is executed” detected in operation S1004. When it is determined that the conversion error occurs before the switching processing, the second CPU 56b proceeds to operation S1008. When it is determined that the conversion error does not occur before the switching processing, the second CPU 56b returns to operation S1004.

Specifically, the second CPU 56b specifies a date and time when the first polarization fluctuation amount 46a first exceeds the first threshold 112a (hereinafter, referred to as a switching date and time) in the determination period detected in operation S1004 by referring to, for example, the first history table 96a. The second CPU 56b also determines whether or not the error data 120 has been received before the switching date and time in the determination period detected in the operation S1004 by referring to the first history table 96a.

When the second CPU 56b determines that the error data 120 is received before the switching date and time, the second CPU 56b proceeds to operation S1008. When the second CPU 56b determines that the error data 120 is not received before the switching date and time, the second CPU 56b returns to operation S1004.

[Operation S1008]

The second CPU 56b determines whether the interrupt to the fourth judgment processing is permitted by referring to the second flag 109b (see FIG. 32). That is, the second CPU 56b determines whether rewriting of the first threshold 112a is permitted.

When the second CPU 56b determines that the interrupt is permitted, the second CPU 56b proceeds to operation S1010. When the second CPU 56b determines that the interrupt is not permitted, the second CPU 56b executes operation S1008 again.

[Operation S1010]

The second CPU 56b reduces the value of the first threshold 112a of the threshold table 108 (see FIG. 14). Thereafter, the second CPU 56b returns to operation S1004.

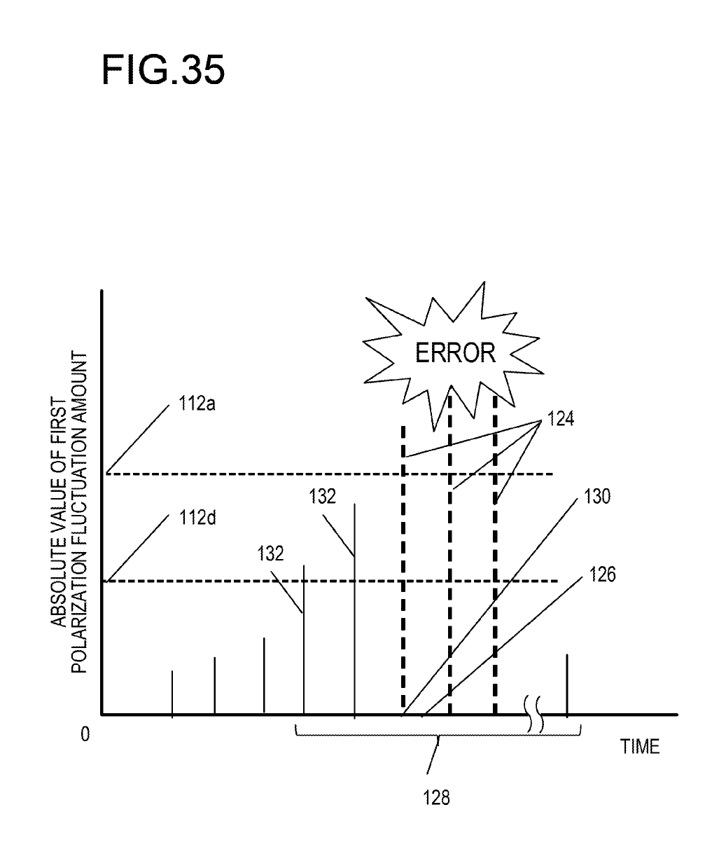

FIG. 35 is a diagram for describing an example of a procedure for reducing the first threshold 112a. The horizontal axis represents time. The vertical axis represents the absolute value of the first polarization fluctuation amount 46a. The horizontal axis and the vertical axis are the linear axes. A dashed line 124 extending in a vertical direction indicates the absolute value of the first polarization fluctuation amount 46a when the conversion error occurs in the first transponder 24a. Further, when the conversion error occurs, the DSP chip 50 of the fourth embodiment outputs the error data instead of the first polarization fluctuation amount 46a. Therefore, the first polarization fluctuation amount 46a indicated by the dashed line 124 extending in the vertical direction is not transmitted to the determination unit 32.

For example, from the first history table 96a (see FIG. 31), the second CPU 56b extracts the first polarization fluctuation amount 46a which is detected during a period from the start of the latest determination period 128 (see FIG. 35) up to a time 130 when the error data 120 is first received. The second CPU 56b also derives a median of the absolute values of the first polarization fluctuation amount 46a, which is larger than the fourth threshold 112d and smaller than the first threshold 112a of absolute values 132 of the extracted first polarization fluctuation amount 46a. The second CPU 56b changes the value of the first threshold 112a of the threshold table 108 (see FIG. 14) to the derived median. Thereafter, the second CPU 56b returns to operation S1004.

As described above, the second CPU 56b reduces the first threshold 112a by executing the fourth judgment program 90d, the third recording program 92c, and the first adjustment program 402a, so as to suppress the occurrence of the transmission error.

Specifically, when the conversion error occurs in the first transponder 24a before switching the transponder that outputs the transmission information 42, the second CPU 56b reduces the first threshold 112a of the threshold table 108.

The decreased first threshold 112a may not be the median described above. The reduced first threshold 112a may be, for example, an average value of the first threshold 112a and the fourth threshold 112d before the reduction.

### (4) Suppression of Transmission Error

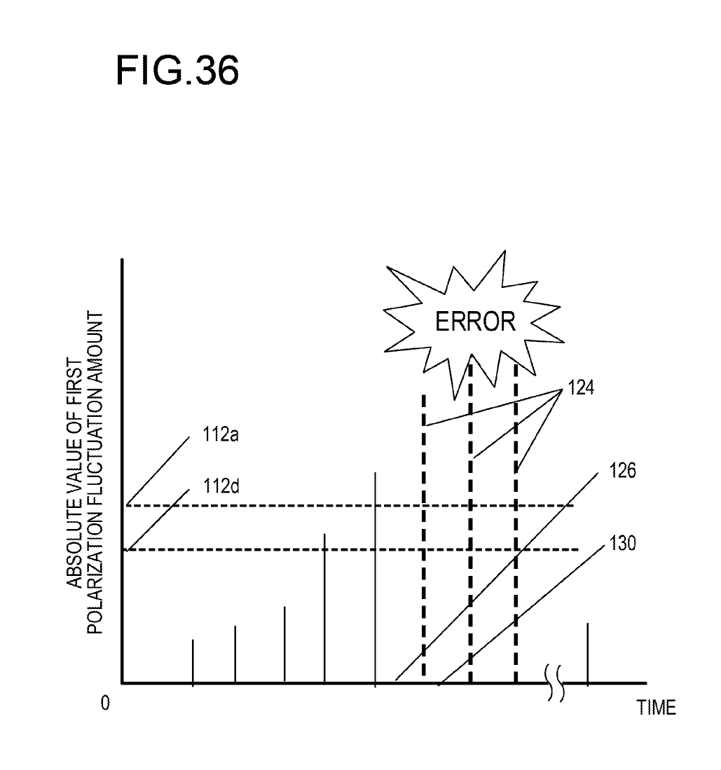

FIG. 36 is a diagram illustrating a relationship of the reduced first threshold 112a and the first polarization fluctuation amount 46a. The horizontal axis represents time. The vertical axis represents the absolute value of the first polarization fluctuation amount 46a. The horizontal axis and the vertical axis are the linear axes.

FIG. 35 described above illustrates the relationship of the first threshold 112a before the reduction and the first polarization fluctuation amount 46a. In the example illustrated in FIG. 35, the conversion error occurs before a time 126 at which the transponder is switched. As a result, the output of the transmission information 42 from the reception unit 20 is temporarily interrupted.

Meanwhile, the first threshold 112a in FIG. 36 is smaller than the first threshold 112a in FIG. 35. As a result, the time 126 at which the transponder is switched is a time before a time 130 at which the error data 120 is first received. Therefore, the output of the transmission information 42 from the reception unit 20 is never interrupted.

As described above, when the output 42 of the transmission information transmitted by the first signal light 6a stops before the output of the transmission information 42 transmitted by the second signal light 6b starts, the reception unit 20 of the fourth embodiment reduces the first threshold 112a.

When the first threshold 112a is reduced, the timing at which the output of the transmission information 42 transmitted by the second signal light 6b starts becomes earlier. As a result, the occurrence of the transmission error is suppressed.

In the above example, the reception unit 20 of the fourth embodiment is configured to execute each operation of the second determination processing of the second embodiment and operations S902 to S910. However, the reception unit 20 of the fourth embodiment may be configured to execute each operation of the first determination processing (or modified example) of the first embodiment and operations S902 to S910 (the same applies to the fifth embodiment as well). Alternatively, the reception unit 20 of the fourth embodiment may be configured to execute each operation of the third determination processing of the third embodiment and operations S902 to S910 (the same applies to a fifth embodiment as well). In this case, the detection unit 22 of the fourth embodiment is configured to perform substantially the same operation as the detection unit 22 of the third embodiment.

### Fifth Embodiment

The optical transmission device according to the fifth embodiment is an optical transmission device that suppresses the dependency on the second route 10b which is the preliminary route by increasing the first threshold which is set too small. The optical transmission device of the fifth embodiment is similar to the optical transmission devices of the second to fourth embodiments. Therefore, for example, the description of the same parts as those of the second to fourth embodiments will be omitted or simplified.

### (1) Configuration and Operation

The optical transmission device of the fifth embodiment has substantially the same structure (see FIGS. 1 and 6) as the optical transmission devices 2 and 102 of the second embodiment. That is, the optical transmission device of the fifth embodiment includes the reception unit 20 and the detection unit 22.

The detection unit 22 of the fifth embodiment is configured to perform substantially the same operation as the detection unit 22 of the second embodiment.

Similarly, the reception unit 20 of the fifth embodiment is configured to perform substantially the same operation as the reception unit 20 of the second embodiment. The reception unit 20 of the fifth embodiment is also configured to increase the first threshold 112a in a predetermined case.

Specifically, the reception unit 20 increases the first threshold when the output of the transmission information by the first signal light is not interrupted while the execution of the output of the transmission information transmitted by the first signal light and the execution of the output of the transmission information transmitted by the second signal light are repeated.

When the first threshold 112a increases, the time for outputting the transmission information 42 from the second route 10b decreases. That is, the dependency on the second route 10b which is the preliminary route is suppressed.

### (2) Hardware

The optical transmission device of the fifth embodiment has substantially the same hardware configuration (see, e.g., FIG. 8) as the optical transmission device of the second embodiment.

### (3) Software

### (3-1) Program

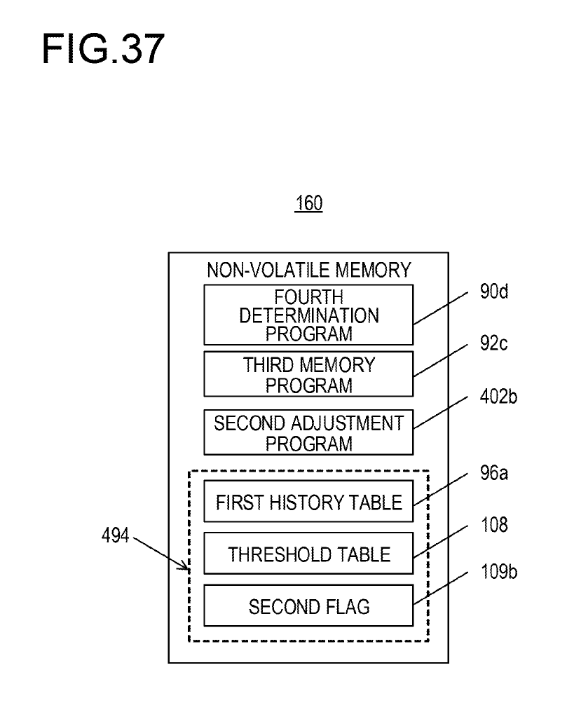

FIG. 37 is a diagram illustrating a program and a data file 494 recorded in the non-volatile memory 160 of the determination unit 32 (see FIG. 8).

The fourth determination program 90d, the third recording program 92c, and a second adjustment program 402b are recorded in the non-volatile memory 160 of the optical transmission device of the fifth embodiment.

### (3-2) Data File

The first history table 96a, the threshold table 108, and the second flag 109b are recorded in the non-volatile memory 160.

### (3-3) Processing

The second CPU 56b reads and concurrently executes the fourth determination program 90d, the third recording program 92c, and the second adjustment program 402b from the non-volatile memory 160. The fourth determination program 90d and the third recording program 92c are described in the fourth embodiment.

(3-3-1) Second Adjustment Processing (Processing by Second Adjustment Program 402b)

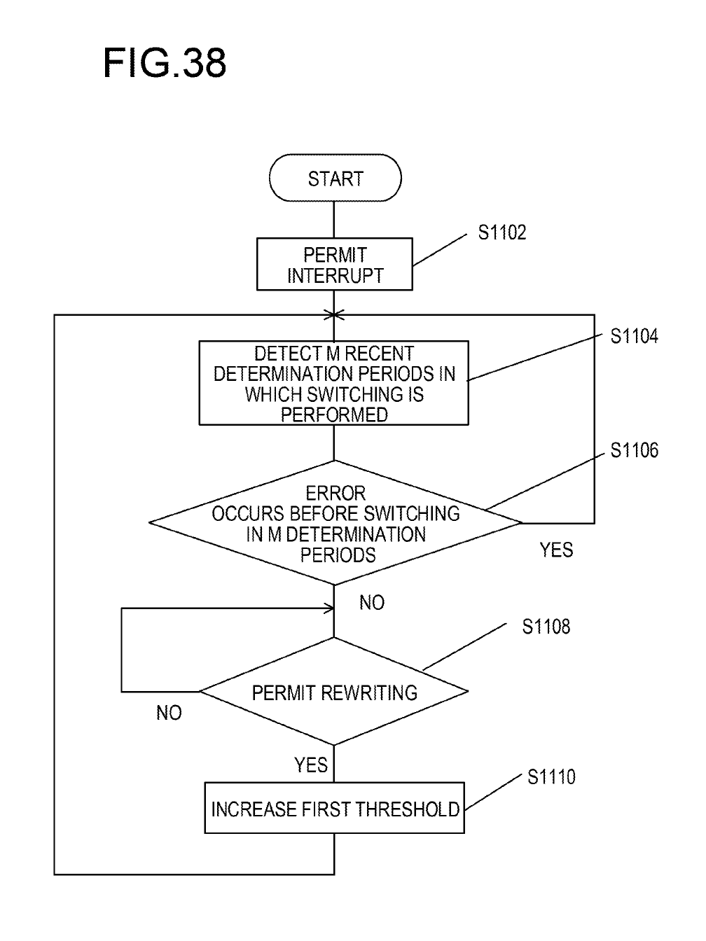

FIG. 38 illustrates an example of the flowchart of the second adjustment program 402b. The second adjustment program is executed by the determination unit 32 (see FIG. 6). In other words, the second adjustment program is executed by the reception unit 20 including the determination unit 32.

[Operation S1102]

First, the second CPU 56b permits the interrupt processing by, for example, the termination program.

[Operation S1104]

The second CPU 56b detects M (e.g., 10) recent determination periods in which the switching processing is executed, by referring to the first history table 96a (see FIG. 31). The M represents, for example, an integer of 2 to 100.

Specifically, for example, the second CPU 56b extracts all determination periods in which the first polarization fluctuation amount 46a whose absolute value is larger than the first threshold 112a is detected, by referring to the first history table 96a. The second CPU 56b also detects M recent determination periods from the extracted determination periods based on the determination start date and time 414 (or the determination termination date and time 416).

[Operation S1106]

The second CPU 56b determines whether the conversion error occurs before the switching processing (operation S308 of FIG. 21) in any one of the determination periods detected in operation S1104. When it is determined that the conversion error occurs before the switching processing in any one determination period, the second CPU 56b returns to operation S1104. When it is determined that the conversion error does not occur before the switching processing even in any determination period, the second CPU 56b proceeds to operation S1108.

Specifically, the second CPU 56b specifies a date and time when the absolute value of the first polarization fluctuation amount 46a first exceeds the first threshold 112a (hereinafter, referred to as a switching date and time) in each determination period detected in operation S1104 by referring to, for example, the first history table 96a. The second CPU 56b also determines whether the error data 120 is received before the switching date and time in each determination period detected in operation S1104 by referring to the first history table 96a.

When the second CPU 56b determines that the error data 120 is received before the switching date and time in any one determination period, the second CPU 56b returns to operation S1104. When the second CPU 56b determines that the error data 120 is not received before the switching date and time even in any one determination period, the second CPU 56b proceeds to operation S1108.

[Operation S1108]

The second CPU 56b determines whether the interrupt to the fourth determination processing is permitted, by referring to the second flag 109b (see FIG. 32). That is, the second CPU 56b determines whether the rewriting of the first threshold 112a is permitted.

When the second CPU 56b determines that the interrupt is permitted, the second CPU 56b proceeds to operation S1110. When the second CPU 56b determines that the interrupt is not permitted, the second CPU 56b executes operation S1108 again.

[Operation S1110]

The second CPU 56b increases the first threshold 112a of the threshold table 108 (see FIG. 14). Thereafter, the second CPU 56b returns to operation S1104.

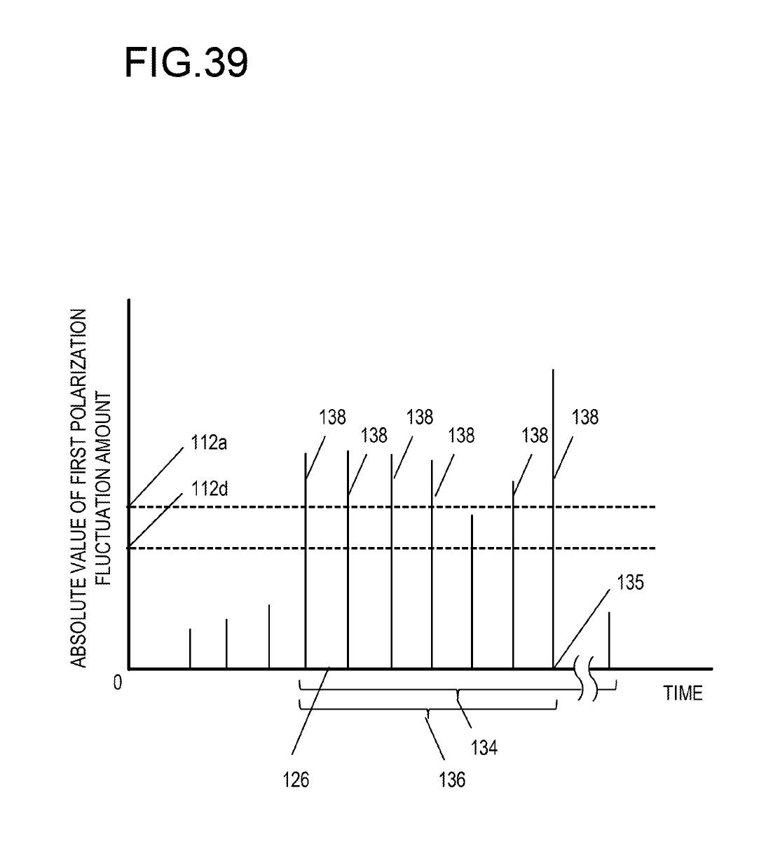

FIG. 39 is a diagram for describing an example of a procedure for increasing the first threshold 112a. The horizontal axis represents time. The vertical axis represents the absolute value of the first polarization fluctuation amount 46a. The horizontal axis and the vertical axis are the linear axes.

For example, the second CPU 56b detects a period 136 from the start of each determination period 134 detected in operation S1104 to the time 135 (or the detection time point of the error data) at which the absolute value of the first polarization fluctuation amount 46a becomes the maximum in each determination period.

The second CPU 56b also detects an absolute value 138 equal to or larger than the first threshold 112a as the absolute value of the first polarization fluctuation amount 46a received in each detected period 136, by referring to the first history table 96a. The second CPU 56b derives a median (hereinafter, referred to as a first median) of the absolute value 138 detected within each period 136. The second CPU 56b also calculates a median (hereinafter, referred to as a second median) of the first median. The second CPU 56b changes the first threshold 112a of the threshold table 108 (see FIG. 14) to the calculated second median. Thereafter, the second CPU 56b returns to operation S1104.

The increased first threshold 112a may not be the second median. The increased first threshold 112a may be, for example, a threshold of 1.1 to 2.0 times the first threshold 112a before the increase.

### (4) Suppression of Dependency on Second Route

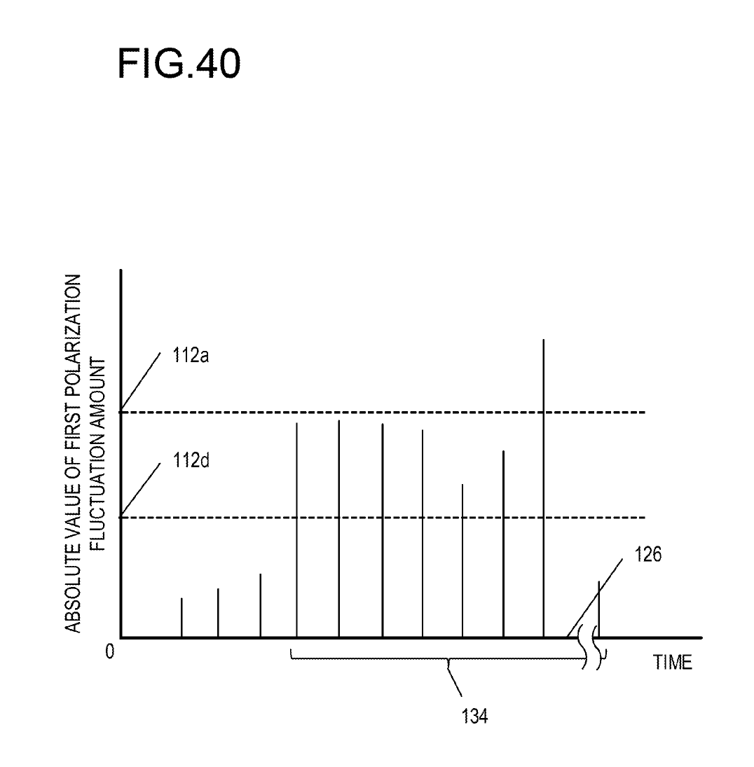

FIG. 40 is a diagram illustrating the relationship of the increased first threshold 112a and the first polarization fluctuation amount 46a. The horizontal axis represents time. The vertical axis represents the absolute value of the first polarization fluctuation amount 46a. The horizontal axis and the vertical axis are the linear axes.

FIG. 39 described above illustrates the relationship of the first threshold 112a before the increase and the first polarization fluctuation amount 46a. In the example illustrated in FIG. 39, the first threshold 112a is set small. As a result, the transponder that outputs the transmission information 42 is switched from the first transponder 24a to the second transponder 24b in a short time period after the polarization fluctuation starts. For this reason, a period during which information is output via the second route 10b becomes longer. Since the second route 10b is a preliminary transmission line, it is not preferable to use the second route 10b for a long time.

The first threshold 112a in FIG. 40 is larger than the first threshold 112a in FIG. 39. Therefore, in the example illustrated in FIG. 40, the time 126 at which the transponder is switched becomes later than the time 126 in the example illustrated in FIG. 39. As a result, a time to use the second route 10b for the information transmission is shortened.

The second CPU 56b may execute the second adjustment processing of the fifth embodiment and the first adjustment processing of the fourth embodiment in parallel. Both the case where the first threshold is set too small and the case where the first threshold is set to be excessive may be dealt with by the parallel execution of the second adjustment processing and the first adjustment processing.

As described above, the reception unit 20 of the fifth embodiment increases the first threshold 112a when there is no conversion error before the switching of the transponder in the M (M is an integer of 2 or more) recent determination periods. That is, when the output of the transmission information 42 of the first signal light 6a is not interrupted while the output of the transmission information 42 by the first signal light 6a and the output of the transmission information 42 by the second signal light 6b are repeated, the reception unit 20 of the fifth embodiment increases the first threshold 112a. When the first threshold 112a increases, the time for outputting the transmission information 42 from the second route 10b decreases. Accordingly, the dependency on the second route 10b is suppressed.

### Sixth Embodiment

The optical transmission device according to the sixth embodiment is a device that changes signal light supplied to the block that reproduces the transmission information from the signal light from the first route 10a to the signal light from the second route 10b when the first polarization fluctuation amount of the first signal light from the first route 10a exceeds the first threshold. According to the sixth embodiment, before the polarization of the first signal light largely fluctuates due to the lightning, the signal light supplied to a block for reproducing the transmission information (hereinafter, referred to as a third reception unit) is changed to the signal light from the second route 10b. Therefore, the transmission error due to the lightning in the vicinity of the first route 10a is suppressed.

The optical transmission device of the sixth embodiment is similar to the optical transmission devices of the second embodiment. Therefore, for example, the description of the same parts as those of the second embodiment is omitted or simplified.

### (1) Configuration and Operation

### (1-1) Configuration Example 1

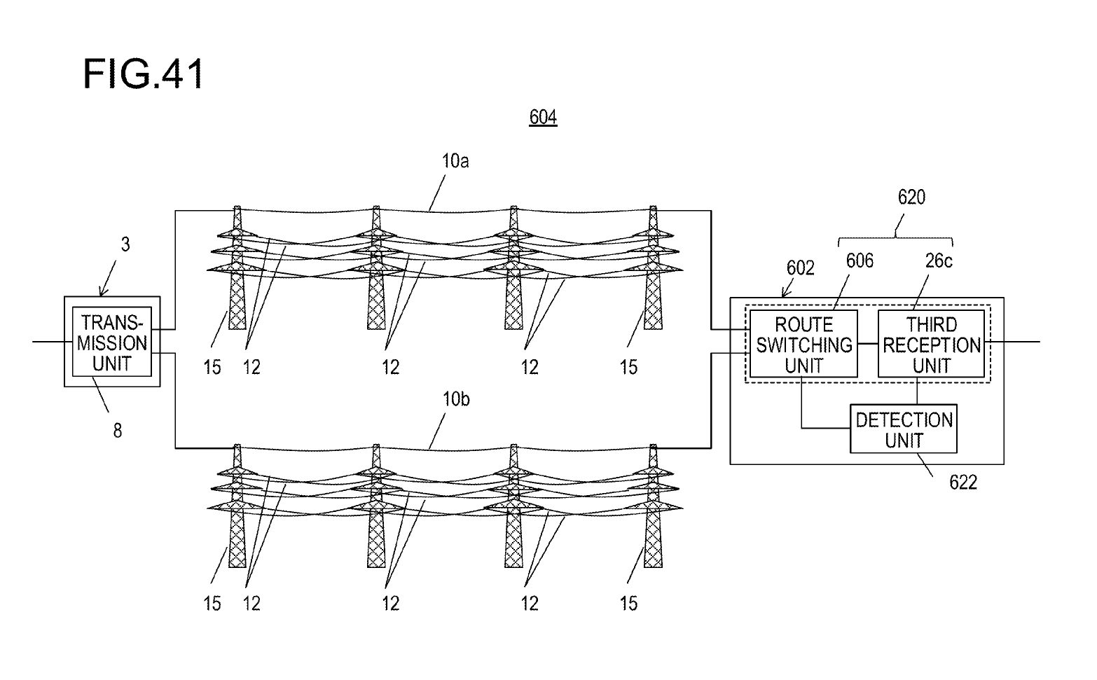

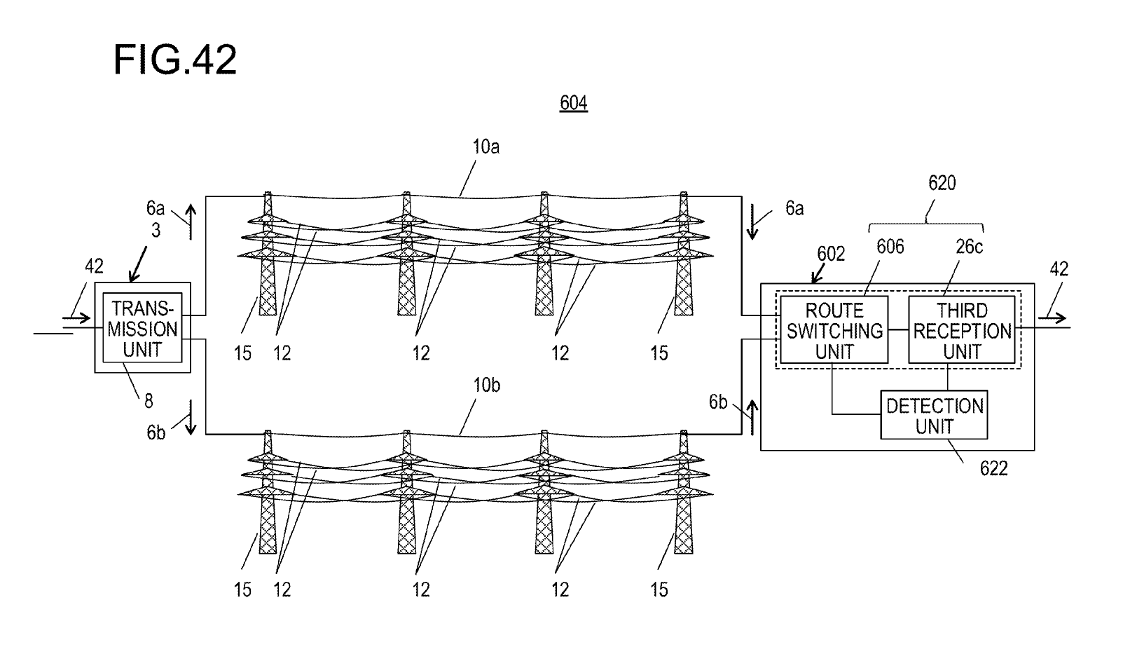

FIG. 41 is a diagram illustrating an example of an optical communication system 604 to which an optical transmission device 602 according to a sixth embodiment is applied. FIG. 42 is a diagram illustrating flows of signal lights 6a and 6b in the optical communication system 604.

The optical transmission device 602 includes a reception unit 620 and a detection unit 622. The reception unit 620 includes a route switching unit 606 and a third reception unit 26c. The route switching unit 606 receives the first signal light 6a (see FIG. 42) and the second signal light 6b.

Before the absolute value of the first polarization fluctuation amount 46a exceeds the first threshold 112a, the route switching unit 606 transmits the first signal light 6a to the third reception unit 26c. The route switching unit 606 also transmits the second signal light 6b to the third reception unit 26c after the absolute value of the first polarization fluctuation amount 46a of the first signal light 6a exceeds the first threshold 112a.

The third reception unit 26c reproduces and outputs the transmission information from the transmitted first signal light 6a and also reproduces and outputs the transmission information from the transmitted second signal light 6b.

### (1-2) Configuration Example 2

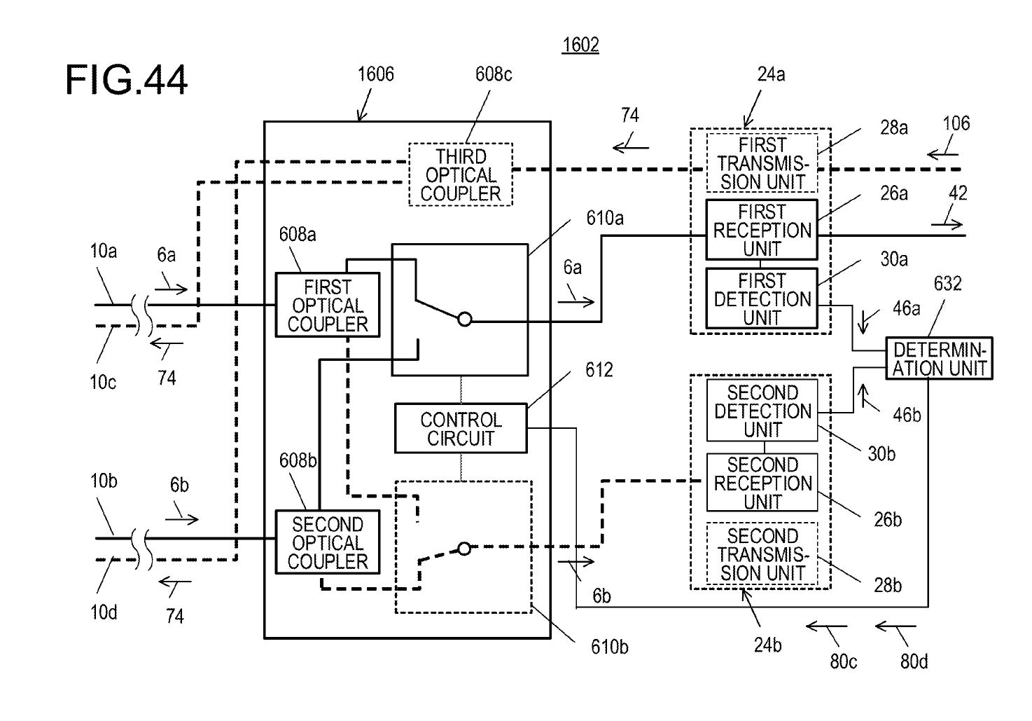

FIG. 43 is a diagram illustrating another example of an optical communication system to which an optical transmission device 1602 of the sixth embodiment is applied. FIG. 44 is a diagram illustrating flows of the signal lights 6a and 6b in FIG. 43.

The optical transmission device 1602 is connected to one end of the transmission route (the first route 10a to the fourth route 10d). An optical transmission device (not illustrated) having substantially the same structure and function as the optical transmission device 1602 is connected to the other end of the transmission route (the first route 10a to the fourth route 10d). According to the optical communication system of FIG. 43, a bidirectional communication becomes available.

The first route 10a is, for example, a route that passes through one optical fiber of the two-core OPGW. The third route 10c passes through the other optical fiber of the two-core OPGW.

The second route 10b is, for example, a route passing through one optical fiber of the two-core OPGW different from the OPGW through which the first route 10a passes. The fourth route 10d passes through the other optical fiber of the two-core OPGW.

The optical transmission device 1602 includes a first transponder 24a, a second transponder 24b, a determination unit 632, and an optical path switch 1606.

(1-2-1) Transponder

The first transponder 24a of the optical transmission device 1602 has substantially the same structure as the first transponder 24a (see FIG. 6) of the first embodiment, except for the structure of the electro-optic conversion circuit 54 to be described later. The same applies to the second transponder 24b as well.

The first transponder 24a of the optical transmission device 1602 is configured to perform substantially the same operation as the first transponder 24a of the first embodiment, except for the operation of the electro-optic conversion circuit 54 to be described later. The same applies to the second transponder 24b as well.

Meanwhile, the first reception unit 26a of the first transponder 24a is connected to a communication device such as a router without passing through the first Y cable 34a. The same applies to the first transmission unit 28a of the first transponder 24a as well.

The first reception unit 26a of the second transponder 24b is not connected to the communication device such as the router. The second transmission unit 28b of the second transponder 24b is not connected to any of the second route 10b and the communication device such as the router.

(1-2-2) Determination Unit

The determination unit 632 has substantially the same structure as the determination unit 32 of the first embodiment.

The determination unit 32 of the first embodiment transmits the first command 48a to the first reception unit 26a via the first detection unit 30a. The determination unit 32 of the first embodiment also transmits the second command 48b to the second reception unit 26b via the second detection unit 30b. Meanwhile, the determination unit 632 of the optical transmission device 1602 transmits a third control signal 80c and a fourth control signal 80d to the optical path switch 1606.

Except for the above point, the determination unit 632 is configured to perform substantially the same operation as the determination unit 32 of the first embodiment.

(1-2-3) Optical Path Switch

The optical path switch 1606 is, for example, an optical uni-directional path switched ring (OUPSR).

The optical path switch 1606 includes a first optical coupler 608a for receiving the first signal light 6a from the first route 10a and a second optical coupler 608b for receiving the second signal light 6b from the second route 10b. For example, the first optical coupler 608a and the second optical coupler 608b are directional couplers whose lengths are adjusted so as to divide input light into two. The same applies to a third optical coupler 608c as well to be described later.

The optical path switch 1606 also includes a first optical switch 610a for receiving one of the first signal light 6a divided by the first optical coupler 608a and one of the second signal light 6b divided by the second optical coupler 608b. The first optical switch 610a transmits any one of the received first signal light 6a and the received second signal light 6b. The same applies to a second optical switch 610b as well to be described later.

The signal light transmitted by the first optical switch 610a is received by the first reception unit 26a of the first transponder 24a. The first optical switch 610a is, for example, a directional coupler configured to switch the signal light to be output in response to a control signal.

The optical path switch 1606 also includes the second optical switch 610b for receiving the other one of the first signal light 6a divided by the first optical coupler 608a and the other one of the second signal light 6b divided by the second optical coupler 608b. The second optical switch 610b transmits any one of the received first signal light 6a and the received second signal light 6b.

The signal light transmitted by the second optical switch 610b is received by the second reception unit 26b of the second transponder 24b.

The optical path switch 1606 also includes a control circuit 612. The control circuit 612 controls the first optical switch 610a and the second optical switch 610b in response to the third control signal 80c from the judgment unit 632. The control circuit 612 is, for example, an application specific integrated circuit (ASIC). The control circuit 612 may be a device having a CPU, a memory such as a non-volatile memory or a RAM, and an interface circuit. In the non-volatile memory, a control program for controlling the first optical switch 610a and the second optical switch 610b is recorded.

The control circuit 612 controls the first and second optical switches 610a and 610b so that the first optical switch 610a transmits one of the first signal light 6a and the second signal light 6b and the second optical switch 610b transmits the other one of the first signal light 6a and the second signal light 6b.

The optical path switch 1606 also includes the third optical coupler 608c. The third optical coupler 608c divides transmission light 74 transmitted by the first transmission unit 28a of the first transponder 24a and transmits one of the divided transmission lights to the third route 10c and the other to the fourth route 10d.

The route switching unit 606 of Configuration Example 1 (see FIG. 41) is a block including the optical path switch 1606 and the determination unit 632.

The third reception unit 26c of Configuration Example 1 corresponds to the first reception unit 26a of Configuration Example 2.

The detection unit 622 of Configuration Example 1 is a block including the first detection unit 30a of Configuration Example 2, the second reception unit 26b of Configuration Example 2, and the second detection unit 30b of Configuration Example 2.

(1-2-4) Operation

When the optical transmission device 1602 is activated, the control circuit 612 controls, for example, the first optical switch 610a to connect the first optical coupler 608a to the first reception unit 26a. The control circuit 612 also controls the second optical switch 610b to connect the second optical coupler 608b to the second reception unit 26b.

Upon receiving the first signal light 6a from the first route 10a, the first optical coupler 608a divides the received first signal light 6a into two and transmits one to the first optical switch 610a and the other to the second optical switch 610b.

Meanwhile, upon receiving the second signal light 6b from the second route 10b, the second optical coupler 608b divides the received second signal light 6b into two and transmits one to the first optical switch 610a and the other to the second optical switch 610b.

The first optical switch 610a transmits the first signal light 6a (one of the divided first signal lights 6a) received from the first optical coupler 608a to the first reception unit 26a. Meanwhile, the second optical switch 610b transmits the second signal light 6b (the other of the divided second signal lights 6b) received from the second optical coupler 608b to the second reception unit 26b.

The first reception unit 26a reproduces and outputs the transmission information 42 from the received first signal light 6a. The first detection unit 30a detects the first polarization fluctuation amount 46a of the first signal light 6a received by the first reception unit 26a and transmits the detected first polarization fluctuation amount 46a to the determination unit 632.

Meanwhile, the second reception unit 26b reproduces the transmission information from the received second signal light 6b, but does not output the reproduced transmission information. The second detection unit 30b detects the second polarization fluctuation amount 46b of the second signal light 6b received by the second reception unit 26b and transmits the detected second polarization fluctuation amount 46b to the determination unit 632.

The determination unit 632 determines whether the received first polarization fluctuation amount 46a exceeds the first threshold 112a, and when it is determined that the first polarization fluctuation amount 46a exceeds the first threshold 112a, the determination unit 632 transmits the third control signal 80c to the control circuit 612 of the optical path switch 1606.

The control circuit 612 that has received the third control signal 80c controls the first optical switch 610a to connect the second optical coupler 608b to the first reception unit 26a. The control circuit 612 also controls the second optical switch 610b to connect the first optical coupler 608a to the second reception unit 26b.

Then, the first optical switch 610a transmits the second signal light 6b (the other of the divided second signal lights 6b) received from the second optical coupler 608b to the first reception unit 26a. Meanwhile, the second optical switch 610b transmits the first signal light 6a (the other of the divided first signal lights 6a) received from the first optical coupler 608a to the second reception unit 26b.

The first reception unit 26a reproduces and outputs the transmission information 42 from the received second signal light 6b. The first detection unit 30a detects the second polarization fluctuation amount 46b of the second signal light 6b received by the first reception unit 26a and transmits the detected second polarization fluctuation amount 46b to the judgment unit 632.

Meanwhile, the second reception unit 26b reproduces the transmission information 42 from the received first signal light 6a, but does not output the reproduced transmission information 42. The second detection unit 30b detects the first polarization fluctuation amount 46a of the first signal light 6a received by the second reception unit 26b and transmits the detected first polarization fluctuation amount 46a to the determination unit 632.

The first transmission unit 28a converts the signal light 106 received from the communication device (not illustrated) such as the router into the transmission light 74 and transmits the transmission light 74 to the third optical coupler 608c. The third optical coupler 608c divides the received transmission light 74 and transmits one of the divided transmission lights 74 to the first route 10a. The third optical coupler 608c also transmits the other of the divided transmission lights 74 to the second route 10b.

### (2) Hardware

### (2-1) Transponder

The first transponder 24a of the sixth embodiment is configured so that the laser driver 75 (see FIG. 11) of the electro-optical conversion circuit 54 (see FIG. 8) continuously drives the semiconductor laser 78 in response to the electrical signal 70a from the DSP chip 50 immediately after activation. The first transponder 24a of the sixth embodiment has substantially the same hardware configuration as the hardware (see FIG. 8) of the first transponder 24a of the first embodiment except for the above point. The first CPU 56a, the memory 58, and the non-volatile memory 60 may be omitted. The same applies to the second transponder 24b as well.

The first reception unit 26a (that is, the third reception unit 26c) is implemented by the photoelectric conversion circuit 52, the DSP chip 50, the electro-optical conversion circuit 54, the first CPU 56a, and the memory 58 in the first transponder 24a similarly to the first reception unit 26a of the first embodiment. The same applies to the second reception unit 26b as well.

The first detection unit 30a is implemented by the DSP chip 50 (particularly, the polarization detection unit 88) in the first transponder 24a. The same applies to the second detection unit 30b as well.

The electro-optical conversion circuit 54 of the sixth embodiment may have substantially the same structure as the electro-optical conversion circuit 54 of the first embodiment. In this case, a fifth determination program 90e (see “(3-3-1) Fifth determination processing”) includes, for example, operation S304 of initializing the transponder.

### (2-2) Determination Unit

The determination unit 632 has substantially the same hardware configuration as the determination unit 32 (see FIG. 8) of the first embodiment. Accordingly, the determination unit 632 is implemented by the second CPU 56b and the memory 158 (see the first embodiment).

### (2-3) Optical Path Switch

The hardware configuration of the optical path switch 1606 is described in “(1-2-3) Optical path switch.”

### (3) Software

### (3-1) Program

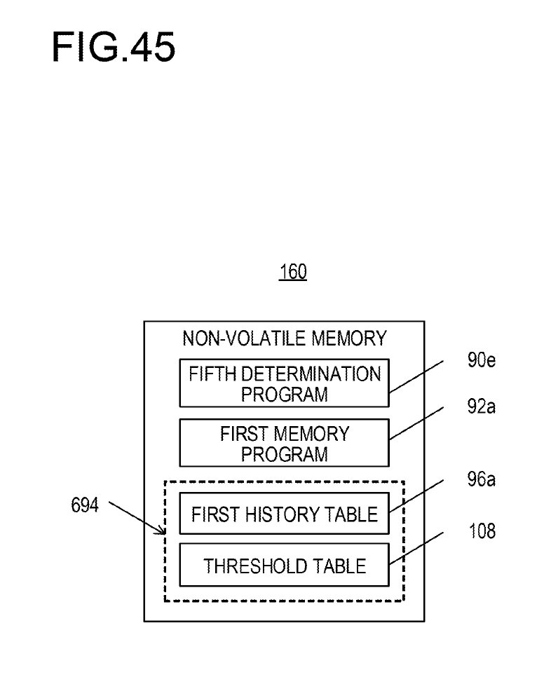

FIG. 45 is a diagram illustrating a program and a data file 694 recorded in the non-volatile memory 160 (see FIG. 8) of the determination unit 632.

As illustrated in FIG. 45, the first determination program 90e and the first recording program 92a are recorded in the non-volatile memory 160 of the sixth embodiment.

### (3-2) Data File

As illustrated in FIG. 45, the first history table 96a and the threshold table 108 are recorded in the non-volatile memory 160 of the sixth embodiment.

### (3-3) Processing

The second CPU 56b reads and concurrently executes the fifth determination program 90e and the first recording program 92a from the non-volatile memory 160. The first recording program 92a is described in the first embodiment.

(3-3-1) Fifth Determination Processing (Processing by Fifth Determination Program 90e)

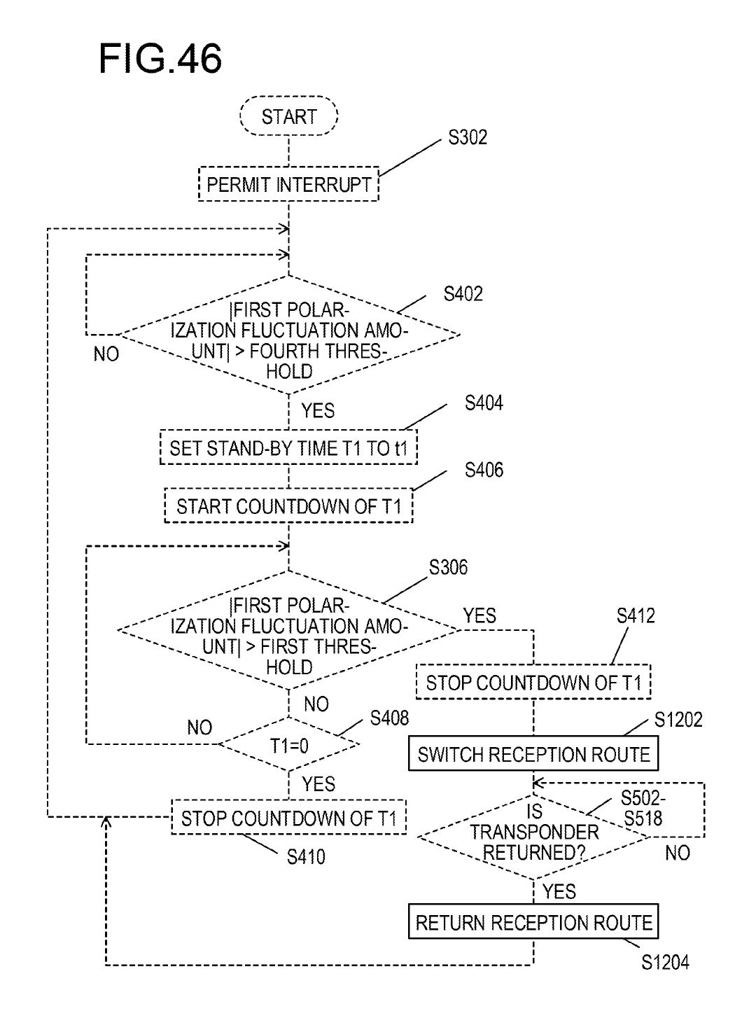

FIG. 46 illustrates an example of the flowchart of the fifth determination program 90e. The fifth determination program 90e monitors the first polarization fluctuation amount 46a of the light from the first route 10a and when the absolute value of the first polarization fluctuation amount 46a exceeds the first threshold 112a, the fifth determination program 90e is a program for reproducing and outputting the transmission information 42 from the signal light from the second route 10b. The fifth determination program 90e is executed by the judgment unit 632. In other words, the fifth determination program 90e is executed by the reception unit 620 including the determination unit 632.

The fifth determination program 90e of FIG. 46 is similar to the second determination program described in the second embodiment. The operations marked by the dashed lines in FIG. 46 are the operations described in the first and second embodiments.

The fifth determination program 90e includes operation S1202 instead of operation S308 (see FIG. 21) of the second judgment program 90b. The fifth determination program 90e also includes operation S1204 instead of operation S520 (see FIG. 22) of the second judgment program 90b. The fifth determination program 90e does not also have operation S304 for initializing the transponder. Except for the above point, the fifth determination program 90e is substantially the same as the second determination program 90b.

[Operation S1202]

When the second CPU 56b determines that the absolute value of the first polarization fluctuation amount 46a of the first signal light 6a exceeds the first threshold 112a in operations S402 to S412 and S306, the second CPU 56b changes a transmission destination of each of the first signal light 6a and the second signal light 6b to the optical path switch 1606. Specifically, the second CPU 56b transmits the third control signal 80c to the control circuit 612 (see FIG. 44) of the optical path switch 1606.

Upon receiving the third control signal 80c, the control circuit 612 controls the first optical switch 610a to connect the second optical coupler 608b to the first receiving unit 26a. The control circuit 612 also controls the second optical switch 610b to connect the first optical coupler 608a to the second reception unit 26b. By operation S1202, the transmission of the second signal light 6b to the first reception unit 26a starts.

[Operation S1204]

When the second CPU 56b determines that the absolute value of the first polarization fluctuation amount 46a does not exceeds the second threshold 112b for the predetermined time t2 in operation S514 (see FIG. 22), the second CPU 56b changes the transmission destination of each of the first signal light 6a and the second signal light 6b to the optical path switch 1606 again.

Specifically, the second CPU 56b transmits the fourth control signal 80d to the control circuit 612 of the optical path switch 1606. Upon receiving the fourth control signal 80d, the control circuit 612 controls the first optical switch 610a to connect the first optical coupler 608a to the first reception unit 26a. The control circuit 612 also controls the second optical switch 610b to connect the second optical coupler 608b to the second reception unit 26b. By operation S1204, the transmission of the first signal light 6a to the first reception unit 26a restarts.

As described above, the optical transmission device according to the sixth embodiment changes the signal light supplied to the third reception unit 26c, from the signal light from the first route 10a to the signal light from the second route 10b, when the absolute value of the first polarization fluctuation amount of the first signal light from the first route 10a exceeds the first threshold. Therefore, according to the optical transmission device 602 of the sixth embodiment, the occurrence of the transmission error due to the lightning in the vicinity of the first route 10a is suppressed.

The optical transmission devices 602 and 1602 according to the sixth embodiment are configured to perform processing similar to the processing of the second embodiment. However, the optical transmission devices 602 and 1602 of the sixth embodiment may be configured to perform a processing similar to the processing of the first and third to fifth embodiments (e.g., the first, third, and fourth determination processing, and the first and second adjustment processing).

Specifically, for example, the optical transmission devices 602 and 1602 may execute processing of changing operations S308 and S520 of the first, third, and fourth determination processing to operations S1202 and S1204 of the fifth determination processing, instead of the fifth determination processing of the sixth embodiment. Except for the above point, the optical transmission devices 602 and 1602 may perform substantially the same processing as the processing of the first and third to fifth embodiments.

### Seventh Embodiment

The optical transmission device of the seventh embodiment is a device that makes the second signal light to be transmitted by the transmission device connected to the reception unit via an optical transmission line when the absolute value of the polarization fluctuation amount of the first signal light exceeds the first threshold. The second signal light is signal light which is modulated by a method different from the modulation method of the first signal light and has a bit rate lower than the first signal light.

According to the seventh embodiment, before the polarization of the first signal light fluctuates largely due to the lightning, the second signal light which has the low bit rate and is modulated by a method that is hardly affected by polarization fluctuation is transmitted, and as a result, the transmission error due to the lightning is reduced.

The optical transmission device of the seventh embodiment is similar to the optical transmission device of the second embodiment. Therefore, for example, the description of the same parts as the second embodiment will be omitted or simplified.

### (A) System

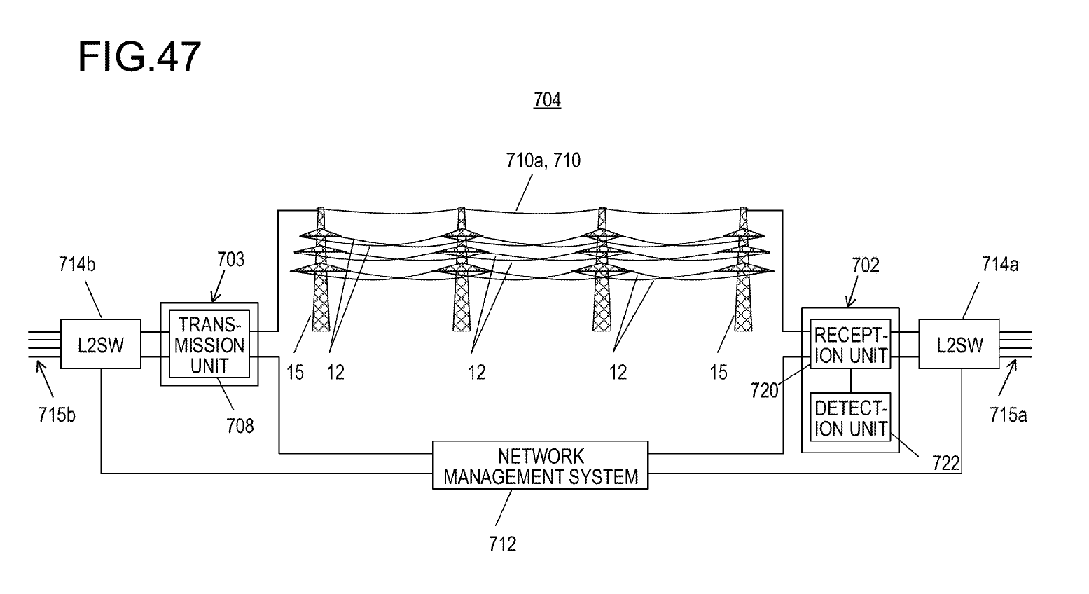

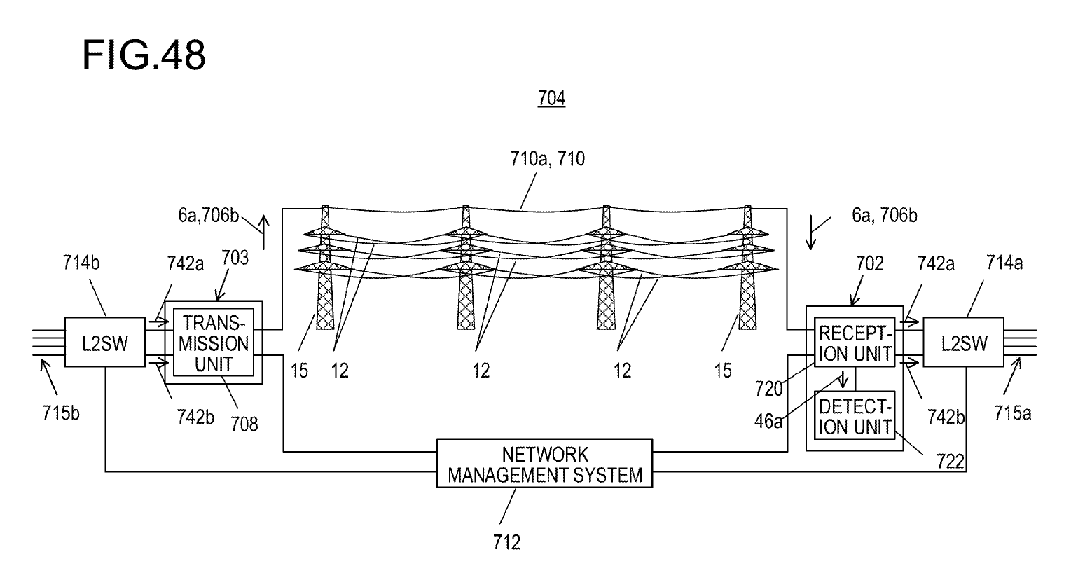

FIG. 47 is a diagram illustrating an example of an optical communication system 704 to which an optical transmission device 702 according to a seventh embodiment is applied. FIG. 48 is a diagram illustrating flows of signal lights 6a and 706b in the optical communication system 704.

The optical communication system 704 includes an optical transmission device 702, an optical transmission device 703 having a transmission unit 708, and an optical transmission line 710 connecting the optical transmission device 702 and the optical transmission device 703 to each other. The optical transmission line 710 is, for example, the OPGW optical fiber. That is, the optical transmission line 710 is an optical fiber 14 that passes through a region 19 wound by a conductive wire 18 extending in a swirling manner (see FIG. 3).

The optical communication system 704 also includes a network management system 712. The network management system is, for example, a server.

The optical communication system 704 also includes a layer 2 switch 714a (hereinafter, referred to as a first layer 2 switch) that connects the communication device (not illustrated) such as the router and the optical transmission device 702 to each other. The optical communication system 704 also includes a plurality of first transmission lines 715a (e.g., a plurality of optical fibers) that connect the communication device (not illustrated) such as the router and the first layer 2 switch 714a to each other.

The optical communication system 704 also includes a layer 2 switch 714b (hereinafter, referred to as a second layer 2 switch) that connects the communication device (not illustrated) such as the router and the optical transmission device 703 to each other. The optical communication system 704 also includes a plurality of second transmission lines 715b (e.g., the plurality of optical fibers) that connect the communication device (not illustrated) such as the router and the second layer 2 switch 714b to each other.

### (B) Optical Transmission Device

### (1) Configuration and Operation

### (1-1) Configuration Example 1

The optical transmission device 702 includes a reception unit 720 that reproduces and outputs information (that is, transmission information) from the signal light from the optical transmission line 710. The optical transmission device 702 also includes a detection unit 722 that detects the first polarization fluctuation amount 46a of the light (e.g., the first signal light 6a) received by the reception unit 720.

The reception unit 720 monitors the first polarization fluctuation amount 46a detected by the detection unit 722, and before the absolute value of the first polarization fluctuation amount 46a exceeds the first threshold, the reception unit 720 reproduces and outputs information 742a from the first signal light 6a from a first optical transmission line 710a which is the optical transmission line 710.

After the absolute value of the detected first polarization fluctuation amount 46a exceeds the first threshold, the reception unit 720 makes the second signal light 706b to be transmitted by the transmission device 703 connected to the reception unit 720 via the first optical transmission line 710a. The transmission device 703 transmits the first signal light 6a and the second signal light 706b to the reception unit 720 via the first optical transmission line 710a.

The second signal light 706b is signal light which is modulated (e.g., light intensity-modulated) by a method different from the modulation method (e.g., dual polarization modulation) of the first signal light 6a and has the bit rate lower than the first signal light 6a. The first signal light 6a is, for example, light whose phase or frequency is modulated for transmission of information. The second signal light 706b is, for example, light whose intensity is modulated for transmission of information. The second signal light 706b may be signal light modulated by polarization diversity.

Signal light modulated by a method with a low bit rate is hardly affected by fluctuation in the polarization state. According to the optical transmission device 702, since the reproduction of the information starts by the second signal light 706b having a lower bit rate than the first signal light 6a and hardly affected by the polarization fluctuation, before the polarization of the first signal light 6a largely fluctuates due to the lightning, the transmission error due to the lightning is reduced.

### (1-2) Configuration Example 2

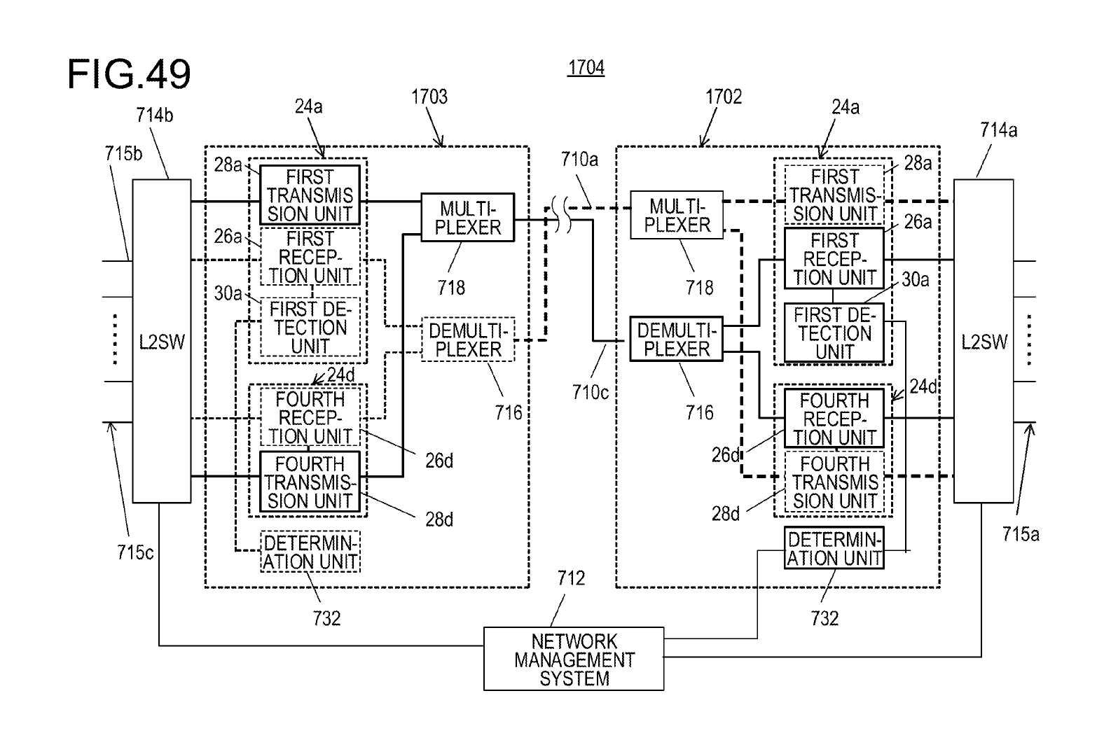

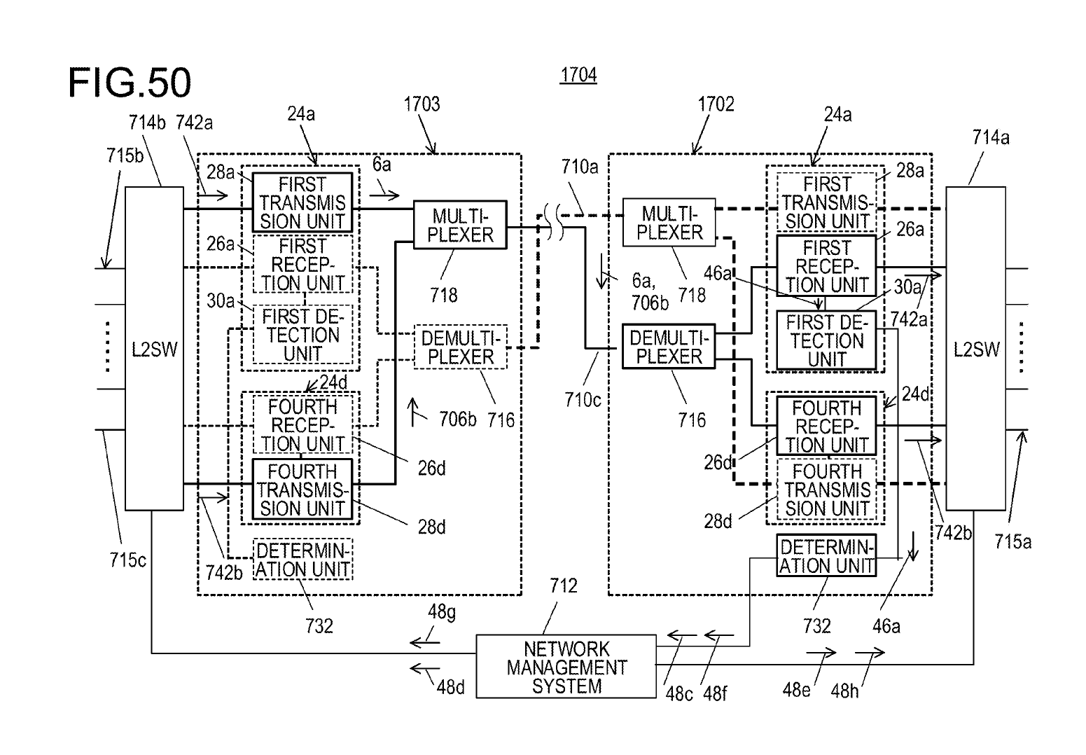

FIG. 49 is a diagram illustrating another example of an optical communication system to which an optical transmission device 1702 of the seventh embodiment is applied. FIG. 50 is a diagram illustrating the flow of the signal in FIG. 49.

The optical communication system 1704 includes an optical transmission device 1702, an optical transmission device 1703, a first optical transmission line 710a, and a third optical transmission line 710c. The optical transmission device 1702 corresponds to the optical transmission device 702 of Configuration Example 1. The optical transmission device 1703 corresponds to the optical transmission device 703 of Configuration Example 1.

The optical transmission device 1702 and the optical transmission device 1703 are connected with each other via the first optical transmission line 710a and the third optical transmission line 710c. The first optical transmission line 710a and the third optical transmission line 710c are, for example, different optical fibers included in one OPGW. According to the optical communication system of Configuration Example 2, the bidirectional communication becomes available.

[Optical Transmission Device]

The optical transmission device 1702 includes the first transponder 24a, the second transponder 24b, the determination unit 732, a demultiplexer 716, and a multiplexer 718.

The optical transmission device 1703 has substantially the same structure as the optical transmission device 1702. The optical transmission device 1703 is also configured to perform substantially the same operation as the optical transmission device 1702. Therefore, the description of the optical transmission device 1703 will be omitted or simplified.

(1-2-1) First Transponder

The first transponder 24a has substantially the same structure as the first transponder 24a of the sixth embodiment. The first transponder 24a is also configured to perform the same operation as the first transponder 24a of the sixth embodiment. The first transponder 24a is, for example, a transponder for digital coherent communication.

(1-2-2) Fourth Transponder

The fourth transponder 24d includes a fourth reception unit 26d and a fourth transmission unit 28d. The fourth reception unit 26d is, for example, a device that reproduces and outputs information from the intensity-modulated signal light.

The fourth transmission unit 28d is, for example, a device that transmits the signal light generated by intensity-modulating light (e.g., laser light) to the third optical transmission line 710c. The bit rate of the signal light transmitted by the fourth transmitting unit 28d is lower than the bit rate of the signal light transmitted by the first transmission unit 28a.

Similarly, the bit rate of the signal light demodulated by the fourth reception unit 26d is lower than the bit rate of the signal light demodulated by the first reception unit 26a. The bands of the fourth transmission unit 28d and the fourth reception unit 26d are, for example, 1 to 10 Gbps (giga bits per second). The bands of the first transmission unit 28a and the first reception unit 26a are, for example, 100 to 1,000 Gbps. The band of each of the plurality of first transmission lines 715a is, for example, 10 Gbps. The same applies even to the plurality of second transmission lines 715b as well.

A center wavelength of the signal light transmitted by the fourth transmission unit 28d is a center wavelength (e.g., 1.31 μm) of the second signal light 706b. The center wavelength of the signal light transmitted by the first transmission unit 28a is a center wavelength (e.g., 1.55 μm) of the first signal light 6a. That is, the center wavelength (e.g., 1.31 μm) of the second signal light 706b is different from the center wavelength (e.g., 1.55 μm) of the first signal light 6a.

(1-2-3) Determination Unit

The determination unit 732 has substantially the same structure as the determination unit 32 of the second embodiment. The operation of the determination unit 32 will be described later (see “(1-2-6) Operation”).

(1-2-4) Demultiplexer

The demultiplexer 716 receives the first signal light 6a and transmits the received first signal light 6a to the first reception unit 26a of the first transponder 24a. The demultiplexer 716 also receives the second signal light 706b and transmits the received second signal light 706b to the fourth reception unit 26d of the fourth transponder 24d. The demultiplexer 716 is, for example, an optical filter having a dielectric multilayer film.

(1-2-5) Multiplexer

The multiplexer 718 multiplexes the signal light transmitted by the first transmission unit 28a of the first transponder 24a and the signal light transmitted by the fourth transmission unit 28d of the fourth transponder 24d and transmits the multiplexed signal light to the first optical transmission line 710a.

The multiplexer 718 is, for example, the optical filter having the dielectric multilayer film. For example, the multiplexer 718 has the same structure as the demultiplexer 716.

The reception unit 720 (see FIG. 47) of Configuration Example 1 is a block including the first reception unit 26a of the optical transmission device 1702, the fourth reception unit 26d of the optical transmission device 1702, the demultiplexer 716 of the optical transmission device 1702, and the determination unit 732 of the optical transmission device 1702. The detection unit 722 (see FIG. 47) of Configuration Example 1 corresponds to the first detection unit 30a of the optical transmission device 1702.

The transmission unit 708 of Configuration Example 1 is a block including the first transmission unit 28a of the optical transmission device 1703 and the fourth transmission unit 28d of the optical transmission device 1703.

(1-2-6) Operation

The second layer 2 switch 714b on the side of the optical transmission device 1703 receives first information 742a via a plurality of second transmission lines 715b and transmits the received first information 742a to the first transmission unit 28a of the optical transmission device 1703. In other words, the second layer 2 switch 714b multiplexes information from a plurality of transmission sources and transmits the multiplexed information to the first transmission unit 28a. For example, the first information 742a is transmitted from the second layer 2 switch 714b to the first transmission unit 28a by the intensity-modulated signal light (the same applies to the second information 742b as well to be described later).

The first transmission unit 28a converts the received first information 742a into the first signal light 6a whose phase (or frequency) is modulated and transmits the first signal light 6a to the demultiplexer 716 of the optical transmission device 1702 through the multiplexer 718 and the first optical transmission line 710a. The first signal light 6a is, for example, light modulated by dual polarization QPSK for the transmission of the first information 742a.

The demultiplexer 716 transmits the received first signal light 6a to the first reception unit 26a of the first transponder 24a. The first reception unit 26a reproduces and outputs the first information 742a from the received first signal light 6a.

The first layer 2 switch 714a on the side of the optical transmission device 1702 receives the first information 742a output by the first reception unit 26a and transmits the received first information 742a to each reception destination via the plurality of first transmission lines 715a. The first information 742a is transmitted from the first reception unit 26a to the first layer 2 switch 714a by, for example, the intensity-modulated signal light (the same applies to the second information 742b as well to be described later).

[Switching of Modulation Method]

The first detection unit 30a detects the first polarization fluctuation amount 46a of the first signal light 6a. The determination unit 732 acquires the first polarization fluctuation amount 46a from the first detection unit 30a and determines whether the absolute value of the first polarization fluctuation amount 46a exceeds the first threshold 112a.

When the determination 732 determines that the absolute value of the first polarization fluctuation amount 46a exceeds the first threshold 112a, the determination unit 732 transmits the third command 48c to the network management system 712. The third command 48c is, for example, an electrical signal.

In response to the third command 48c, the network management system 712 transmits a fourth command 48d to the second layer 2 switch 714b. In response to the third command 48c, the network management system 712 also transmits a fifth command 48e to the first layer 2 switch 714a.

In response to the fourth command 48d, the second layer 2 switch 714b transmits the second information 742b from a specific transmission line 715c among the plurality of transmission lines 715b to the fourth transmission unit 28d of the optical transmission device 1703. The transmission line 715c is a transmission line that transmits information having particularly high importance among information transmitted via the plurality of transmission lines 715b. For example, the transmission path 715 c is predetermined.

The fourth transmission unit 28d converts the received second information 742b into the second signal light 706b whose is intensity-modulated and transmits the second signal light 706b to the demultiplexer 716 of the optical transmission device 1702 through the multiplexer 718 and the first optical transmission line 710a.

The demultiplexer 716 transmits the received second signal light 706b to the fourth reception unit 26d. The fourth reception unit 26d reproduces and outputs the second information 742b from the received second signal light 706b.

In response to the fifth command 48e from the network management system 712, the first layer 2 switch 714a transmits the second information 742b output by the fourth reception unit 26d to each reception destination.

[Returning of Modulation Method]

When the absolute value of the first polarization fluctuation amount 46a continues to be below the second threshold 112b which is smaller than the first threshold 112a for the predetermined time t2 after the transmission of the third command 48c, the determination unit 732 transmits a sixth command 48f to the network management system 712. In response to the sixth command 48f, the network management system 712 transmits a seventh command 48g to the second layer 2 switch 714b. The network management system 712 also transmits an eighth command 48h to the first layer 2 switch 714a.

In response to the seventh command 48g, the second layer 2 switch 714b resumes transmission of the first information 742a to the first transmission unit 28a. As a result, the transmission of the first signal light 6a restarts. The first reception unit 26a of the optical transmission device 1702 resumes the reproduction and output of the first information 742a from the first signal light 6a.

In response to the eighth command 48h, the first layer 2 switch 714a transmits the first information 742a output by the first reception unit 26a of the optical transmission device 1702 to each reception destination.

### (2) Hardware

### (2-1) First Transponder

The first transponder 24a has substantially the same hardware configuration as the first transponder 24a of the sixth embodiment.

### (2-2) Fourth Transponder

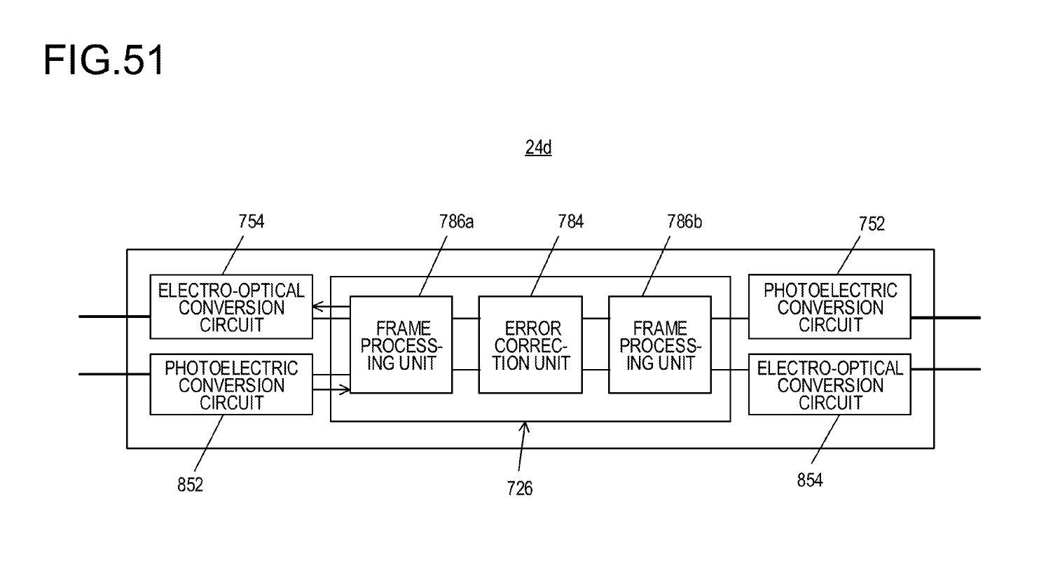

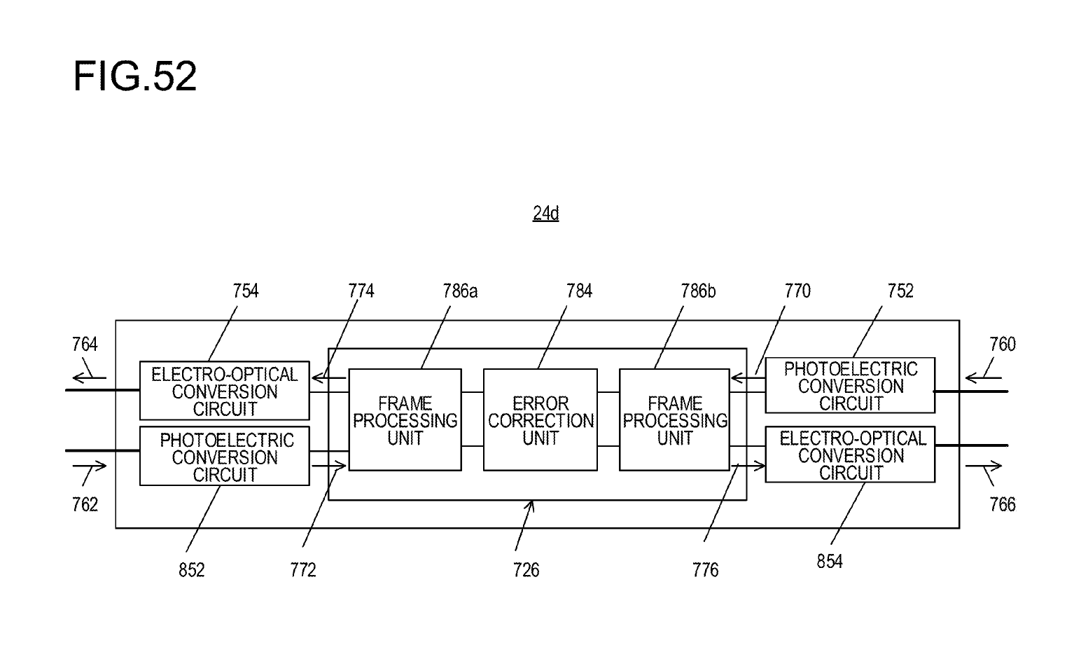

FIG. 51 is a diagram illustrating an example of a hardware configuration of a fourth transponder 24d. FIG. 52 is a diagram illustrating an example of the flow the signal in the fourth transponder 24d. The fourth transponder 24d includes a photoelectric conversion circuit 752 on the side of the first layer 2 switch 714a (see FIG. 50) and an electro-optical conversion circuit 754 on the side of the optical transmission lines 710a and 710c (see FIG. 50). The fourth transponder 24d also includes a photoelectric conversion circuit 852 on the side of the optical transmission lines 710a and 710c and an electro-optical conversion circuit 854 on the side of the first layer 2 switch 714a. The fourth transponder 24d also includes an integrated circuit 726.

(2-2-1) Photoelectric Conversion Circuit

The photoelectric conversion circuit 752 on the side of the first layer 2 switch 714a converts intensity-modulated signal light 760 (see FIG. 52) from the first layer 2 switch 714a into an electrical signal 770. The photoelectric conversion circuit 852 on the side of the optical transmission lines 710a and 710c converts signal light 762 (e.g., the second signal light 706b) into an electrical signal 772.

The photoelectric conversion circuit 752 is, for example, a circuit including a photodiode that converts the signal light into photocurrent, a drive circuit of the photodiode, and an amplifier that amplifies the photocurrent generated by the photodiode. The same also applies to the photoelectric conversion circuit 852 on the side of the optical transmission lines 710a and 710c.

(2-2-2) Electro-Optical Conversion Circuit

The electro-optical conversion circuit 754 on the side of the optical transmission lines 710a and 710c converts the electric signal 774 from the integrated circuit 726 into intensity-modulated transmission light 764. The electro-optical conversion circuit 854 on the side of the first layer 2 switch 714a converts the electrical signal 776 from the integrated circuit 726 into intensity-modulated transmission light 766.

The electro-optical conversion circuit 754 on the side of the optical transmission lines 710a and 710c is, for example, a device including the semiconductor laser and the laser driver for driving the semiconductor laser in response to the electrical signal 774. The same also applies to the electro-optical conversion circuit 854 on the side of the first layer 2 switch 714a.

(2-2-3) Integrated Circuit

As illustrated in FIG. 51, the integrated circuit 726 includes a first frame processing unit 786a, an error correction unit 784, and a second frame processing unit 786b. The integrated circuit 726 is, for example, an ASIC that is a semiconductor chip.

The first frame processing unit 786a converts a serial electrical signal 772 from the photoelectric conversion circuit 852 into data (parallel bit string) and transmits the data to the error correction unit 784. The error correction unit 784 corrects an error of the received data and transmits the data with the corrected error to the second frame processing unit 786b. The second frame processing unit 786b converts the received data into a serial electrical signal 776 and outputs the serial electrical signal 776.

The second frame processing unit 786b also converts a serial electrical signal 770 from the photoelectric conversion circuit 752 into data (parallel bit string) and transmits the data to the error correction unit 784. The error correction unit 784 corrects the error of the received data and transmits the data with the corrected error to the first frame processing unit 786a. The first frame processing unit 786a converts the received data into a serial electrical signal 774 and outputs the serial electrical signal 774.

### (2-3) Determination Unit

The determination unit 732 has substantially the same hardware configuration as the determination unit 32 of the first embodiment.

The hardware that implements the first reception unit 26a, the first transmission unit 28a, and the first detection unit 30a is described in the sixth embodiment. Similarly to the determination unit 32 of the first embodiment, the determination unit 732 is implemented by the second CPU 56b (see FIG. 8) and the memory 158.

The fourth reception unit 26d is implemented by the photoelectric conversion circuit 852 of the fourth transponder 24d, the integrated circuit 726 of the fourth transponder 24d, and the electro-optical conversion circuit 854 of the fourth transponder 24d.

The fourth transmission unit 28d is implemented by the photoelectric conversion circuit 752 of the fourth transponder 24d (see FIG. 51), the integrated circuit 726 of the fourth transponder 24d, and the electro-optical conversion circuit 754 of the fourth transponder 24d.

### (3) Software

### (3-1) Program

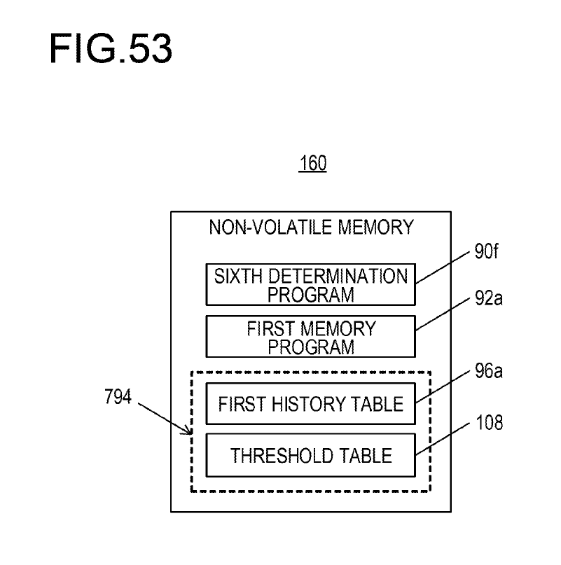

FIG. 53 is a diagram illustrating a program and a data file 794 recorded in the non-volatile memory 160 (see FIG. 8) of the determination unit 732.

In the non-volatile memory 160 of the seventh embodiment, a sixth determination program 90f and the first recording program 92a are recorded.

### (3-2) Data File

As illustrated in FIG. 53, the first history table 96a and the threshold table 108 are recorded in the non-volatile memory 160. The first history table 96a is substantially the same table as the first history table 96a of the first embodiment. The same applies even to the threshold table 108 as well.

### (3-3) Processing

The second CPU 56b (see FIG. 8) reads and executes the sixth determination program 90f and the first recording program 92a from the non-volatile memory 160. The second CPU 56b concurrently executes the sixth determination program 90f and the first recording program 92a. The first recording program 92a is described in the first embodiment.

(3-3-1) Sixth Determination Processing (Processing by Sixth Determination Program 90f)

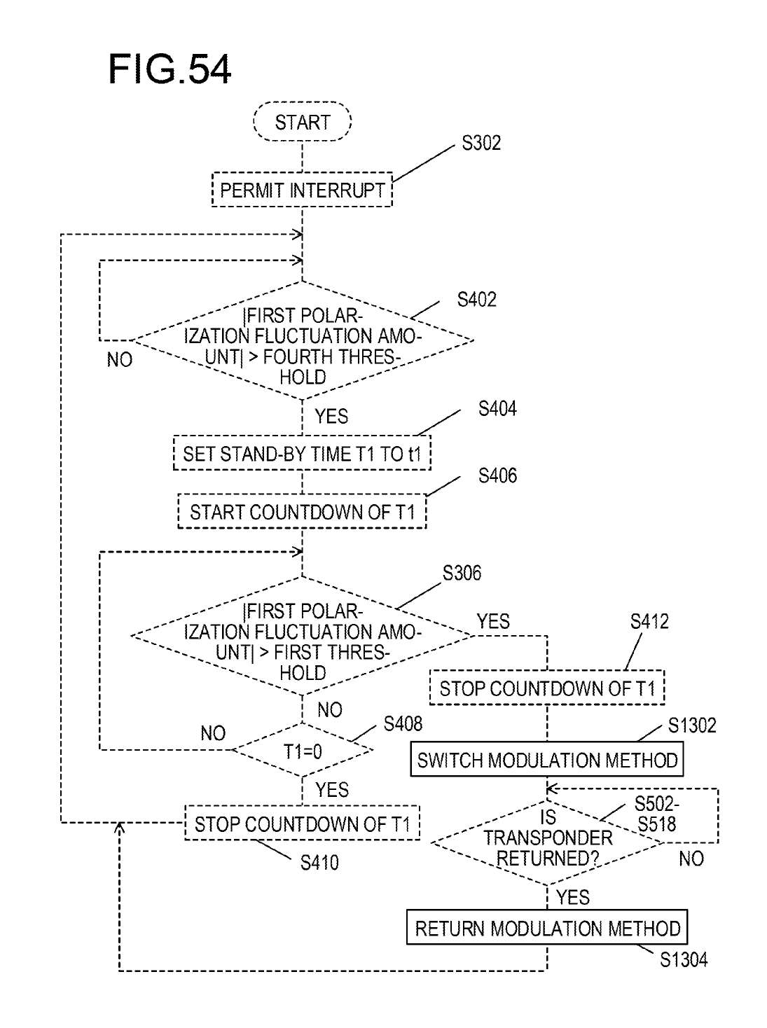

FIG. 54 illustrates an example of the flowchart of a sixth determination program 90f. The sixth determination program 90f is executed by the determination unit 732 (see FIG. 49). In other words, the sixth determination program 90f is executed by the reception unit 720 including the determination unit 732.

The sixth determination program 90f is similar to the second determination program 90b (see FIGS. 21 and 22) of the second embodiment. The operations marked by the dashed lines in FIG. 54 are the operations described in the second embodiment.

The determination unit 732 executes operation S1302 instead of operation S308 (see FIG. 21). The determination unit 732 also executes operation S1304 instead of operation S520 (see FIG. 22). The determination unit 732 does not execute operation S304 of initializing the transponder.

[Operation S1302]

When the second CPU 56b determines that the absolute value of the first polarization fluctuation amount 46a of the first signal light 6a exceeds the first threshold 112a in operations S402 to S412 and S306, the second CPU 56b makes, for example, the intensity-modulated second signal light 706b to be transmitted by the optical transmission device 1703. Specifically, the second CPU 56b transmits the third command 48c to the network management system 712.

[Operation S1304]

When the second CPU 56b determines that the absolute value of the first polarization fluctuation amount 46a continues to be below the second threshold 112b for the predetermined time t2 after operations S502 to S518, the second CPU 56b makes the optical transmission device 1703 to resume the transmission of, for example, the dual polarization modulated first signal light 6a. Specifically, the second CPU 56b transmits the sixth command 48f to the network management system 712.

According to the processing of the seventh embodiment, before the polarization of the first signal light 6a fluctuates largely due to the lightning, the second signal light 706b which is modulated by a method that is hardly affected by polarization fluctuation is transmitted, and as a result, the transmission error due to the lightning is reduced.

### (4) Modification

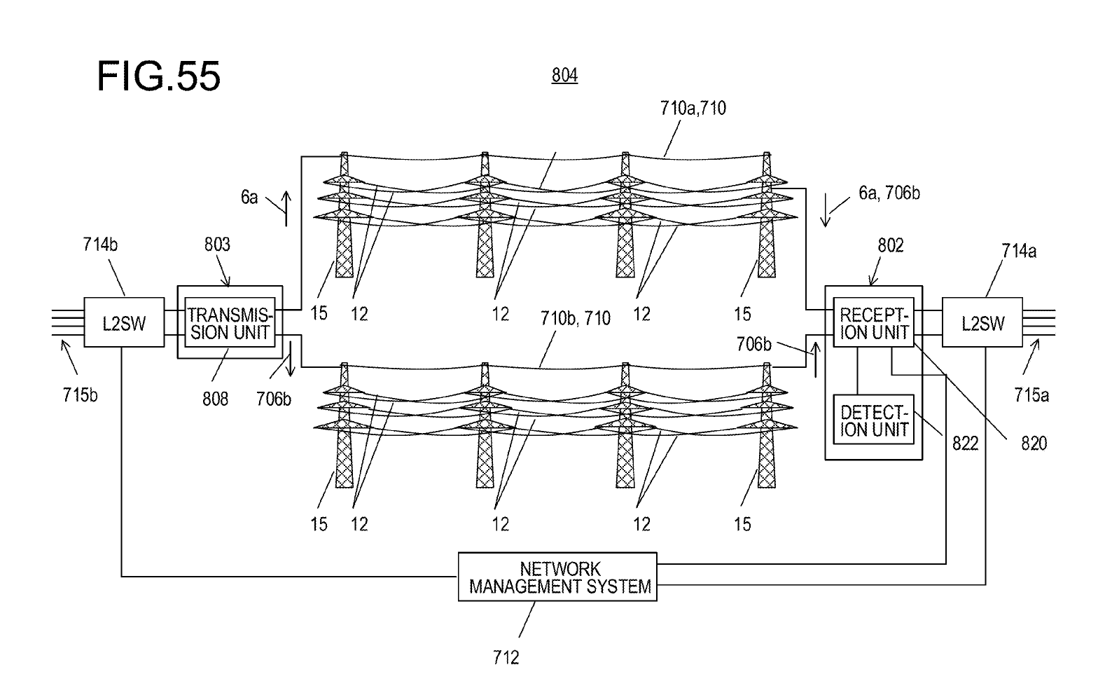

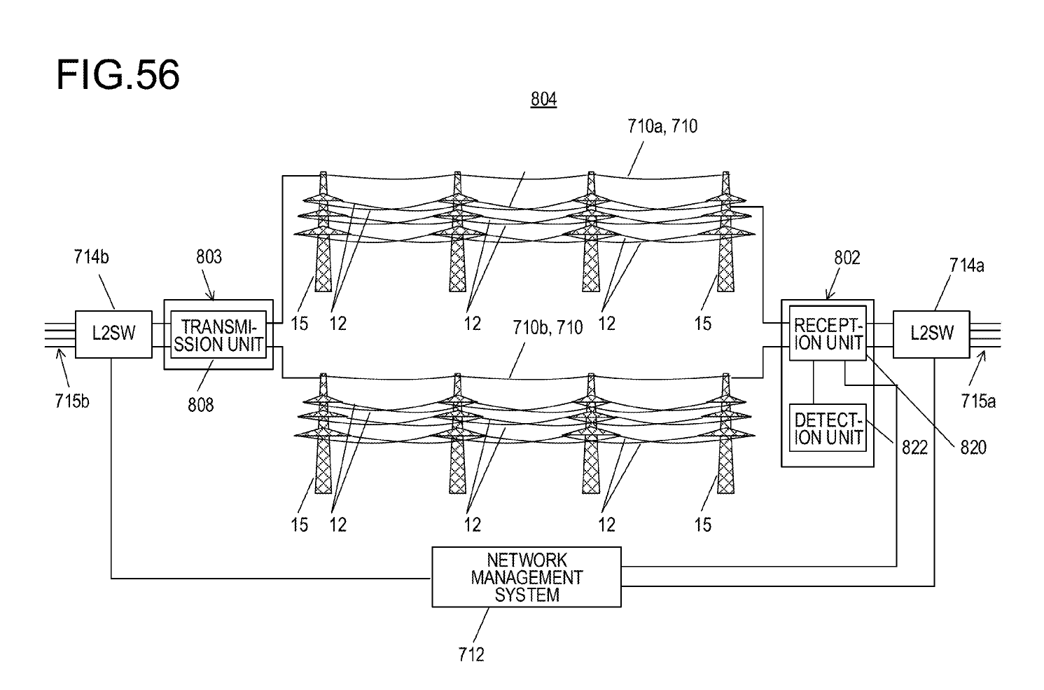

FIG. 55 is a diagram illustrating the modification of the seventh embodiment. FIG. 56 is a diagram illustrating the flow of the signal in FIG. 55.

In the above example, after the absolute value of the first polarization fluctuation amount 46a exceeds the first threshold 112a, the reception unit 720 (see FIG. 48) makes the second signal light 706b to be transmitted by the optical transmission device 703 through the first optical transmission line 710a. However, a reception unit 820 of the optical transmission device 802 according to the modification makes the second signal light 706b to be transmitted by a transmission unit 808 of the optical transmission device 803 via the second optical transmission path 710b different from the first optical transmission line 710a. The second optical transmission line 710b is, for example, an optical fiber passing through the OPGW different from the OPGW through which the first optical transmission line 710a passes.

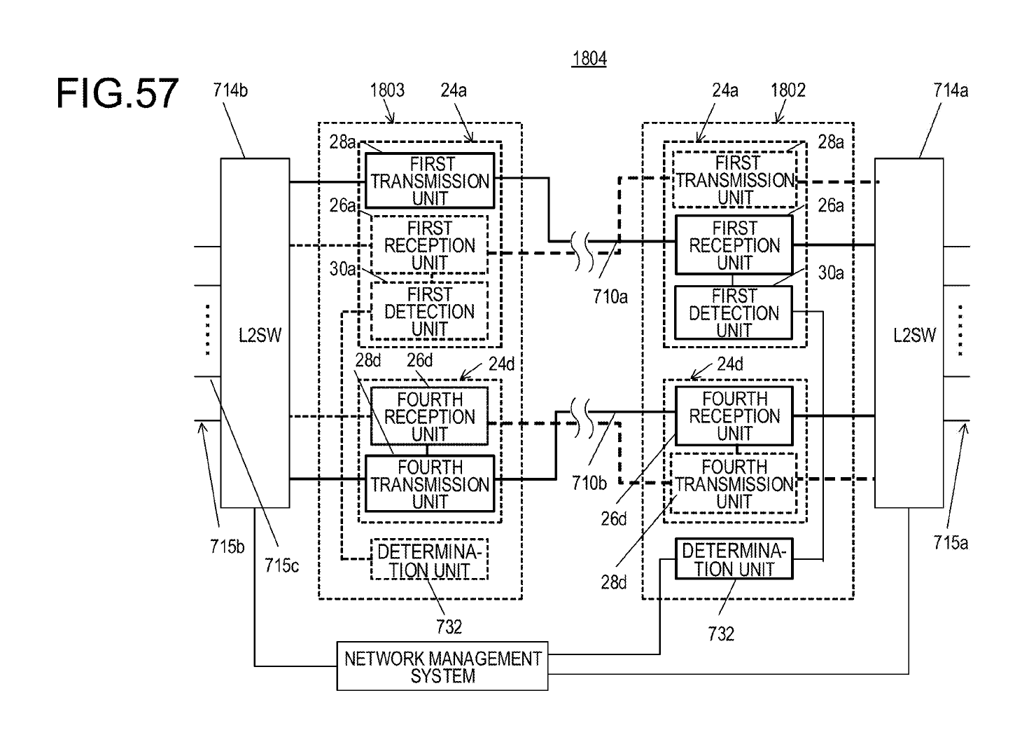

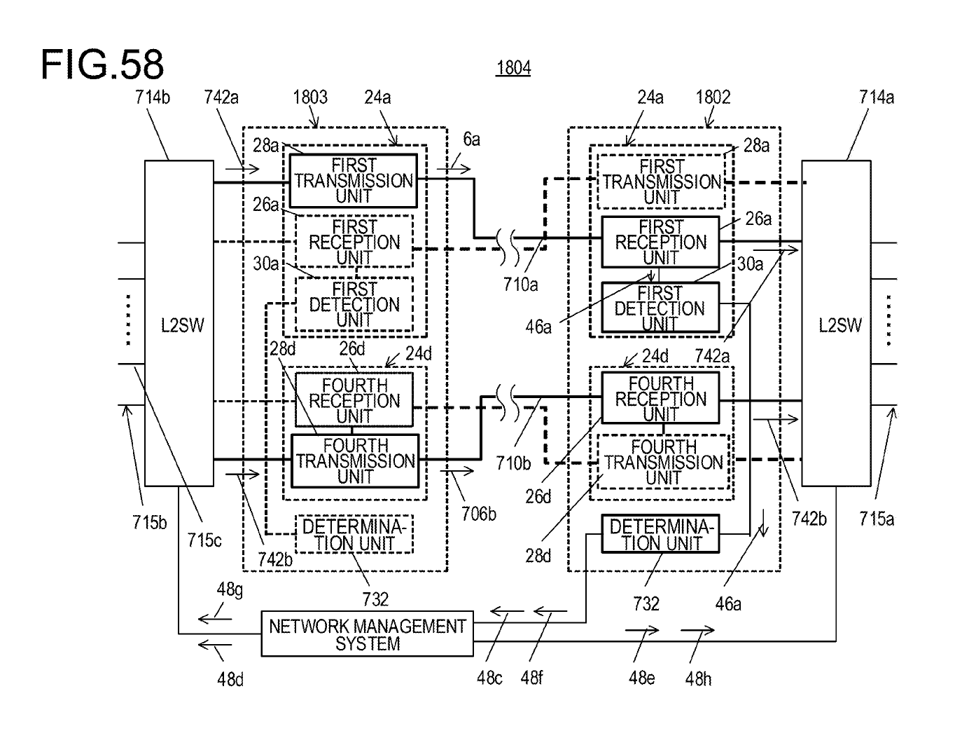

FIG. 57 is a diagram illustrating another example of the modification. FIG. 58 is a diagram illustrating the flow of the signal in FIG. 57. An optical transmission device 1802 of FIG. 57 corresponds to the optical transmission device 802 of FIG. 55. An optical transmission device 1803 of FIG. 57 corresponds to the optical transmission device 803 of FIG. 55.

The reception unit 820 of FIG. 55 is a block including the first reception unit 26a of the optical transmission device 1802 (see FIG. 57), the fourth reception unit 26d of the optical transmission device 1802, and the determination unit 732 of the optical transmission device 1802. The detection unit 822 of FIG. 55 corresponds to, for example, the first detection unit 30a of the optical transmission device 1802. The transmission unit 808 of FIG. 55 is a block including the first transmission unit 28a of the optical transmission device 1803 and the second transmission unit 28b of the optical transmission device 1803.

The first reception unit 26a of the optical transmission device 1802 of the modified example is directly connected to the first transmission unit 28a of the optical transmission device 1803 via the first optical transmission line 710a. The fourth reception unit 26d of the optical transmission device 1802 of the modification is directly connected to the fourth transmission unit 28d of the optical transmission device 1803 via the second optical transmission line 710b. Therefore, the second signal light 706b is transmitted to the optical transmission devices 802 and 1802 via the second optical transmission line 710b different from the first optical transmission line 710a.

According to the modification, since the transmission route of the signal light is changed along with the modulation method of the signal light, the transmission error due to the lightning may be further reduced.

As described above, when the absolute value of the first polarization fluctuation amount of the first signal light 6a exceeds the first threshold, the optical transmission device according to the seventh embodiment makes the second signal light 706b to be transmitted by the optical transmission device 803 connected to the reception unit 820 through the optical transmission line 710. The second signal light 706b is signal light that is modulated by a method different from the first signal light modulation method and is hardly affected by the polarization fluctuation.

According to the optical transmission device of the seventh embodiment, before the polarization of the first signal light 6a fluctuates largely due to the lightning, the transmission of the second signal light 706b that is hardly affected by polarization fluctuation starts, and as a result, the transmission error due to the lightning may be reduced.

The optical transmission device according to the seventh embodiment is configured to perform a processing similar to the processing of the second embodiment. However, the optical transmission device of the seventh embodiment may be configured to perform a processes similar to the processing (e.g., the first and fourth determination processing, and the first and second adjustment processing) of the first, fourth, and fifth embodiments, instead of the processing of the second embodiment.

Specifically, the optical transmission device of the seventh embodiment may execute a determination processing in which operations S308 and S520 of the first or fourth determination processing are changed to operations S1302 and S1304 of the sixth determination processing, instead of, for example, the sixth determination processing. Except for the above point, the optical transmission devices 702, 1702, 802, and 1802 may perform substantially the same processing as the processing of the first and fourth to sixth embodiments.

Although the embodiments of the present disclosure have been described above, the first to seventh embodiments are illustrative and not restrictive.

For example, in the above example, the detection unit 22 monitors the polarization state of the first signal light 6a. However, the detection unit 22 may monitor another light propagating through the same optical fiber as the first signal light 6a (hereinafter, referred to as monitor light). The monitor light is, for example, continuous light.

The polarization fluctuation amount of the monitor light received from the lightning is substantially the same as the polarization fluctuation amount of the first signal light 6a received from the lightning. Therefore, by monitoring the polarization state of the monitor light, the polarization state of the first signal light 6a may be detected. For example, the monitor light is transmitted together with the first signal light 6a by the transmission unit 8 (see FIG. 1). The same also applies to monitoring (see the third embodiment) of the polarization state of the second signal light 6b.

In the above example, the first signal light 6a and the second signal light 6b are light of which phase (or frequency) is modulated. However, the first signal light 6a and the second signal light 6b may be light of which intensity is modulated in addition to the phase (or frequency).

In the above example, the reception unit and the detection unit of the optical transmission device are implemented by a plurality of transponders. However, the reception unit and the detection unit of the optical transmission device may be implemented by the photoelectric conversion circuit, the electro-optical conversion circuit, and one or a plurality of semiconductor chips that performs a data processing for transmitting and receiving the signal light (e.g., the first signal light, the second signal light, and the transmission light). The semiconductor chip is, for example, a field-programmable gate array (FPGA) or an ASIC.

In the above example, a plurality of processings are executed by the second CPU. However, the processing executed by the second CPU may be executed by a plurality of CPUs (that is, multiprocessors). The same also applies to the processing executed by the first CPU.

In the above example, the second CPU is a single-core processor. However, the second CPU may be a multi-core processor. The same applies to the first CPU as well.

In the above example, each of the first signal light and the second signal light is single. However, each of the first signal light and the second signal light may be a plurality of wavelength-multiplexed signal lights.

In the above example, there is one second route. However, a plurality of second routes may be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission device comprising:
a first receiver configured to receive first signal light from a first route;
a memory;
a processor coupled to the memory and the processor configured to detect a first polarization fluctuation amount which is a change amount of a parameter indicating a polarization state within a predetermined time and the change amount of the first signal light received from the first route; and
a second receiver configured to receive second signal light from a second route different from the first route when an absolute value of the detected first polarization fluctuation amount exceeds a first specific value.

2. The optical transmission device according to claim 1,
wherein the first receiver is configured to receive the first signal light when the absolute value of the first polarization fluctuation amount detected after starting reception of the second signal light continues to be below a second specific value smaller than the first specific value for the predetermined time.

3. The optical transmission device according to claim 1,
wherein the processor is further configured to detect a second polarization fluctuation amount which is the change amount of the second signal light received from the second route, and
wherein the second receiver is further configured to suspend reception of the second signal light when the absolute value of the detected second polarization fluctuation amount exceeds a third specific value before the absolute value of the first polarization fluctuation amount exceeds the first specific value.

4. The optical transmission device according to claim 1,
wherein the first receiver is further configured to reduce the first specific value when reception of the first signal light stops before reception of the second signal light starts.

5. The optical transmission device according to claim 2,
wherein the first receiver is further configured to increase the first specific value when the first signal light is continually received while the reception of the first signal light and the reception of the second signal light are repeated.

6. The optical transmission device according to claim 1,
wherein, before the absolute value of the first polarization fluctuation amount exceeds the first specific value, the first receiver is further configured to output information reproduced from the first signal light, and
wherein, when the absolute value of the first polarization fluctuation amount exceeds the first specific value, the second receiver is further configured to output information reproduced from the second signal light.

7. The optical transmission device according to claim 1,
wherein each of the first signal light and the second signal light is light of which phase or frequency is modulated, and
wherein the first route passes through a region wound by a conductive wire extending in a swirling manner, and the second route passes outside the region.

8. The optical transmission device according to claim 1, further comprising:
an optical path switch arranged between the first route and the first receiver and between the second route and the second receiver, and configured to:
receive the first signal light from the first route and the second signal light from the second route,
transmit the first signal light to the first receiver, until before an absolute value of the first polarization fluctuation amount exceeds the first specific value, and
transmit the second signal light to the first receiver, when the absolute value of the first polarization fluctuation amount exceeds the first specific value.

9. An optical transmission device as a first optical transmission device couple to the second optical transmission device through an optical transmission line, the optical transmission device comprising:
a receiver configured to receive one of first signal light and second signal light from the second optical transmission device through the optical transmission line;
a memory; and
a processor coupled to the memory and the processor configured to detect a first polarization fluctuation amount which is a change amount of a parameter indicating a polarization state within a predetermined time and the change amount of the first signal light received by the receiver,
wherein the receiver is configured to receive the first signal light, and
wherein the processor is further configured to make the second signal light which is modulated by a method different from a modulation method of the first signal light and has a lower bit rate than the first signal light to be transmitted by the second optical transmission device, when an absolute value of the detected first polarization fluctuation amount exceeds the first specific value.

10. The optical transmission device according to claim 9,
wherein the first signal light is light of which phase or frequency is modulated, and the second signal light is light of which intensity is modulated.

11. The optical transmission device according to claim 9,
wherein the optical transmission line is an optical fiber passing through a region wound by a conductive wire extending in a swirling manner.

12. An optical transmission method comprising:
receiving first signal light from a first route;
detecting a first polarization fluctuation amount which is a change amount of a parameter indicating a polarization state within a predetermined time and the change amount of the first signal light received from the first route; and
receiving second signal light from a second route different from the first route when an absolute value of the detected first polarization fluctuation amount exceeds a first specific value.
